(19) United States
(12) Patent Application Publication
(10) Pub. No.: US 2024/0065476 A1
(43) Pub. Date: Feb. 29, 2024

(54) MEAT AUTOMATIC COOKING APPARATUS AND CONTROLLING METHOD THEREOF

(71) Applicant: PEOPLE S LEAGUE CORP., Daejeon (KR)

(72) Inventors: Gunny RYU, Seoul (KR); Seunghyun JUNG, Daejeon (KR); Wonjun HWANG, Daejeon (KR)

(73) Assignee: PEOPLE S LEAGUE CORP., Daejeon (KR)

(21) Appl. No.: 18/114,972

(22) Filed: Feb. 27, 2023

(30) Foreign Application Priority Data
Aug. 23, 2022 (KR) 10-2022-0105322

(51) Int. Cl. A47J 37/06; A47J 36/32

(52) U.S. Cl. CPC A47J 37/0611; A47J 36/32; A47J 2037/0617; A47J 2202/00

(57) ABSTRACT

Provided is a cooking device comprising a first grilling plate, a second grilling plate disposed to face the first grilling plate, a shaft configured to adjust a distance between the first grilling plate and the second grilling plate and at least one processor that controls an operation of the shaft, wherein the at least one processor configured to control the operation of the shaft so that the distance between the first grilling plate and the second grilling plate becomes a first distance in case that the first grilling plate and the second grilling plate operate in a first mode, control the operation of the shaft so that the distance between the first grilling plate and the second grilling plate becomes a second distance in case that the first grilling plate and the second grilling plate operate in a second mode, wherein the second distance is shorter than the first distance, and apply heat to the first grilling plate and the second grilling plate.

### CROSS-REFERENCE TO RELATED APPLICATION

This application claims priority to and the benefit of Korean Patent Application No. 10-2022-0105322, filed on Aug. 23, 2022, the disclosure of which is incorporated herein by reference in its entirety.

### BACKGROUND

### 1. Field of the Invention

The present invention relates to a method of determining a cooking method in which properties of meat and user preference are reflected, a method of automatically cooking meat using the determined cooking method, and a device for performing the same.

### 2. Discussion of Related Art

Globally, the problem of manpower shortage in the food service industry is becoming serious, and the rate of business closure or one-man business is rapidly increasing due to the minimum wage increase and the asymmetry of job market. Recently, employment in the dirty, dangerous, and difficult (3Ds) sector of the food service industry has shown a sharp decline, and as the frequency of personnel replacement increases, the cost of employing, training, and maintaining personnel is increasing, resulting in an increase in actual labor costs.

In particular, in the case of meat cooking in the food service industry, cooking is performed at high temperatures, and thus cooks work in a very dirty, dangerous, and difficult environment. For example, the health of cooks is threatened due to carcinogens generated when meat is roasted at high temperatures, the risk of burns is very high due to the nature of the industry that handles strong fire, and industrial accidents may occur frequently.

Due to these conventional problems, the robotic kitchen market is rapidly increasing, and various food robots are being actively developed.

However, the robotic kitchen and food robots currently being developed are replacing only simple repetitive tasks that do not require intelligence, and a task that requires intelligence, for example, an automation task of meat cooking that needs to be cooked at an appropriate temperature and in a period of time by reflecting properties of meat and user preference, has a limitation that cannot be replaced.

### SUMMARY OF THE INVENTION

The present invention is directed to providing a device for checking meat properties information through analysis of data related to meat and a method of controlling the same.

The present invention is also directed to providing a method and device for selecting a cooking method in which meat properties information and user preference are reflected.

The present invention is also directed to providing an automatic meat cooking device and a method of controlling the same.

The present invention is also directed to providing a method of guiding meat cooking and a system for performing the same.

The present invention is also directed to providing a method of improving a meat cooking recipe and a device for performing the same.

Objects of the present invention are not limited to the above-described objects and other objects that are not described may be clearly understood by those skilled in the art from this specification and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing an automatic meat cooking system according to an embodiment;

FIG. 2 is an exemplary flowchart for describing a method of obtaining meat properties information in an automatic meat cooking system according to an embodiment;

FIG. 3 is an exemplary diagram for describing a method of determining a cooking method on the basis of meat properties information and controlling a cooking device according to the determined cooking method in an automatic meat cooking system according to an embodiment;

FIG. 4 is an exemplary diagram for describing a method of determining a cooking method on the basis of user preference and meat properties information in an automatic meat cooking system according to an embodiment;

FIG. 5 is an exemplary diagram for describing a test performed on meat that has been cooked in an automatic meat cooking system according to an embodiment;

FIG. 6 is an exemplary diagram for describing a method of obtaining, by a server, meat properties information according to an embodiment;

FIG. 7 is a set of exemplary diagrams for describing a method of obtaining, by a server, meat properties information by utilizing image data and non-image data according to an embodiment;

FIG. 8 is a diagram for describing a specific example in which a server obtains meat properties information on the basis of image data according to an embodiment;

FIGS. 9 to 14 are diagrams for describing a method of obtaining meat properties information on the basis of meat image analysis according to an embodiment;

FIG. 15 is an exemplary diagram for describing auxiliary modules used to obtain meat properties information on the basis of meat image analysis according to another embodiment;

FIG. 16 is a diagram for describing a method of obtaining meat properties information on the basis of meat image analysis according to another embodiment;

FIGS. 17 to 21 are exemplary diagrams for describing an operation of obtaining, by a server, meat information on the basis of analysis of first and second surfaces of meat according to an embodiment;

FIGS. 22 to 26 are exemplary diagrams for describing a method of obtaining meat properties information on the basis of meat image analysis and a method of utilizing the obtained meat properties information according to another embodiment;

FIG. 27 is a diagram for describing a method of obtaining meat properties information on the basis of meat image analysis according to another embodiment;

FIGS. 28 to 31 are exemplary diagrams for describing a method of determining a cooking method on the basis of additional analysis of non-image data according to an embodiment;

FIG. 32 is an exemplary diagram for describing a method of determining, by a server, a meat cooking method according to an embodiment;

FIGS. 33 and 34 are exemplary diagrams for describing a method of determining, by a server, a meat cooking method according to another embodiment;

FIGS. 35 and 36 are exemplary diagrams for describing a determined cooking method according to an embodiment;

FIG. 37 is an exemplary diagram for describing an overall configuration of an automatic cooking device according to an embodiment;

FIG. 38 is a perspective view of an automatic cooking device for describing a grilling module (100) according to an embodiment;

FIG. 39 is a side view of an automatic cooking device for describing a grilling module (100) according to an embodiment;

FIG. 40 is a diagram for describing a grilling module according to an embodiment;

FIG. 41 is an exemplary diagram for describing a method of adjusting a height of one of a plurality of grilling plates included in a grilling module;

FIG. 42 is an exemplary diagram for describing at least one elastic member constituting a grilling module;

FIG. 43 is a set of exemplary diagrams for describing a method of allowing a grilling module to apply heat to meat using a plurality of grilling plates according to an embodiment.

FIG. 44 is a set of exemplary diagrams for describing various operations performed by a grilling module according to an embodiment;

FIG. 45 is a set of exemplary diagrams for describing a housing included in a grilling module according to an embodiment;

FIG. 46 is a set of exemplary diagrams for describing a relationship between a housing and a plurality of grilling plates included in a grilling module according to an embodiment;

FIG. 47 is a set of exemplary diagrams for describing a grilling plate according to an embodiment;

FIGS. 48 and 49 are exemplary diagrams for describing a pushing module according to an embodiment;

FIGS. 50 and 51 are exemplary diagrams for describing an operation of a pushing module according to an embodiment;

FIGS. 52 and 53 are exemplary diagrams for describing a first pushing module according to an embodiment;

FIGS. 54 and 55 are exemplary diagrams for describing a moving module according to an embodiment;

FIG. 56 is an exemplary flowchart for describing a method of operating an automatic cooking device according to an embodiment;

FIGS. 57 and 58 are diagrams for describing a cooking guide system according to an embodiment;

FIGS. 59 and 60 are exemplary diagrams for describing a method of providing a guide to a user through a cooking guide system according to an embodiment;

FIGS. 61 to 63 are diagrams for describing a cooking guide system according to another embodiment;

FIGS. 64 to 67 are diagrams for describing a cooking recipe improvement system according to an embodiment; and

FIGS. 68 and 69 are exemplary diagrams for describing a method of determining a customized cooking condition according to an embodiment.

### DETAILED DESCRIPTION OF EXEMPLARY EMBODIMENTS

The above-described objects, features and, advantages of the present invention will be clearly understood through the following detailed description taken in conjunction with the accompanying drawings. However, while the present invention may have various modifications and alternative forms, specific embodiments thereof are shown by way of example in the accompanying drawings and will be described in detail herein.

Like reference numerals refer to like elements in principle throughout this specification. In addition, elements having the same function within the scope of the same idea shown in the drawings of each embodiment will be described using the same reference numerals, and overlapping descriptions thereof will be omitted.

When it is determined that detailed descriptions of related well-known functions or configurations may unnecessarily obscure the gist of the present invention, detailed descriptions thereof will be omitted. Further, the ordinal numbers (for example, first, second, etc.) used in description of the specification are used only to distinguish one element from another element.

Further, the term “module,” “unit,” “part,” or “part” of an element used herein is assigned or incorporated for convenience of specification description, and the term itself does not have a distinct meaning or role.

In the following embodiments, the singular forms “a” and “an” are intended to also include the plural forms, unless the context clearly indicates otherwise.

In the following embodiments, the terms “comprise,” “comprising,” “include,” and/or “including,” when used herein, specify the presence of stated features or elements described in the specification, but do not preclude the presence or addiction of one or more other features or elements.

In the drawing, the size of the elements may be exaggerated or reduced for convenience of description. For example, the size and thickness of each element shown in the drawings are arbitrarily indicated for convenience of description and the present invention is not necessarily limited to the illustration.

When a certain embodiment is allowed to be implemented differently, a specific process order may be performed differently from the described order. For example, two consecutively described processes may be performed substantially at the same time or performed in an order opposite to the described order.

In the following embodiments, when elements and the like are described as being connected to each other, the elements are directly connected to each other or the elements are indirectly connected to each other with another element interposed therebetween.

For example, in this specification, when elements and the like are described as being electrically connected to each other, the elements are directly and electrically connected to each other or the elements are indirectly and electrically connected to each other with another element interposed therebetween.

According to an embodiment, a method of obtaining meat properties information may include obtaining an image obtained by capturing at least a part of meat, obtaining a pre-processed image obtained by pre-processing the image, extracting a region of interest (ROI) from the pre-processed image, extracting a first region and a second region which correspond to at least some parts of the ROI using a predetermined algorithm, obtaining first information on the basis of analysis of the first region, obtaining second information on the basis of analysis of the second region, and obtaining meat properties information, wherein the obtaining of the meat properties information may include obtaining the meat properties information on the basis of the first information and the second information.

The extracting of the ROI may include obtaining segmentation information by segmenting the pre-processed image, and extracting the ROI on the basis of the segmentation information.

The ROI may be a region of the pre-processed image, which corresponds to at least a part of the meat to be analyzed.

The first region and the second region may be regions determined according to a predetermined criterion, wherein the first region may be a region of the ROI, in which extramuscular fat is positioned, and the second region may be a region of the ROI, in which intramuscular fat is positioned.

The first region and the second region may be regions determined according to a predetermined criterion, wherein the first region may be a region of the ROI, in which a ratio of components constituting the meat is greater than or equal to a predetermined criterion, and the second region may be a region of the ROI, in which the ratio of the components constituting the meat is less than the predetermined criterion.

The second region may be a region of the ROI excluding the first region.

The extracting of the first region and the second region may include extracting the first region using a first algorithm and extracting the second region using a second algorithm, wherein the first algorithm and the second algorithm may be different algorithms.

The extracting of the first region and the second region may include extracting the first region from the ROI and, when it is checked that the first region is extracted, extracting the second region from the ROI.

The first information may be information on major components of the meat corresponding to the first region, and the second information may be information on major components of the meat corresponding to the second region, wherein the major components of the meat may include fat and protein.

After the performance of the obtaining of the first information is completed, the obtaining of the second information may be performed.

The first information may be obtained based on a result of analyzing the first region using a pre-trained neural network model, and the second information may be obtained based on a result of analyzing the second region using the pre-trained neural network model.

The obtaining of the pre-processed image may include converting a format of the obtained image so that the obtained image has a format corresponding to that of an image used for training the neural network model.

The method may further include obtaining non-image data related to the meat, wherein the non-image data may be data related to at least one of a type of the meat, a part of the meat, a weight of the meat, an ambient temperature, and an ambient humidity.

The method may further include obtaining non-image data related to the meat, wherein the non-image data is data related to a state of air and a weight of the meat.

The state of the air may be at least one of an amount of moisture in the air, a temperature of the air, and a surface temperature of the meat.

The method may further include obtaining third information on the basis of analysis of the non-image data, wherein the obtaining of the meat properties information may include obtaining the meat properties information on the basis of the first information, the second information, and the third information.

The obtaining of the meat properties information may include obtaining preliminary meat properties information on the basis of the first information and the second information, and obtaining the meat properties information by reflecting the non-image data an auxiliary indicator to the preliminary meat properties information as.

According to an embodiment, an electronic device may include at least one processor, wherein the at least one processor may obtain an image obtained by capturing at least a part of meat, obtain a pre-processed image obtained by pre-processing the image, extract an ROI from the pre-processed image, extract a first region and a second region which correspond to at least some parts of the ROI using a predetermined algorithm, obtain first information on the basis of analysis of the first region, obtain second information on the basis of analysis of the second region, and obtain meat properties information on the basis of the first information and the second information.

According to an embodiment, in a non-transitory computer-readable storage medium which is connected to an electronic device and on which a computer program for executing operations is stored, the operations may include obtaining an image obtained by capturing at least a part of meat, obtaining a pre-processed image obtained by pre-processing the image, extracting an ROI from the pre-processed image, extracting a first region and a second region which correspond to at least some parts of the ROI using a predetermined algorithm, obtaining first information on the basis of analysis of the first region, obtaining second information on the basis of analysis of the second region, and obtaining meat properties information, wherein the obtaining of the meat properties information may include obtaining the meat properties information on the basis of the first information and the second information.

An automatic meat cooking device disclosed in this application may include at least one heat source and at least one processor, wherein the at least one processor may obtain meat properties information determined based on an image obtained by capturing at least a part of meat, obtain user preference, determine a temperature condition and a time condition on the basis of at least one of the meat properties information and the user preference, determine a cooking method on the basis of the temperature condition and the time condition, and control the at least one heat source on the basis of the cooking method.

The time condition may be a condition for controlling the at least one heat source during a time period including a first time period and a second time period.

The at least one heat source may be controlled to be at a first temperature in the first time period and controlled to be at a second temperature in the second time period.

The at least one heat source may be controlled according to a first temperature curve in the first time period and controlled according to a second temperature curve in the second time period.

The first time period may be a time period required to cook a front surface of the meat, and the second time period may be a time period required to cook a rear surface of the meat.

The first temperature curve may correspond to the second temperature curve.

The first time period may include a plurality of sub-time periods wherein the plurality of sub-time periods may include a first sub-time period and a second sub-time period, the at least one heat source may be controlled to be at the first temperature in the first sub-time period and controlled to be at the second temperature in the second sub-time period, and the first temperature and the second temperature may be different from each other.

The second time period may include a plurality of sub-time periods wherein the plurality of sub-time periods may include a third sub-time period and a fourth sub-time period, the at least one heat source may be controlled to be at a third temperature in the third sub-time period and controlled to be at a fourth temperature in the fourth sub-time period, and the third temperature and the fourth temperature may be different from each other.

The automatic meat cooking device may further include a memory in which a plurality of cooking techniques are stored, wherein the at least one processor may determine one cooking technique from among the plurality of cooking techniques on the basis of at least one of the meat properties information and the user preference and determine the cooking method on the basis of the determined cooking technique.

The plurality of cooking techniques may include at least one of a resting technique and a searing technique.

The temperature condition may include a first temperature condition and a second temperature condition, the time condition may include a first time condition and a second time condition, the at least one processor may determine a first cooking method on the basis of the first temperature condition and the first time condition, determine a second cooking method on the basis of the second temperature condition and the second time condition, control the at least one heat source during the first time period on the basis of the first cooking method, and control the at least one heat source during the second time period on the basis of the second cooking method, and the first time period and the second time period may be different from each other.

The at least one heat source may be controlled based on the cooking method, wherein the at least one heat source may be controlled such that the temperature is controlled to be at the first temperature in the first time period and then gradually decreased.

The at least one heat source may be controlled based on the cooking method, wherein the at least one heat source may be controlled such that the temperature is controlled to be at the second temperature in the second time period and then gradually decreased.

The cooking method may be a method of controlling the at least one heat source in consideration of the meat properties information so that the meat is cooked according to the user preference.

The user preference may relate to at least one of meat juiciness, meat tenderness, and meat flavor.

An automatic meat cooking device disclosed in this application may include a transfer module, a pushing module, at least one grilling module, and at least one processor that controls the transfer module, the pushing module, and the at least one grilling module, wherein the at least one processor may determine one of the at least one grilling module as a target grilling module according to a predetermined criterion, move meat to be cooked to the target grilling module using the transfer module and the pushing module, and control the target grilling module on the basis of a predetermined cooking method.

The at least one grilling module may include a first grilling module and a second grilling module, wherein the at least one processor may control the first grilling module and the second grilling module parallelly.

The transfer module may be provided in the form of a rail and may include at least one sensor, wherein the transfer module may move the meat to be cooked to the target grilling module on the basis of a value measured by the at least one sensor.

The at least one processor may obtain an image obtained by capturing at least a part of the meat to be cooked, obtain meat properties information on the basis of analysis of the image, obtain user preference, and determine the cooking method on the basis of the meat properties information and the user preference.

The at least one processor may obtain non-image data and determine the cooking method on the basis of the non-image data, the meat properties information, and the user preference.

The automatic meat cooking device may further include a storage module, wherein the storage module may include a space in which pieces of candidate meat before being cooked are stored.

The at least one processor may obtain the user preference and determine one of the pieces of candidate meat stored in the storage module as the meat to be cooked on the basis of the user preference.

The user preference may relate to at least one of meat juiciness, meat tenderness, and meat flavor.

In the storage module, at least one storage container or at least one plate containing the pieces of candidate meat before being cooked may be provided.

Information on properties of the candidate meat may be mapped to the at least one storage container or the at least one plate, and the at least one processor may determine one of the pieces of candidate meat stored in the storage module as the meat to be cooked on the basis of a value obtained by the mapping.

The at least one storage container or the at least one plate may be disposed according to a predetermined arrangement criterion, and the at least one processor may determine one of the pieces of candidate meat stored in the storage module as the meat to be cooked on the basis of the arrangement criterion.

The at least one processor may determine a grilling module in a standby state among the at least one grilling module as the target grilling module.

The at least one processor may determine a grilling module heated at a temperature closest to a predetermined value among the at least one grilling module as the target grilling module.

The at least one processor may determine a grilling module positioned closest to the storage module among the at least one grilling module as the target grilling module.

The automatic meat cooking device may further include a storage module, wherein the at least one processor may determine a grilling module in a standby state among the at least one grilling module, when there are a plurality of grilling modules in the standby state, determine a grilling module which is heated at the most appropriate temperature among the plurality of grilling modules in the standby state as the target grilling module, and when there are a plurality of grilling modules heated at the most appropriate temperature, determine a grilling module positioned closest to the storage module among the plurality of grilling modules heated at the most appropriate temperature as the target grilling module.

A cooking device disclosed in this application may include a first grilling plate, a second grilling plate disposed to face the first grilling plate, a shaft that adjusts a distance between the first grilling plate and the second grilling plate, and at least one processor that controls an operation of the shaft, wherein the at least one processor may control the operation of the shaft so that the distance between the first grilling plate and the second grilling plate becomes a first distance when the first grilling plate and the second grilling plate operate in a first mode, the at least one processor may control the operation of the shaft so that the distance between the first grilling plate and the second grilling plate becomes a second distance when the first grilling plate and the second grilling plate operate in a second mode wherein the second distance is shorter than the first distance, and the at least one processor may allow heat to be applied to meat placed between the first grilling plate and the second grilling plate by heat being applying to the first grilling plate and the second grilling plate.

When the first grilling plate and the second grilling plate operate in the first mode, meat to be cooked may be placed on the first grilling plate or the second grilling plate or meat cooked may be discharged from the first grilling plate or the second grilling plate, and when the first grilling plate and the second grilling plate operate in the second mode, the placed meat may be cooked by the first grilling plate and the second grilling plate.

When the first grilling plate and the second grilling plate operate in the second mode, the first grilling plate may apply heat to a first surface of the placed meat, and the second grilling plate may apply heat to a second surface of the placed meat.

The cooking device may further include at least one elastic member, wherein the at least one elastic member may be directly or indirectly connected to the second grilling plate to transmit power generated by the shaft to the second grilling plate. The at least one elastic member may include a first support, a second support, a buffer member, and a protruding member.

The first support may have an inner space and may be formed to be coupled to the second support, and at least a part of the second support may be inserted into at least a part of the inner space of the first support.

An opening may be formed in at least a part of a side surface of the first support, a protruding member may be provided on at least a part of a side surface of the second support, and when the at least a part of the second support is inserted into the inner space of the first support, the opening and the protruding member may guide the at least a part of the second support to be inserted only within a predetermined range.

The buffer member may be attached to one surface of the second support and inserted and disposed into the inner space of the first support, and may allow an impact generated when the at least a part of the second support is inserted into the inner space of the first support to be reduced.

The cooking device may further include a housing having an inner space, and when the first grilling plate and the second grilling plate operate in the second mode, at least a part of the first grilling plate and at least a part of the second grilling plate may be accommodated in the inner space of the housing.

The housing may include a housing body and a housing cover, wherein the housing body may form an inner space with at least one surface open, and the housing cover may be provided to open or close at least a part of the open part of the housing body.

The cooking device may further include a sub-housing, wherein the sub-housing may be fluidly connected to the housing, and a blowing fan may be provided in the sub-housing to discharge smoke generated in the housing to the outside.

When the first grilling plate and the second grilling plate operate in the second mode, the at least one processor may control the operation of the shaft so that the second grilling plate moves toward the first grilling plate.

When the first grilling plate and the second grilling plate operate in the second mode, the at least one processor may control the operation of the shaft so that the housing moves toward the first grilling plate at a first time point, and control the operation of the shaft so that the second grilling plate moves toward the first grilling plate at a second time point, which is a time point later than the first time point.

At the second time point, the second grilling plate may be accommodated in the inner space of the housing.

At the second time point, at least a part of the first grilling plate and the second grilling plate may be accommodated in the inner space of the housing.

The cooking device may further include a housing having an inner space, and when the first grilling plate and the second grilling plate operate in the second mode, the at least one processor may control the operation of the shaft so that the housing moves toward the first grilling plate at a first time point, and control the operation of the shaft so that the second grilling plate moves toward the first grilling plate at a second time point, which is a time point later than the first time point, wherein, at the first time point, the protruding member formed on the second support may be positioned at one end of the opening formed on the first support, and at the second time point, the protruding member formed on the second support may be positioned at the other end of the opening formed on the first support.

The cooking device may further include a housing having an inner space, and when the first grilling plate and the second grilling plate operate in the first mode, a distance from the ground to an end of the housing may be smaller than or equal to a distance from the ground to the first grilling plate, and when the first grilling plate and the second grilling plate operate in the second mode, the distance from the ground to the end of the housing may be greater than or equal to the distance from the ground to the first grilling plate.

The cooking device may further include a housing having an inner space, and the at least one elastic member may be disposed in the inner space of the housing.

A shape of the first grilling plate and a shape of the second grilling plate may correspond to each other.

The shape of the first grilling plate may be a shape in which a plurality of grooves are formed at regular intervals, and the shape of the second grilling plate may correspond to the shape of the first grilling plate.

When the first grilling plate and the second grilling plate are disposed to face each other, a cooking space may be formed due to the plurality of grooves formed in the first grilling plate and the plurality of grooves formed in the second grilling plate.

A first temperature sensor may be provided on the first grilling plate, a second temperature sensor may be provided on the second grilling plate, and the at least one processor may control a temperature of the first grilling plate and a temperature of the second grilling plate on the basis of the first temperature sensor and the second temperature sensor.

A first heat insulation plate may be provided on the first grilling plate, and a second heat insulation plate may be provided on the second grilling plate, wherein one surface of the first grilling plate and one surface of the second grilling plate may face each other, the first heat insulation plate may be disposed on another surface of the first grilling plate, and the second heat insulation plate may be disposed on another surface of the second grilling plate.

A cooking device disclosed in this application may include a grilling module including a first grilling plate and a second grilling plate, a pushing module provided to be moveable toward the grilling module, and at least one processor that controls operations of the grilling module and the pushing module, wherein the at least one processor may control the grilling module to operate in a first mode or a second mode, when the grilling module operates in the first mode, a distance between the first grilling plate and the second grilling plate may become a first distance, and when the grilling module operates in the second mode, the distance between the first grilling plate and the second grilling plate may become a second distance.

The first grilling plate and the second grilling plate may be disposed to face each other, wherein the first grilling plate may be disposed to be spaced a preset distance from an upper part of the second grilling plate.

When the grilling module operates in the first mode, meat to be cooked may be placed on the first grilling plate or the second grilling plate, and when the grilling module operates in the second mode, the placed meat may be cooked by the first grilling plate and the second grilling plate.

The at least one processor may control the operation of the pushing module in conjunction with the operation of the grilling module.

When the grilling module operates in the first mode, the at least one processor may control the pushing module to reciprocate toward the grilling module by a predetermined distance.

The pushing module may include a first pushing module and a second pushing module.

The first pushing module and the second pushing module may be disposed to form a step difference from each other, and the first pushing module may be disposed to be spaced a preset distance from an upper part of the second pushing module.

The at least one processor may control the grilling module to operate in a third mode, and when the grilling module operates in the third mode, a distance between the first grilling plate and the second grilling plate may become a third distance.

The first distance may be longer than the third distance, and the third distance may be longer than the second distance.

When the grilling module operates in the first mode, the at least one processor may control the second pushing module to reciprocate toward the grilling module by a predetermined distance, and when the grilling module operates in the third mode, the at least one processor may control the first pushing module to reciprocate toward the grilling module by a predetermined distance.

When the first distance from the ground to the second pushing module corresponds to the second distance from the ground to the second grilling plate, the at least one processor may control the second pushing module to reciprocate toward the grilling module by a predetermined distance.

When the first distance from the ground to the first pushing module corresponds to the second distance from the ground to the second grilling plate, the at least one processor may control the first pushing module to reciprocate toward the grilling module by a predetermined distance.

A cleaning member may be additionally provided in the first pushing module, and the first grilling plate or the second grilling plate may be cleaned due to the cleaning member according to an operation of the first pushing module.

The first pushing module and the second pushing module may operate in conjunction with each other, wherein the first pushing module may operate when the second pushing module does not operate, and the second pushing module may operate when the first pushing module does not operate.

The grilling module may include a first grilling module and a second grilling module, and the at least one processor may control the pushing module to operate in conjunction with the first grilling module and the second grilling module.

A cooking device disclosed in this application may include a grilling module including at least one grilling plate, a cleaning module provided to be moveable toward the grilling module, and at least one processor that controls the grilling module and the cleaning module, wherein the at least one processor may control the cleaning module to operate in conjunction with the operation of the grilling module, and when the grilling module operates in a first mode to clean the at least one grilling plate, the at least one processor may control the cleaning module.

The grilling module may include a first grilling plate and a second grilling plate, the first grilling plate and the second grilling plate may be disposed to face each other, and the first grilling plate may be disposed to be spaced a preset distance from an upper part of the second grilling plate.

When the grilling module operates in the first mode, a distance between the first grilling plate and the second grilling plate may become a first distance.

When the grilling module operates in the first mode, the at least one processor may control the cleaning module to reciprocate toward the grilling module by a predetermined distance.

The cleaning module may include a supply roller in which a roll of paper is provided, a collection roller that collects the roll of paper, and a rotation roller that is indirectly connected to the supply roller and the collection roller so that the supply roller and the collection roller may be interlocked and rotated.

The cleaning module may include a plate connected to the rotation roller to guide movement of the paper, and at least one pressing member that assists the paper to move in close contact with the plate.

When it is determined that an abnormal situation has occurred in at least one of the supply roller, the collection roller, and the rotation roller, the at least one processor may provide an alarm to a user.

When it is determined that all of the roll of paper provided in the supply roller is exhausted, the at least one processor may provide an alarm to the user.

The at least one processor may determine whether the roll of paper provided in the supply roller is exhausted, on the basis of the number of rotations of the at least one of the supply roller, the collection roller, and the rotation roller or a value measured by a sensor.

The collection roller may be directly or indirectly connected to a driving unit and may provide power to the supply roller or the rotation roller.

A shape of the rotation roller may correspond to a shape of the at least one grilling plate.

A plurality of grooves may be formed in the at least one grilling plate at a first interval, and a plurality of protruding members may be formed on the rotation roller at a second interval, wherein shapes of the plurality of protruding members may correspond to shapes of the plurality of grooves, and the first interval may be identical to the second interval within an error range.

The at least one pressing member may include a first pressing member and a second pressing member, the first pressing member may be disposed on one surface of the plate, and the second pressing member may be disposed on another surface of the plate.

The first pressing member and the second pressing member may be disposed to be symmetrical to each other with respect to the plate.

The first pressing member and the second pressing member may be disposed in regions adjacent to the rotation roller on the plate.

The first pressing member and the second pressing member may be disposed at points spaced a preset distance from the rotation roller.

The at least one pressing member may further include a third pressing member and a fourth pressing member, the first pressing member and the second pressing member may be provided as a pair, and the third pressing member and the fourth pressing member may be provided as a pair.

A device for assisting cooking for meat disclosed in this application may include a display and at least one processor, wherein the at least one processor may obtain a user input, determine a cooking condition on the basis of the obtained user input, generate a signal for controlling a heat source on the basis of the cooking condition, and output a first alarm when it is determined that the control of the heat source is completed.

The at least one processor may obtain an image obtained by capturing a plate on which meat is cooked, determine a plate state on the basis of analysis of the image of the plate, and output the first alarm on the basis of the plate state.

The first alarm may be an alarm guiding the user to place meat on the plate.

The cooking condition may include a first cooking condition and a second cooking condition, the at least one processor may output a second alarm when it is determined that the control of the heat source is completed according to the first cooking condition, and the at least one processor may output a third alarm when it is determined that the control of the heat source is completed according to the second cooking condition.

The first cooking condition may be a cooking condition for cooking a first surface of meat to be cooked, and the second cooking condition may be a cooking condition for cooking a second surface of the meat to be cooked.

The second alarm may be an alarm guiding the user to flip the meat.

The at least one processor may obtain an image obtained by capturing meat, obtain meat properties information on the basis of analysis of the image of the meat, and determine a cooking condition on the basis of the meat properties information and the user input.

The at least one processor may obtain user preference on the basis of the user input, and determine a cooking condition on the basis of the meat properties information and the user preference, wherein the user preference may relate to at least one of meat juiciness, meat tenderness, and meat flavor.

The plate may be divided into a first region and a second region according to a predetermined criterion, a first temperature value for the first region and a second temperature value for the second region may be obtained, at least one region of the first region and the second region that satisfies the cooking condition may be determined based on the first temperature value and the second temperature value, and information on the determined at least one region may be output.

The at least one processor may divide the plate into the first region and the second region according to a predetermined criterion, obtain the first temperature value for the first region and the second temperature value for the second region, determine one of the first region and the second region that is closest to a preset temperature value as a cooking region, and output an alarm guiding the user to place the meat in the cooking region.

A method of generating an improved cooking recipe disclosed in this application may include obtaining a target meat, obtaining meat properties information through analysis of the target meat, obtaining a first target value related to a first type of property from a user input, determining a basic cooking recipe on the basis of the meat properties information and the first target value, cooking the target meat according to the basic cooking recipe to obtain the cooked meat, analyzing the cooked meat to obtain a first result value related to the first type of property, comparing the first target value with the first result value to obtain a first comparison value, and determining a final cooking recipe on the basis of the first comparison value.

The determining of the final cooking recipe may include, when the first comparison value is greater than or equal to a predetermined value, modifying the basic cooking recipe on the basis of the first target value and the first result value, and determining a cooking recipe obtained by modifying the basic cooking recipe as the final cooking recipe.

The method of generating the improved cooking recipe may further include obtaining a second target value related to a second type of property from the user input, analyzing the cooked meat to obtain a second result value related to the second type of property, and comparing the second target value with the second result value to obtain a second comparison value, wherein the determining of the basic cooking recipe may further include determining the basic cooking recipe on the basis of the meat properties information, the first target value, and the second target value, and the determining of the final cooking recipe may further include determining the final cooking recipe on the basis of the first comparison value and the second comparison value.

The determining of the final cooking recipe may include, when the second comparison value is greater than or equal to a predetermined value, modifying the basic cooking recipe on the basis of the second target value and the second result value, and determining a cooking recipe obtained by modifying the basic cooking recipe as the final cooking recipe.

The first type of property may relate to at least one of meat flavor, meat juiciness, and meat tenderness.

The second type of property may relate to at least one of meat flavor, meat juiciness, and meat tenderness and may be different from the first type of property.

The first type of property may relate to the meat tenderness, and the first result value may be obtained by performing a tenderness test on the cooked meat.

The tenderness test may be a texture profile analysis (TPA) test.

The first type of property may relate to the meat juiciness, the first target value may be a weight of the target meat, and the first result value may be a weight of the cooked meat.

The first result value may be a weight measured after a pressure test is performed on the cooked meat.

The determining of the final cooking recipe may include, when the first comparison value is less than a predetermined value, determining the basic cooking recipe as the final cooking recipe.

The determining of the final cooking recipe may include, when the first comparison value and the second comparison value are less than a predetermined value, determining the basic cooking recipe as the final cooking recipe.

1 Entire System

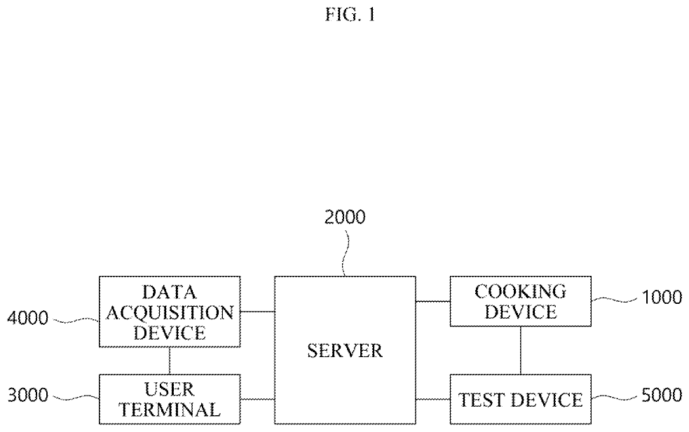

FIG. 1 is a diagram for describing an automatic meat cooking system according to an embodiment.

Referring to FIG. 1, the automatic meat cooking system according to the embodiment may include a cooking device 1000, a server 2000, a user terminal 3000, a data acquisition device 4000, or a test device 5000.

The automatic meat cooking system according to the embodiment may determine a meat cooking method on the basis of information (e.g., type, part, fat/protein ratio, etc. of meat) on properties of meat to be cooked and user preference (e.g., degree of juiciness, tenderness, and/or flavor), and then control a heat source and cooking time of a cooking device according to the determined meat cooking method to automatically cook the meat. Furthermore, the automatic meat cooking system according to the embodiment may provide a feedback system for performing a test on the meat cooked using the above-described method and improving a cooking method on the basis of a result of performing the test.

More specifically, the automatic meat cooking system according to the embodiment may obtain data related to the meat to be cooked from the data acquisition device 4000, obtain the meat properties information from the server 2000 on the basis of the obtained data related to the meat, obtain information on the user preference from the user terminal 3000, and then allow the cooking device 1000 to control the heat source or the heating time according to the cooking method determined based on the meat properties information and the meat preference information.

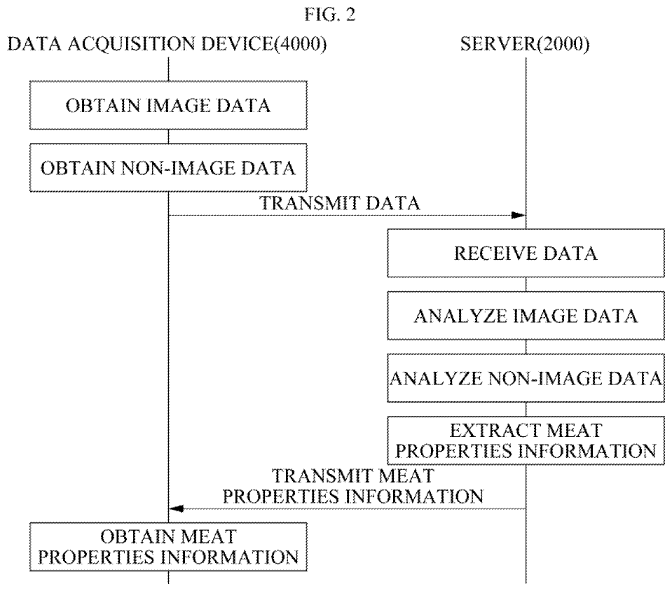

FIG. 2 is an exemplary flowchart for describing a method of obtaining meat properties information in an automatic meat cooking system according to an embodiment.

Referring to FIG. 2, a data acquisition device 4000 according to the embodiment may obtain image data or non-image data. The image data may be an image obtained by capturing meat, and the non-image data may be data related to factors (e.g., type of meat, part of meat, weight of meat, ambient temperature, ambient humidity, etc.) affecting a method of cooking meat.

The data acquisition device 4000 may transmit the obtained data to the server 2000. The data acquisition device 4000 may transmit the obtained image data and/or non-image data to the server 2000.

The server 2000 may receive data from the data acquisition device 4000 and then analyze the data to obtain meat properties information. The server 2000 may obtain the meat properties information on the basis of a result of analyzing at least one of the image data and the non-image data. A more detailed description of a method of extracting, by the server 2000, the meat properties information on the basis of the result of analyzing the image data and/or the non-image data will be given below.

For example, the meat properties information may include information (e.g., ratio of fat and protein, information on marbling, etc.) on components constituting the meat, information on a weight, a shape, a size, a thickness etc. of the meat, and information on a type, a part, an aging condition, etc. of the meat.

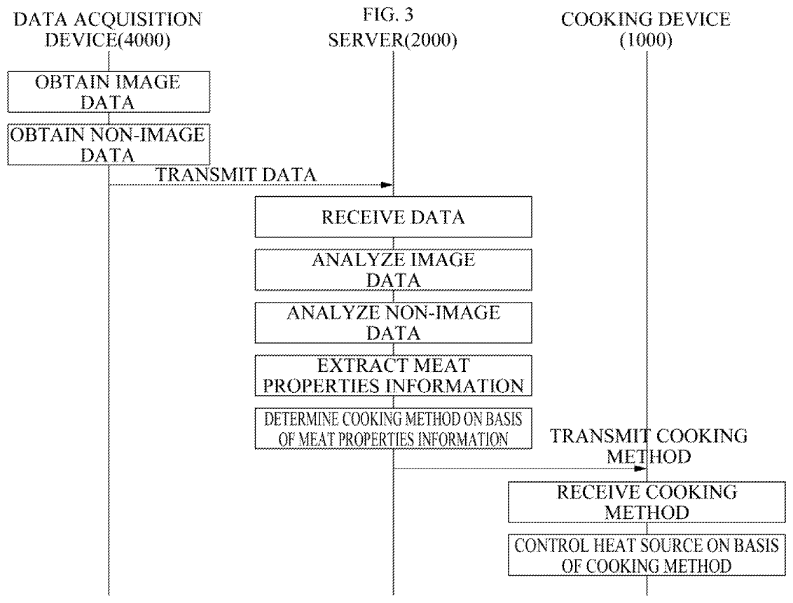

FIG. 3 is an exemplary diagram for describing a method of determining a cooking method on the basis of meat properties information and controlling a cooking device according to the determined cooking method in an automatic meat cooking system according to an embodiment.

Referring to FIG. 3, a server 2000 may extract the meat properties information in the method described above with reference to FIG. 2. The server 2000 may determine the cooking method on the basis of the extracted meat properties information. A more detailed description of the method of determining, by the server 2000, the cooking method on the basis of the meat properties information will be given below.

A cooking device 1000 may receive the cooking method from the server 2000 and then control the heat source on the basis of the cooking method. The cooking device 1000 may control a temperature of the heat source on the basis of the cooking method. The cooking device 1000 may control an operation time and/or timing of the heat source on the basis of the cooking method. The cooking device 1000 may control operations of various components other than the heat source on the basis of the cooking method, and a more detailed description thereof will be given below.

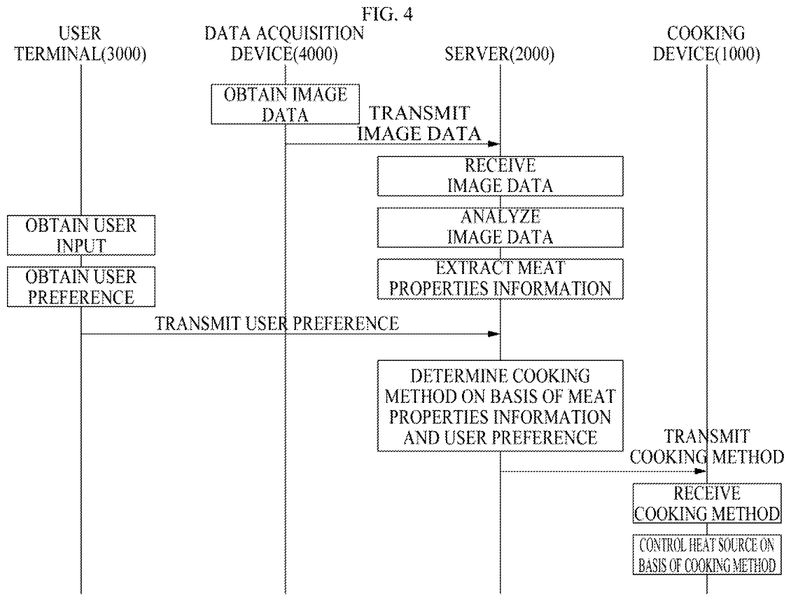

FIG. 4 is an exemplary diagram for describing a method of determining a cooking method on the basis of user preference and meat properties information in an automatic meat cooking system according to an embodiment.

Referring to FIG. 4, a user terminal 3000 may obtain a user input. The user terminal 3000 may obtain a user input in which user preference for meat is reflected. The user terminal 3000 may obtain the user input and derive user preference on the basis of the obtained user input.

For example, the user preference obtained or derived from the user terminal is related to a result of cooking the meat, and may be related to a taste of meat desired by the user, such as meat flavor, meat juiciness, meat tenderness, etc.

A server 2000 may extract meat properties information in the methods described above with reference to FIGS. 2 and 3, and determine a cooking method on the basis of the extracted meat properties information and the user preference obtained from the user terminal 3000. Amore detailed description of the method of determining the cooking method on the basis of the meat properties information and the user preference will be given below.

A cooking device 1000 may control operations of a heat source or other components constituting the cooking device 1000 on the basis of the determined cooking method.

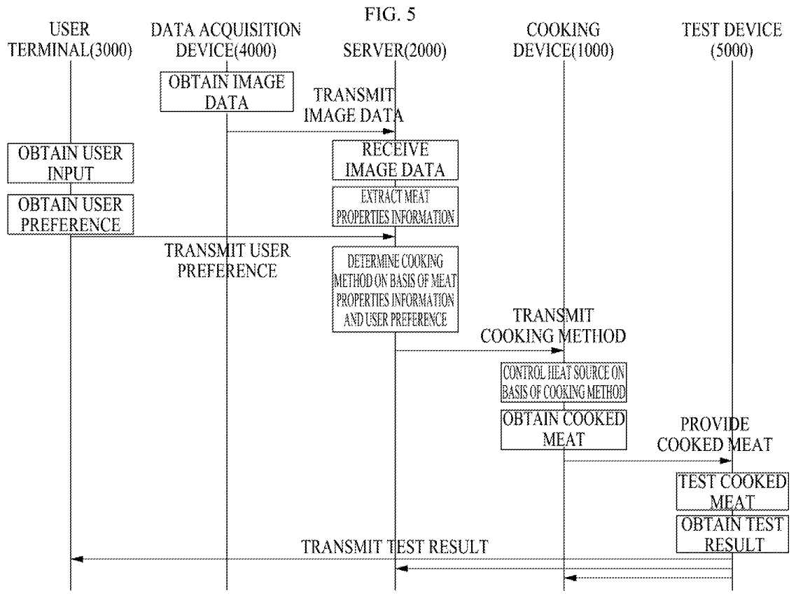

FIG. 5 is an exemplary diagram for describing a test performed on meat that has been cooked in an automatic meat cooking system according to an embodiment.

Referring to FIG. 5, a cooking device 1000 may control a heat source or the like according to the methods described above with reference to FIGS. 2 to 4 and obtain meat that has been cooked through the control of the heat source or the like.

A test device 5000 may obtain the meat that has been cooked and then perform at least one test on the meat that has been cooked. The test device 5000 may perform at least one test for determining whether the meat is appropriately cooked according to a predetermined cooking method. The test device 5000 may perform at least one test for determining whether the meat is appropriately cooked in response to a user input and/or user preference obtained from a user terminal 3000. A more detailed description of the type and method of the test performed by the test device 5000 will be given below.

The automatic meat cooking system described above with reference to FIGS. 2 to 5 is exemplary and is not limited to the contents illustrated in the accompanying drawings. A subject performing each step and/or operation performed by the automatic meat cooking system according to the embodiment is not limited to the subject described above with reference to FIGS. 2 to 5, and the subject of each step and/or operation described above may be performed by different subjects.

Hereinafter, the automatic meat cooking system described above with reference to FIGS. 2 to 5 will be described in more detail with reference to the accompanying drawings.

2 Acquisition of Meat Properties Information

In order to cook raw meat in a desired way in consideration of user preference, the raw meat should be cooked at an appropriate temperature for an appropriate period of time, and at the same time, properties of the raw meat should be accurately identified and the raw meat should be cooked in consideration of the properties of the raw meat.

Conventionally, accurately identifying properties of raw meat and then cooking the raw meat at an appropriate temperature for an appropriate period of time in consideration of the identified properties of the raw meat were performed by the subjective determination of a skilled person, and thus there was a limitation that general stores or general consumers cook raw meat through such a cooking method.

Furthermore, there is a limit in that when properties of raw meat are identified through the experience and determination of each person who cooks, it is not objective, is inconsistent, and may have a certain range of inaccuracy.

In the meat cooking system according to the embodiment, data related to meat may be obtained, and meat properties information may be obtained based on the obtained data. Accordingly, objective and accurate properties information on raw meat to be cooked may be obtained and used as an auxiliary indicator in determining a cooking method in which user preference is reflected.

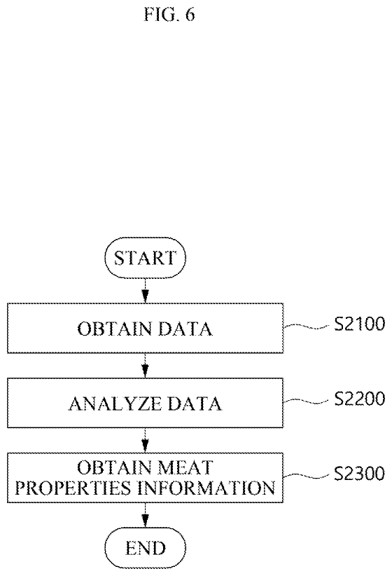

FIG. 6 is an exemplary diagram for describing a method of obtaining, by a server, meat properties information according to an embodiment.

Referring to FIG. 6, a server 2000 according to the embodiment may perform a step S2100 of obtaining data, a step S2200 of analyzing the data, and a step S2300 of obtaining meat properties information.

The server 2000 may obtain data related to meat from an external device through the step S2100 of obtaining the data. Data to be analyzed may include image data and non-image data. The image data may be an image obtained by capturing meat, and the non-image data may be data related to factors (e.g., type of meat, part of meat, weight of meat, ambient temperature, ambient humidity, etc.) affecting a method of cooking meat. The image data may be a set of a plurality of images in which various parts of the meat are photographed, or may be data captured as a video.

The server 2000 may perform analysis on data through the step S2200 of analyzing the data. The server 2000 may perform analysis on at least one of the obtained image data and non-image data using a predetermined algorithm.

The server 2000 may obtain information related to properties of the meat on the basis of a result of analyzing the data through the step S2300 of obtaining the meat properties information. For example, the meat properties information may include information (e.g., ratio of fat and protein, information on marbling, etc.) on components constituting the meat, information on a weight, a shape, a size, a thickness etc. of the meat, and information on a type, a part, an aging condition, etc. of the meat.

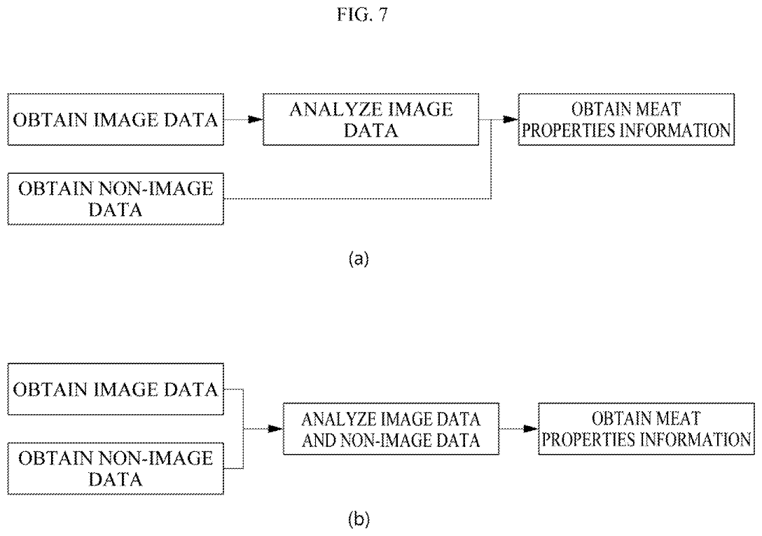

FIG. 7 is a set of exemplary diagrams for describing a method of obtaining, by a server, meat properties information by utilizing image data and non-image data according to an embodiment.

Referring to FIG. 7, a server 2000 according to the embodiment may obtain meat properties information on the basis of image data and/or non-image data.

As illustrated in FIG. 7A, the server 2000 may additionally utilize a result of analyzing the non-image data in order to obtain meat properties information. The server 2000 may obtain the meat properties information on the basis of a result of analyzing the image data and utilize the non-image data as an auxiliary indicator in order to obtain more accurate information. For example, the server 2000 may first obtain the meat properties information from the result of analyzing the image data, and may obtain final meat properties information by utilizing the non-image data as an auxiliary indicator.

As illustrated in FIG. 7B, the server 2000 may obtain meat properties information on the basis of a result of analyzing the image data and a result of analyzing the non-image data. For example, the obtained non-image data may be a subject to separate analysis according to a type of the non-image data, and in this case, the meat properties information may be obtained in additional consideration of not only the result of analyzing the image data but also the result of separately analyzing the non-image data.

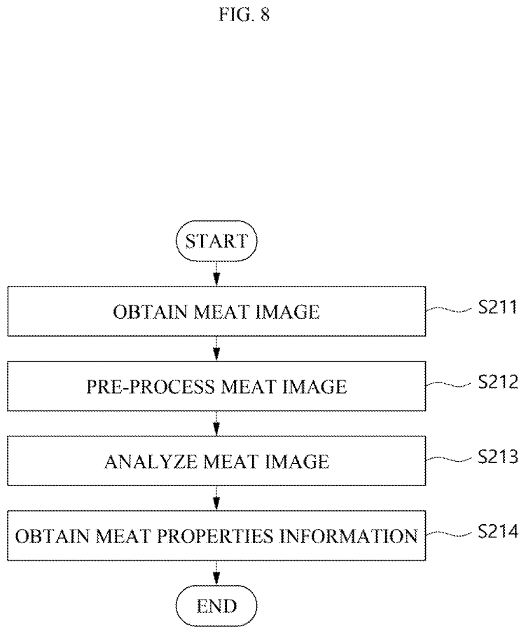

FIG. 8 is a diagram for describing a specific example in which a server obtains meat properties information on the basis of image data according to an embodiment.

Referring to FIG. 8, a server 2000 according to the embodiment may perform a step S211 of obtaining an image of meat, a step S212 of pre-processing the image of the meat, a step S213 of analyzing the image of the meat, and a step S214 of obtaining meat properties information.

The server 2000 may perform pre-processing on the obtained image of the meat through the step S212 of pre-processing the image of the meat. The server 2000 may perform pre-processing to improve accuracy of the obtained meat properties information. The server 2000 may perform pre-processing on the image of the meat before performing the step of analyzing the image of the meat in order to obtain a more accurate analysis result.

As an example, the server 2000 may perform an operation of converting a format of the obtained image of the meat. For example, the server 2000 may perform the operation of converting a format of an image so that the obtained image of the meat has the same format as an image used for training a neural network model. In this case, the image analysis may be performed using the image having the same format as the image used for training the neural network model, and thus a more stable and accurate analysis result may be obtained.

As another example, the server 2000 may perform an operation of removing noise that can be present in the obtained image. For example, a blurring technique and a technique using a mid-dyne filter may be used to remove noise, and a more accurate image analysis result may be derived by performing an operation of removing noise.

As another example, the server 2000 may perform an operation of correcting the intensity of the obtained image. The server 2000 may remove noise that can be present in an image by appropriately correcting the intensity of the image, and accordingly, a more accurate image analysis result may be derived.

The server 2000 according to the embodiment may perform various known pre-processing processes (e.g., an operation of smoothing, an operation of adjusting a ratio of an image, an operation of cutting a part of an image, etc.) that can affect accuracy of image analysis in addition to the above-described methods, but the present invention is not limited thereto. The server 2000 may not perform a pre-processing operation. The server 2000 may obtain meat properties information through analysis of an image that has not been pre-processed.

The server 2000 may obtain the meat properties information through the analysis of the image of the meat, and the method of analyzing the image of the meat will be described below in more detail with reference to the accompanying drawings.

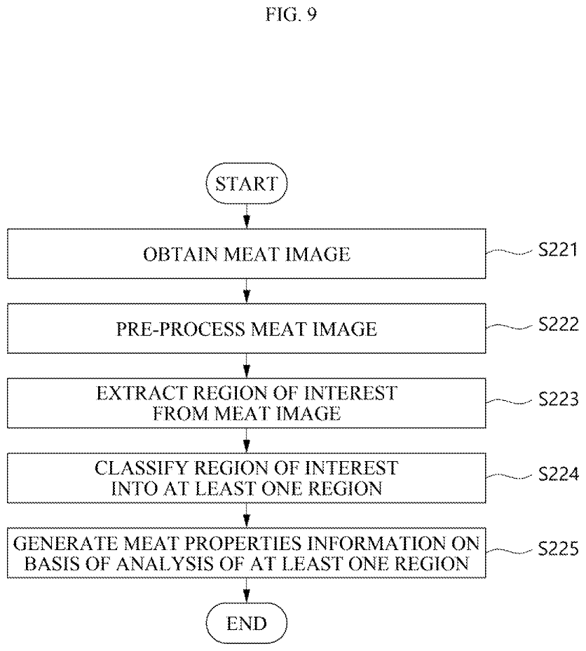

FIGS. 9 to 14 are diagrams for describing a method of obtaining meat properties information on the basis of meat image analysis according to an embodiment.

Referring to FIG. 9, a server 2000 according to the embodiment may perform a step S221 of obtaining an image of meat, a step S222 of pre-processing the image of the meat, a step S223 of extracting an ROI from the image of the meat, a step S224 of classifying the ROI into at least one region, and a step S225 of obtaining meat properties information on the basis of analysis of the at least one region.

Since the step S221 of obtaining the image of the meat and the step S222 of pre-processing the image of the meat which are performed by the server 2000 have been described above, overlapping descriptions thereof will be omitted.

The server 2000 may perform an operation of extracting an ROI from the image of the meat through the step S223 of extracting the ROI from the image of the meat.

The server 2000 may obtain an ROI and information related to the ROI on the basis of segmentation information obtained by segmenting the obtained image of the meat. The server 2000 may obtain information related to the ROI from the segmentation information obtained by segmenting the image of the meat. The server 2000 may obtain one or more regions by segmenting the image of the meat, and obtain a region corresponding to an ROI from among the segmented regions.

The ROI may be a region occupied by a target of analysis in the region of the obtained image. The ROI may include at least a region among the regions related to the meat obtained through the segment of the obtained image. The ROI may be pre-defined as a region corresponding to an element to be analyzed on the image. For example, the ROI may be a region for meat to be analyzed in the obtained image, and may be a region in which the background is excluded. As another example, the ROI may be a region for at least a part of meat to be analyzed in the obtained image.

The server 2000 may perform an operation of classifying the extracted ROI into at least one region through the step S224 of classifying the ROI into the at least one region.

The server 2000 may extract an ROI from the image and then classify the extracted ROI into at least one region. However, the present invention is not limited thereto, and the server 2000 may immediately classify the obtained image into at least one region without extracting a separate ROI from the obtained image. Hereinafter, for convenience of description, it will be described that the server 2000 extracts and classifies at least one region from the ROI.

The server 2000 may extract at least one region from the ROI using a predetermined algorithm and then classify the extracted at least one region. The server 2000 may extract a first region and a second region from the ROI using a predetermined algorithm and then classify the first region and the second region.

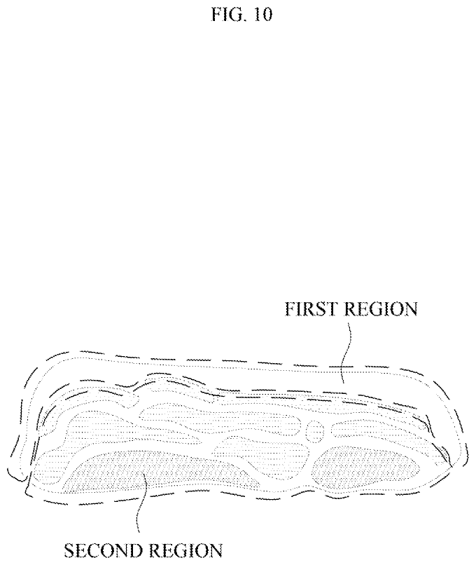

Referring to FIG. 10, the first region is a region corresponding to at least a part of the ROI, and the second region is a region of the ROI excluding the first region, but the present invention is not limited thereto. For example, the ROI may be divided into a plurality of regions according to a predetermined criterion, and each of the first region and the second region may correspond to one of the plurality of regions.

The first region and the second region may be regions of the ROI, which are determined according to the predetermined criterion. For example, the predetermined criterion may be a criterion determined based on a part of meat, components constituting the meat, position information, and the like.

For example, the first region may be a region of the ROI, in which extramuscular fat is positioned, and the second region may be a region of the ROI, in which intramuscular fat is positioned.

As another example, the first region may be a region of the ROI, which is positioned at a first point, and the second region may be a region of the ROI, which is positioned at a second point. For example, the first point may be an upper part of the ROI, and the second point may be a part corresponding to a lower part than the first point.

As another example, the first region may be a region of the ROI, which includes a first point, and the second region may be a region of the ROI, which includes a second point. For example, the first point may be one part within a region constituting the periphery of the ROI, and the second point may be a region corresponding to the center of the ROI.

As another example, the first region may be a region of the ROI, in which a ratio of specific components constituting meat is greater than or equal to a predetermined criterion, and the second region may be a region of the ROI, in which the ratio of specific components constituting the meat is less than the predetermined criterion. For example, the specific component may be one of fat and protein, and may also be a degree of marbling.

Referring to FIG. 9 again, the server 2000 may classify the ROI into at least one region using a pre-trained neural network model. In this case, the pre-trained neural network model may be a model trained to classify an image obtained by capturing meat into the at least one region.

For example, the pre-trained neural network model may be a model trained to extract first and second regions related to the meat from the image obtained by capturing the meat and then classify the first and second regions, or may be a model trained to extract the first and second regions from the ROI and then classify the first and second regions. As a more specific example, the pre-trained neural network model may be a model trained to extract a first region, in which extramuscular fat is positioned, and a second region, in which intramuscular fat is positioned, from the image of the meat (or the ROI) and then classify the first and second regions.

The server 2000 may generate the meat properties information on the basis of analysis of the at least one region through the step S224 of generating the meat properties information.

As an example, the server 2000 may obtain the meat properties information on the basis of a result of analyzing the first region extracted and classified in the above-described method. As another example, the server 2000 may obtain the meat properties information on the basis of a result of analyzing the second region extracted and classified in the above-described method. As still another example, the server 2000 may obtain the meat properties information on the basis of results of analyzing the first region and the second region extracted and classified in the above-described method. Here, since the meat properties information has been described above, overlapping descriptions thereof will be omitted.

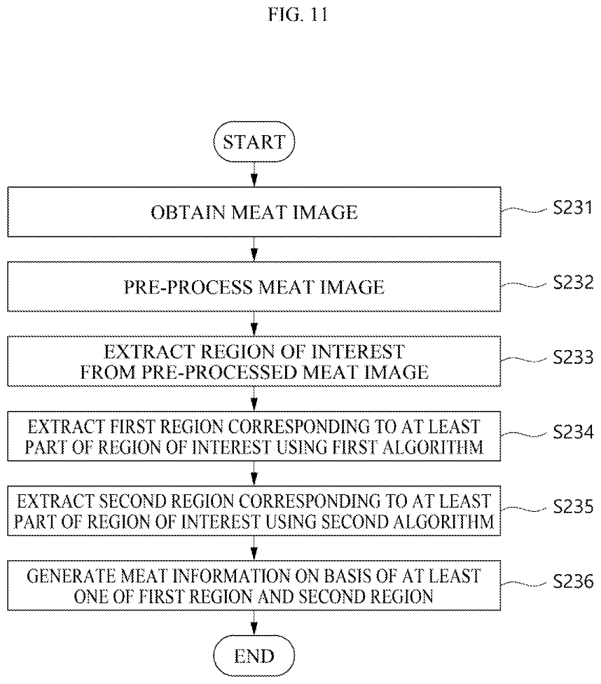

Referring to FIG. 11, the server 2000 may extract and classify at least one region from an ROI using different algorithms.

The server 2000 may extract a first region through a step S234 of extracting a first region corresponding to at least a part of the ROI using a first algorithm, and extract a second region through a step S235 of extracting a second region corresponding to at least a part of the ROI using a second algorithm. Here, the first algorithm and the second algorithm may be different algorithms.

For example, the first algorithm may be an algorithm optimized for extracting the first region from the ROI, and the second algorithm may be an algorithm optimized for extracting the second region from the ROI.

Although not illustrated in the drawing, the server 2000 may extract and classify at least one region from an ROI using different neural network models. For example, the server 2000 may extract a first region corresponding to at least a part of the ROI using a first neural network model, and may extract a second region corresponding to at least a part of the ROI using a second neural network model.

For example, the first neural network model may be a model trained to extract or classify a first region from the ROI, and the second neural network model may be a model trained to extract or classify a second region from the ROI. As a more specific example, the first neural network model may be a model trained to extract extramuscular fat from the ROI, and the second neural network model may be a model trained to extract intramuscular fat from the ROI.

A method of extracting and classifying at least one region from an ROI (or an image obtained by capturing meat) may be performed in various ways other than the methods illustrated in FIGS. 9 and 10. For example, the server 2000 may extract or classify a first region from the ROI using a predetermined algorithm, and may extract or classify a second region from the ROI using a pre-trained neural network model.

Meanwhile, the server 2000 may extract each of the first region and the second region on the basis of a predetermined order. Time points at which the server 2000 extracts the first region and the second region from the ROI may be different from each other.

For example, when the server 2000 first extracts a first region from the ROI and then extracts a second region from the ROI, the first region and the second region may be more accurately extracted. In this case, the server 2000 may perform the step S235 of extracting the second region after the performance of the step S234 of extracting the first region is completed. The server 2000 may preferentially extract the first region from the ROI and then extract the second region from the ROI.

As another example, when the server 2000 first extracts the second region from the ROI and then extracts the first region from the ROI, the first region and the second region may be more accurately extracted. In this case, the server 2000 may perform the step S234 of extracting the first region after the performance of the step S235 of extracting the second region is completed. The server 2000 may preferentially extract the second region from the ROI and then extract the first region from the ROI.

As a more specific example, the server 2000 may extract a first region related to extramuscular fat from the ROI, and after the extraction of the first region is completed, extract a second region related to intramuscular fat. In this case, it is possible to more accurately classify and extract a region related to extramuscular fat and a region related to intramuscular fat from the ROI.

Although not illustrated in the drawing, the server 2000 may extract a first region, a second region, and a third region from the ROI using a predetermined algorithm and then classify the first region, the second region, and the third region. In this case, the first region, the second region, and the third region may be regions of the ROI, which are determined according to a predetermined criterion. The predetermined criterion may be determined based on a part of meat, components constituting the meat, position information, and the like.

For example, the first region may be a region of the ROI, in which extramuscular fat is positioned, the second region may be a region of the region, in which intramuscular fat is positioned, and the third region may be a region in which a bone or tendon is positioned.

As another example, the first region may be a region of the ROI, which is positioned at a first point, the second region may be a region of the ROI, which is positioned at a second point, and the third region may be a region of the ROI, which is positioned at a third point.

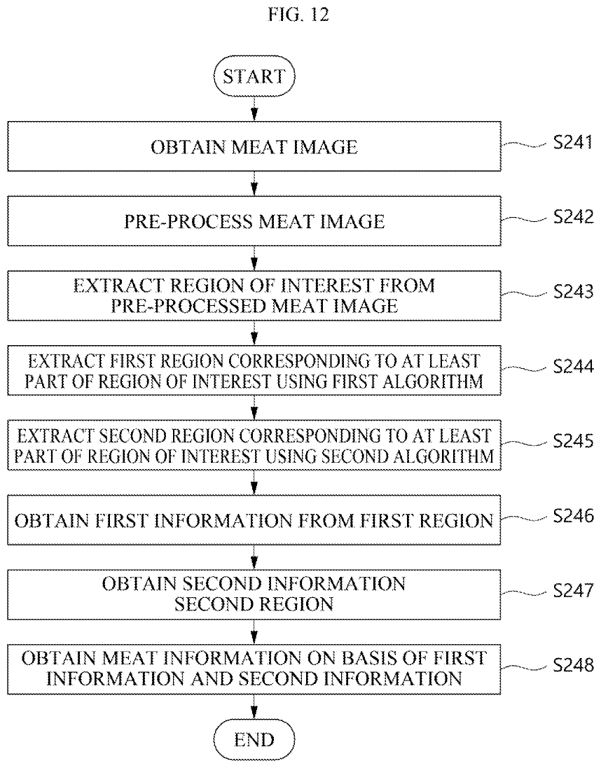

Referring to FIG. 12, the server 2000 may obtain information on at least one region extracted from an ROI and then obtain meat information on the basis of the obtained information.

The server 2000 may obtain first information related to a first region extracted from the ROI through a step S246 of obtaining first information from a first region, and obtain second information related to a second region extracted from the ROI through a step S247 of obtaining second information from a second region. Further, the server 2000 may additionally obtain a third region from the ROI and then obtain third information on the basis of analysis of the third region.

The first information may be obtained through a predetermined algorithm and/or a pre-trained neural network model, and may include information related to major components (e.g., fat, protein, tendon, bone, etc.) constituting meat.

The second information may be obtained through a predetermined algorithm and/or a pre-trained neural network model, and may include information related to major components (e.g., fat, protein, tendon, bone, etc.) constituting meat. In this case, the algorithms and/or the neural network models which are used to obtain the first information and the second information may be the same as or different from each other.

The third information may be obtained through a predetermined algorithm and/or a pre-trained neural network model, and may include information related to major components (e.g., fat, protein, tendon, bone, etc.) constituting meat. In this case, the algorithms and/or the neural network models which are used to obtain the first information, the second information, and the third information may be the same as or different from each other.

For example, the server 2000 may extract a first region from the ROI and then obtain first information on major components constituting meat included in the first region through analysis of the first region. The server 2000 may extract a second region from the ROI and then obtain second information on major components constituting meat included in the second region through analysis of the second region.

As a more specific example, the server 2000 may extract a first region from the ROI and then obtain first information on components constituting extramuscular fat of the meat through analysis of the first region. The server 2000 may extract a second region from the ROI and then obtain second information on components constituting intramuscular fat of the meat through analysis of the second region.

The server 2000 may obtain each of the first information and the second information according to a predetermined order. For example, the server 2000 may perform the step S247 of obtaining the second information from the second region after the performance of the step S246 of obtaining the first information from the first region is completed. More specifically, the server 2000 may perform analysis on the components constituting the region related to the intramuscular fat of the meat through the analysis of the second region after the analysis of the components constituting the region related to the extramuscular fat of the meat through the analysis of the first region is completed. In this case, accuracy of the obtained information can be further improved.

The server 2000 may obtain meat information on the basis of the first information and the second information. For example, in comprehensive consideration of the information on the components constituting the region related to the extramuscular fat and the information on the components constituting the region related to the intramuscular fat, information on meat to be analyzed may be obtained.

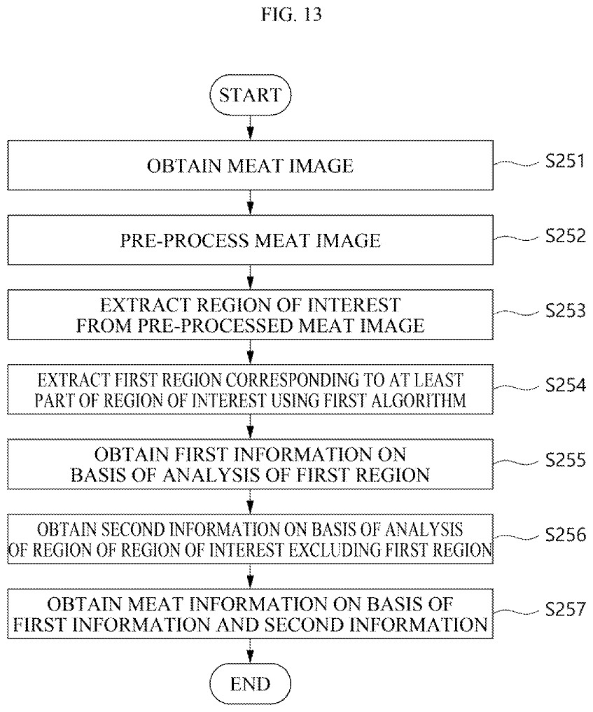

Referring to FIG. 13, the server 2000 may extract an ROI from an image obtained by capturing meat and then extract a first region corresponding to at least a part of the ROI using a first algorithm.

The server 2000 may obtain first information on the basis of analysis of the extracted first region and obtain second information on the basis of analysis of a region of the ROI excluding the first region.

The server 2000 may obtain meat information on the basis of the first information and the second information. In other words, the server 2000 may extract only one region from the ROI and then obtain the meat information on the basis of the analysis of the extracted region. The server 2000 may extract the ROI and then obtain the meat information through analysis of the first region corresponding to at least a partial region of the ROI.

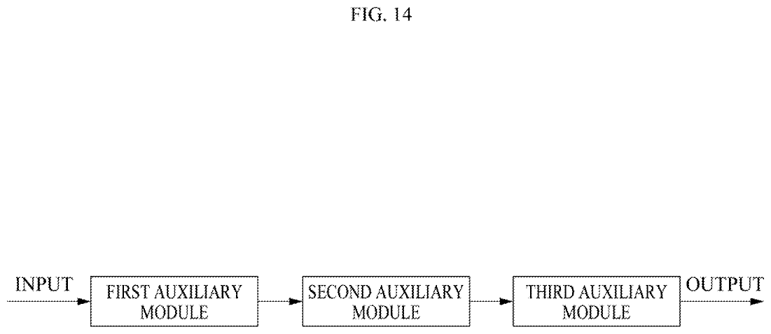

FIG. 14 is an exemplary diagram for describing an auxiliary module used to obtain meat properties information on the basis of meat image analysis according to an embodiment.

Referring to FIG. 14, a server 2000 according to the embodiment may obtain meat properties information on the basis of analysis of an image of meat through at least one auxiliary module.

A first auxiliary module constituting the server 2000 may receive an image obtained by capturing meat and extract an ROI, which is a region to be analyzed. The first auxiliary module may include a pre-trained neural network model. The first auxiliary module may perform an operation of extracting the ROI by segmenting the input image of the meat through the pre-trained neural network model.

A second auxiliary module constituting the server 2000 may receive an image of the ROI extracted through the first auxiliary module, extract a part corresponding to a first region corresponding to at least a partial region of the ROI, and obtain first information through analysis of the part corresponding to the first region. For example, the first region may be a region corresponding to extramuscular fat of the meat, and the first information may be information related to components of the meat, which constitute the extramuscular fat. In this case, since descriptions related to the first region and the first information may be the same as or correspond to those described above with reference to FIGS. 8 to 13, overlapping descriptions thereof will be omitted.

A third auxiliary module constituting the server 2000 may receive the image of the ROI extracted through the first auxiliary module, extract a part corresponding to a second region corresponding to at least a partial region of the ROI, and obtain second information through analysis of the part corresponding to the second region. For example, the second region may be a region corresponding to intramuscular fat of the meat, and the second information may be information related to components of the meat, which constitute the intramuscular fat. In this case, since descriptions related to the second region and the second information may be the same as or correspond to those described above with reference to FIGS. 8 to 13, overlapping descriptions thereof will be omitted.

However, this is exemplary, and the server 2000 according to the embodiment may obtain desired information using two auxiliary modules. For example, the server 2000 may extract an ROI to be analyzed from an image obtained by capturing meat using a first auxiliary module, and extract a first region and/or a second region from the ROI using a second auxiliary module and then obtain information related to components of the meat through analysis of each region.

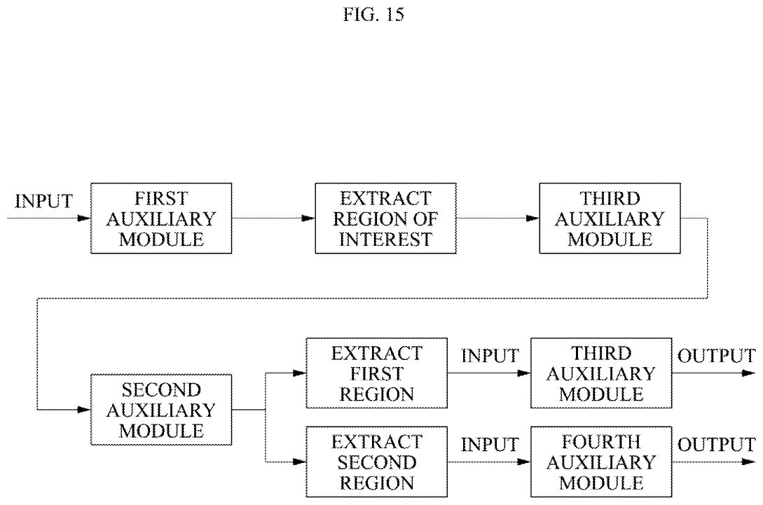

FIG. 15 is an exemplary diagram for describing auxiliary modules used to obtain meat properties information on the basis of meat image analysis according to another embodiment.

Referring to FIG. 15, a first auxiliary module constituting a server 2000 may receive an image obtained by capturing meat and extract an ROI to be analyzed. A second auxiliary module may receive the extracted ROI and extract a first region and/or a second region. In this case, operations performed by the first auxiliary module for extracting the ROI and the second auxiliary module for extracting the first region and/or the second region may be performed using different algorithms and/or different neural network models.

A third auxiliary module constituting the server 2000 may receive the image of the extracted first region, and obtain first information related to components of the meat through analysis of the image. A fourth auxiliary module may receive an image of the second region and obtain second information related to the components of the meat through analysis of the image. In this case, operations performed by the third auxiliary module and the fourth auxiliary module may be performed through the same algorithm and/or neural network model.

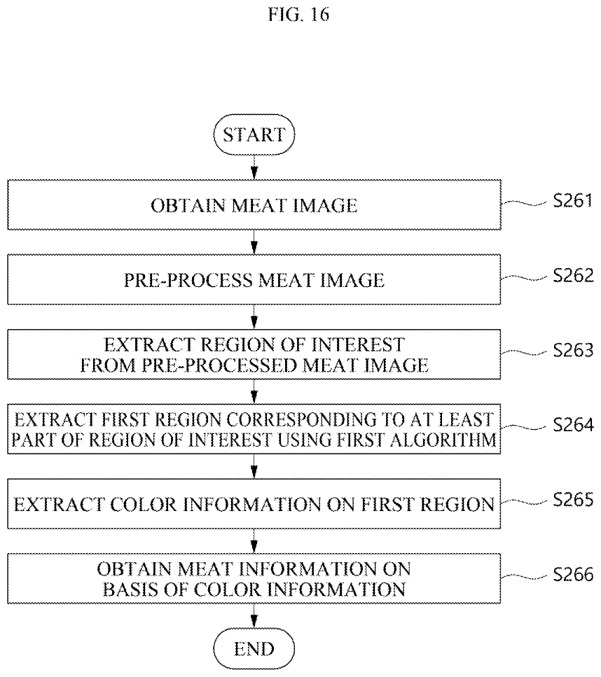

FIG. 16 is a diagram for describing a method of obtaining meat properties information on the basis of meat image analysis according to another embodiment.

Referring to FIG. 16, the server 2000 may perform a step S261 of obtaining an image of meat, a step S262 of pre-processing the image of the meat, a step S263 of extracting an ROI from the pre-processed image of the meat, a step S264 of extracting a first region corresponding to at least a partial region of the ROI using a first algorithm, a step S265 of extracting color information on the first region, and a step S266 of obtaining meat information on the basis of the color information.

Since the step S261 of obtaining the image of the meat to the step S264 of extracting the first region which are performed by the server 2000 may be the same as or correspond to those described above with reference to FIGS. 8 to 13, overlapping descriptions thereof will be omitted.

The server 2000 may extract color information on the first region and obtain meat information on the basis of the extracted color information. The server 2000 may obtain information on the components constituting the meat on the basis of analysis of color constituting the first region.

The server 2000 may obtain information on how long the meat to be analyzed has been left at room temperature on the basis of color information of pixels constituting the first region. For example, the server 2000 may obtain information on a period of time during which the photographed meat is stored at room temperature on the basis of at least one of color, saturation, and/or brightness of the pixels constituting the first region. As a more specific example, when at least one of color, saturation, and/or brightness of the pixels constituting the first region satisfies a predetermined condition, the server 2000 may determine that the photographed meat has been stored at room temperature for a predetermined period of time or longer.

The server 2000 may obtain information on components constituting meat in consideration of the number of pixels corresponding to a first color and the number of pixels corresponding to a second color among the pixels constituting the first region. For example, the server 2000 may obtain information on a period of time during which the meat is placed at room temperature on the basis of the number of pixels corresponding to the first color and the number of pixels corresponding to the second color.

As another example, the server 2000 may obtain information on a ratio of fat and protein constituting meat on the basis of the number of pixels corresponding to the first color and the number of pixels corresponding to the second color.

An operation of obtaining information related to a state of the meat on the basis of the color information, which is performed by the server 2000, may be performed through a pre-trained neural network model. In this case, the neural network model may be a model trained to obtain information on components constituting meat and/or information on a period of time during which the meat is stored at room temperature on the basis of the color information constituting the image.

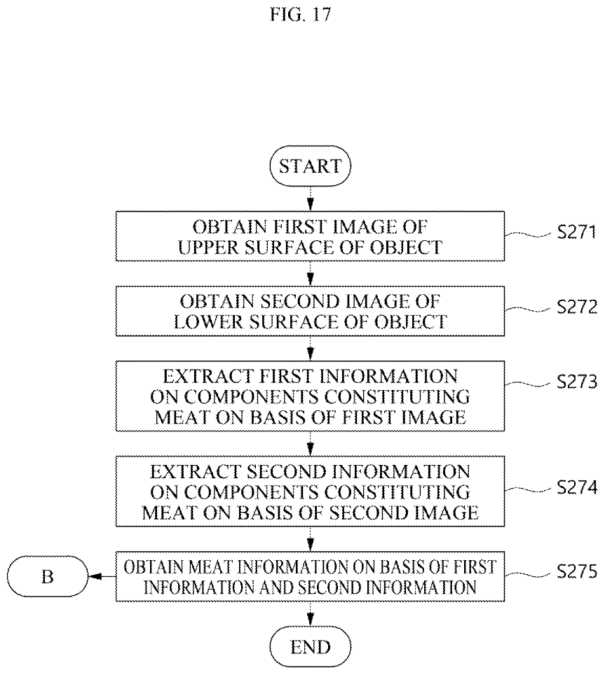

FIGS. 17 to 21 are exemplary diagrams for describing an operation of obtaining, by a server, meat information on the basis of analysis of first and second surfaces of meat according to an embodiment.

Referring to FIG. 17, a server 2000 may perform a step S271 of obtaining a first image of an upper surface of an object, a step S272 of obtaining a second image of a lower surface of the object, a step S273 of extracting first information on components constituting the meat on the basis of the first image, a step S274 of extracting second information on the components constituting the meat on the basis of the second image, and a step S275 of obtaining meat information on the basis of the first information and the second information.

In the case of obtaining information on components constituting meat through image analysis, there is a limit in obtaining accurate information on thick meat only by analyzing an image obtained by capturing a surface of the meat. In this case, that is, when a thickness of meat to be analyzed is a certain level or higher, it is possible to obtain more accurate meat properties information through analysis of images obtained by capturing different surfaces (e.g., upper and lower surfaces) of the meat. For example, when information on components constituting each of upper and lower surfaces of the meat is obtained through analysis of the image obtained by capturing each of the upper and lower surfaces of the meat and then in comprehensive consideration of the information on the components, information on components constituting the meat to be analyzed is obtained, it is possible to obtain more accurate information on the components even in the case of thick meat.

The server 2000 according to the embodiment may obtain information on components constituting meat through analysis of images obtained by capturing difference surfaces of the meat to be analyzed. When the server 2000 obtains information on components constituting meat through analysis of images obtained by capturing difference surfaces of the meat to be analyzed, the server 2000 may obtain more accurate information compared to information on components constituting the meat obtained by analyzing an image obtained by capturing only one surface of the meat.

The server 2000 may obtain a first image of an upper surface of the object. The server 2000 may obtain a first image of a first surface, which is one surface of the object. The server 2000 may obtain a first image obtained by capturing the first surface, which is one surface of the meat.

The server 2000 may obtain a second image of a lower surface of the object. The server 2000 may obtain a second image of a second surface, which is one surface of the object, and in this case, the second surface may be a different surface from the first surface. The server 2000 may obtain a second image obtained by capturing the second surface, which is one surface of the meat, and in this case, the second surface may be a surface rather than the first surface.

The server 2000 may extract first information on components constituting the first surface of the meat on the basis of the first image. The server 2000 may extract ROIs from the first image, and extract the first information on the components constituting the first surface of the meat on the basis of analysis of the first region and the second region of the ROIs. Since the method of extracting, by the server 2000, the ROIs from the image, classifying the ROIs into at least one region, and then extracting the information on the meat has been described above, overlapping descriptions thereof will be omitted.

The server 2000 may extract second information on components constituting the second surface of the meat on the basis of the second image. The server 2000 may extract ROIs from the second image and extract the second information on the components constituting the second surface of the meat on the basis of analysis of a third region and a fourth region of the ROIs. Since the method of extracting, by the server 2000, the ROIs from the image, classifying the ROIs into at least one region, and then extracting the information on the meat has been described above, overlapping descriptions thereof will be omitted.

The server 2000 may finally obtain information on the meat to be analyzed on the basis of the first information extracted on the basis of the first image and the second information extracted on the basis of the second image.

For example, the server 2000 may finally obtain information on the meat to be analyzed on the basis of the first information extracted as a result of analyzing the first image obtained by capturing the upper surface of the meat and the second information extracted as a result of analyzing the second image obtained by capturing the lower surface of the meat.

As another example, the server 2000 may use the first information extracted as a result of analyzing the first image obtained by capturing the upper surface of the meat and the second information extracted as a result of analyzing the second image obtained by capturing the lower surface of the meat to obtain information on components constituting an inside of the meat, not the upper and lower surfaces of the meat. Further, the server 2000 may use the first information extracted as a result of analyzing the first image obtained by capturing the upper surface of the meat and the second information extracted as a result of analyzing the second image obtained by capturing the lower surface of the meat to obtain information on a surface rather than the upper and lower surfaces of the meat.

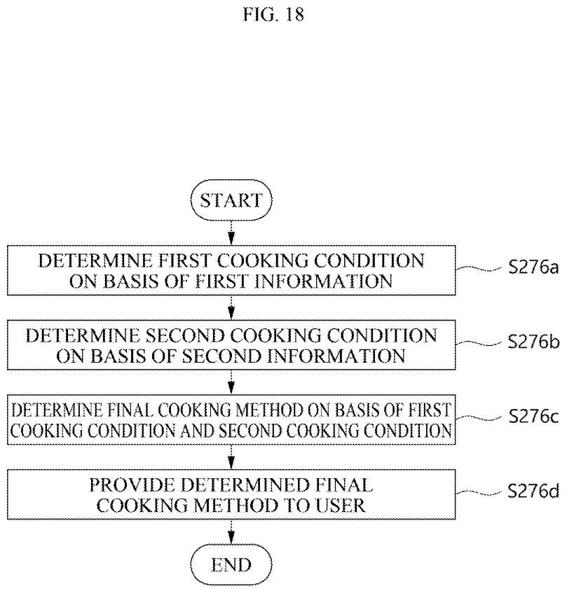

Referring to FIG. 18, the server 2000 may perform a step S276a of determining a first cooking condition on the basis of the first information, a step S276b of determining a second cooking condition on the basis of the second information, a step S276c of determining a final cooking method on the basis of the first cooking condition and the second cooking condition, and a step S276d of providing the determined final cooking method to the user.

As described above, the server 2000 may obtain the information on the components constituting the meat on the basis of a result of analyzing the images obtained by capturing difference surfaces of the meat and then determine a cooking method using the obtained information.

The server 2000 may determine a first cooking condition on the basis of the first information extracted through the analysis of the first image and determine a second cooking condition on the basis of the second information extracted through the analysis of the second image. For example, the server 2000 may determine a cooking condition (first cooking condition) used when the first surface of the meat is cooked and a cooking condition (second cooking condition) used when the second surface of the meat is cooked, and determine a final cooking method in comprehensive consideration of the first cooking condition and the second condition.

For example, the server 2000 may obtain information on components constituting an upper surface of the meat through analysis of a first image obtained by capturing the upper surface of the meat and determine a first cooking condition, which is a condition for cooking the upper surface of the meat in consideration of the information on the components. As with above, the server 2000 may obtain information on components constituting a lower surface of the meat through analysis of a second image obtained by capturing the lower surface of the meat and determine a second cooking condition, which is a condition for cooking the lower surface of the meat in consideration of the information on the components. Thereafter, the server 2000 may determine a final cooking method for cooking a target meat on the basis of the first cooking condition and the second cooking condition.

The first cooking condition and the second cooking condition may be conditions for determining a meat cooking method and may relate to the intensity and a heating time of a heat source, and the like. The first cooking condition and the second cooking condition may be the same as or different from each other. Since the first information extracted through the analysis of the first image and the second information extracted through the analysis of the second image are the same as or different from each other, the first cooking condition and the second cooking condition may be, accordingly, the same as or different from each other. For example, the first cooking condition may be a heating condition (heating time, heating temperature, etc.) for the upper surface, and the second cooking condition may be a heating condition (heating time, heating temperature, etc.) for the lower surface.

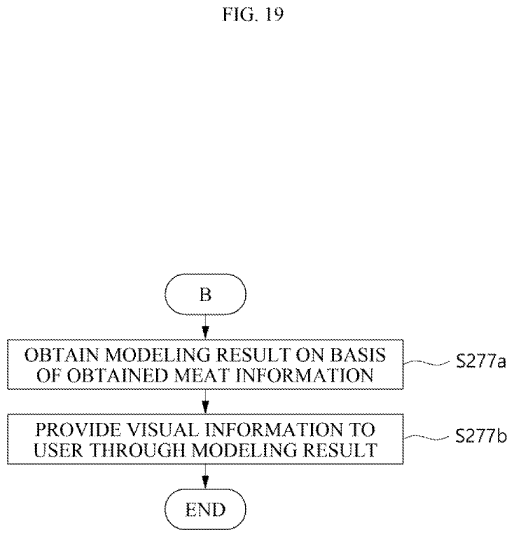

Referring to FIG. 19, the server 2000 may perform a step S277a of obtaining a modeling result on the basis of obtained meat information and a step S277b of providing visual information to the user through the modeling result.

The server 2000 may obtain the information on the components constituting the meat on the basis of the result of analyzing the images obtained by capturing difference surfaces of the meat as described above, and then obtain a three-dimensional (3D) modeling result using the information on the components. For example, the server 2000 may generate a 3D modeling result on the basis of the first information extracted through the analysis of the first image and the second information extracted through the analysis of the second image.

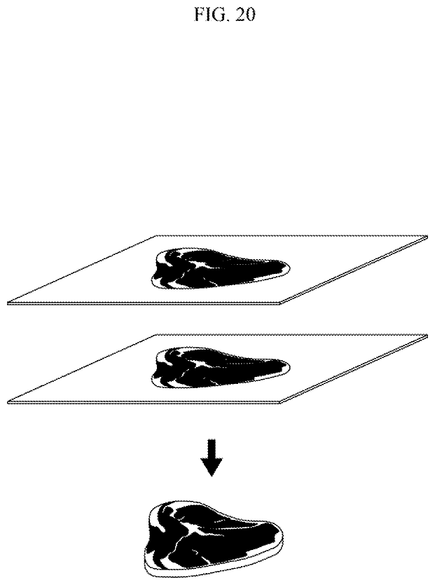

Referring to FIG. 20, the 3D modeling result may be a 3D image in which the first information and the second information are reflected. The 3D modeling result may be a 3D image in which components constituting a first surface of the meat and components constituting a second surface of the meat are reflected. The 3D modeling result may be a 3D image in which components constituting an upper surface of the meat and components constituting a lower surface of the meat are reflected.

The 3D modeling result may be a 3D image obtained by interpolating the first image and the second image on the basis of the first information and the second information. For example, the 3D modeling result may be a 3D image obtained by interpolating an image of the upper surface of the meat and an image of the lower surface of the meat on the basis of the components constituting the upper surface of the meat and the components constituting the lower surface of the meat.

The server 2000 may visually provide information on a cooking state of the meat to the user in real time while the meat is being cooked. For example, the server 2000 may provide a cooking state of one surface of the meat to the user in real time, and the user may use the cooking state as auxiliary data for cooking the meat.

The server 2000 may visually provide information on a cooking state of meat to the user in real time using the generated 3D modeling result. The server 2000 may map a current real-time cooking state of meat to a generated 3D modeling to provide a current real-time cooking state to the user.

When the first surface is being heated, the server 2000 may visually map a cooking state of the first surface to provide the cooking state to the user. When the first surface is being heated, the server 2000 may visually display the cooking state of the first surface in consideration of a heating temperature and a period of time, and provide the cooking state to the user.

When it is determined that the cooking state of the first surface satisfies a predetermined condition, the server 2000 may provide an alarm to the user. When it is determined that the cooking state of the first surface is heated for a predetermined period of time at a predetermined temperature, the server 2000 may provide an alarm to the user.

The alarm may be an alarm for notifying the user that cooking of the first surface is completed or an alarm guiding the user to flip the meat over. In this case, the form of the alarm may be various, such as sound, vibration, light, and the like.

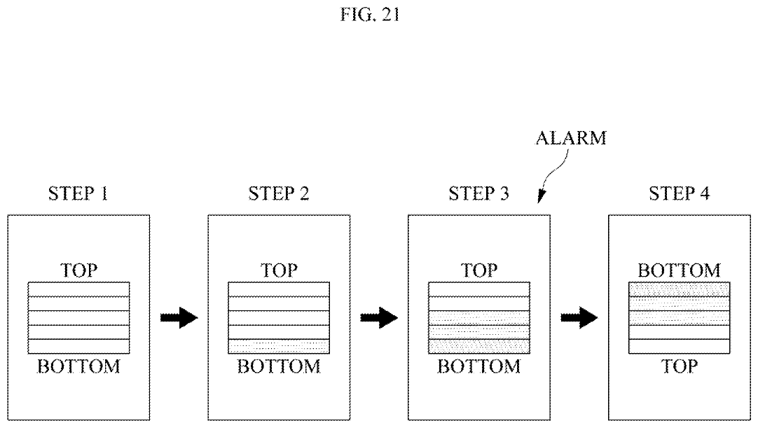

Referring to FIG. 21, when the lower surface of the meat is being cooked, the server 2000 may provide a cooking state of the lower surface of the meat to the user step by step. For example, the server 2000 may time-sequentially display the cooking state of the lower surface of the meat through a first step (STEP 1) to a third step (STEP3) and provide the cooking state to the user.

When it is determined that the cooking of the lower surface of the meat satisfies a predetermined condition, the server 2000 may provide an alarm. When the user receives the alarm and then flips the meat so that the upper surface of the meat is cooked, the server 2000 may determine that the upper surface of the meat is being cooked, and then visually display the cooking state of the upper surface of the meat and provide the cooking state to the user through a fourth step (STEP4).

Although not illustrated in the drawing, the server 2000 may provide an additional alarm indicating that the cooking of the meat is completed to the user when it is determined that the cooking of the upper surface of the meat satisfies a predetermined condition.

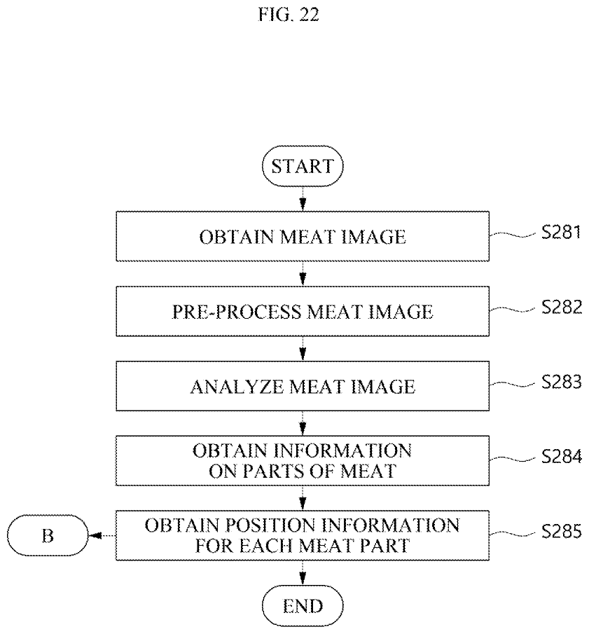

FIGS. 22 to 26 are exemplary diagrams for describing a method of obtaining meat properties information on the basis of meat image analysis and a method of utilizing the obtained meat properties information according to another embodiment.

The name of meat is determined differently according to parts thereof. For example, parts of meat are variously defined, such as pork belly for a first part, neck meat for a second part, and cheek meat for a third part. In this case, even when a target meat corresponds to meat corresponding to a first part, the quality of the meat, a cooking method, and the like may vary depending on a position of the first part. For example, even when a target meat corresponds to pork belly corresponding to a first part, the quality of the meat, a cooking method, and the like may vary depending on a position of the first part.

A server 2000 according to the embodiment may analyze an image of meat to determine which part of the meat corresponds to a target meat and also determine a position in the corresponding part, at which the target meat is present.

Referring to FIG. 22, the server 2000 according to the embodiment may perform a step S281 of obtaining an image of meat, a step S282 of pre-processing the image of the meat, a step S283 of analyzing the image of the meat, a step S284 of obtaining information on parts of the meat, and a step S285 of obtaining position information for each part of the meat.

Since the step of obtaining, by the server 2000 according to the embodiment, the image of the meat and the step of pre-processing of the image of the meat have been described above, overlapping descriptions thereof will be omitted.

The server 2000 may obtain information on parts of the meat through analysis of the image of the meat. For example, the server 2000 may determine whether the photographed meat corresponds to one of neck loin, sirloin, tenderloin, front leg, hind leg, rib, and pork belly through analysis of the image of the meat. However, this is exemplary, and the server 2000 may determine whether the photographed meat corresponds to one of a plurality of predetermined types of meat through the analysis of the image of the meat.

The obtaining, by the server 2000, the information on the parts of the meat through the analysis of the image of the meat may be performed using a pre-trained neural network model, and in this case, the pre-trained neural network model may be a neural network model trained to output the information on the parts of the meat from the image obtained by capturing the meat.

When it is determined that the photographed meat is related to the first part, the server 2000 may determine a position of the first part, to which the photographed meat corresponds, on the basis of a result of the determination. For example, when it is determined that the photographed meat is related to the first part, the server 2000 may determine that the position of the photographed meat corresponds to which one of a plurality of points included in the first part on the basis of a result of the determination.

For example, when it is determined that the photographed meat corresponds to the first part, the server 2000 may determine that the photographed meat corresponds to which one of a plurality of predetermined positions with respect to the first part using information on major muscles constituting the meat. For example, the major muscles may be deep pectoralis major muscle, latissimus dorsi muscle, trunk dermatome muscle, rectus abdominis muscle, external oblique abdominis muscle, or abdominis oblique muscle, but the present invention is not limited thereto.

As a more specific example, when it is determined that the photographed meat corresponds to the first part, the server 2000 may determine that the photographed meat corresponds to which one of the plurality of predetermined positions with respect to the first part on the basis of at least one of the presence or absence, position, and area of the major muscles constituting the meat.

As another example, when it is determined that the photographed meat corresponds to the first part, the server 2000 may determine that the photographed meat corresponds to which one of the plurality of predetermined positions with respect to the first part on the basis of major component (e.g., fat, protein, and/or degree of marbling) constituting the meat.

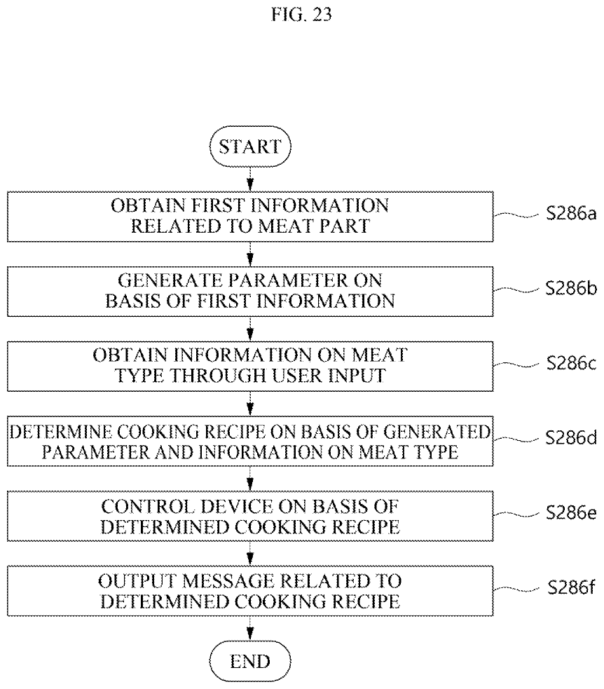

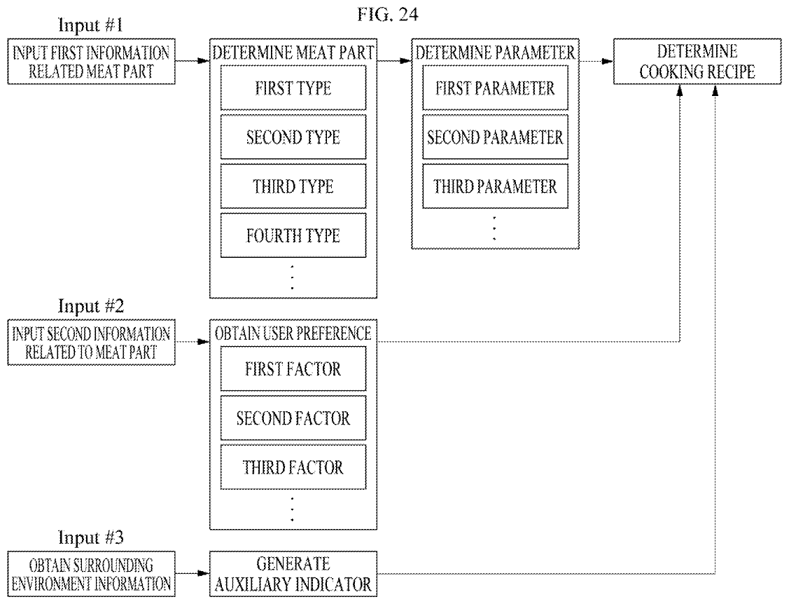

Referring to FIGS. 23 and 24, the server 2000 may determine a cooking method of a target meat on the basis of information on parts of the meat and/or position information for each part of the meat which are obtained through the method of FIG. 22.

Referring to FIG. 23, the server 2000 may perform a step S286a of obtaining first information related to the parts of the meat, a step S286b of generating parameters on the basis of the first information, a step S286c of obtaining information on a type of the meat through a user input, a step S286d of determining a cooking recipe on the basis of the generated parameters and the information on the type of the meat, a step S286e of controlling a device on the basis of the determined cooking recipe, and a step S286f of outputting a message related to the determined cooking recipe.

The server 2000 may obtain first information related to the parts of the meat. Here, the first information may be information that the photographed meat corresponds to which one of a plurality of predetermined types of meat, as described above, through the step S284 of obtaining the information on the parts of the meat of FIG. 22. Further, the first information may be information that the photographed meat corresponds to which position of a specific part of the meat, as described above, through the step S285 of obtaining the position information for each part of the meat of FIG. 22.

The server 2000 may generate and/or determine parameters on the basis of the first information. The server 2000 may generate and/or determine the parameters that are the basis for determining a cooking recipe on the basis of the first information.

When the first information includes information indicating that the photographed meat corresponds to a first part, the server 2000 may generate and/or determine parameters appropriate for controlling the meat corresponding to the first part. When the first information includes information indicating that the photographed meat corresponds to a second part, the server 2000 may generate and/or determine parameters appropriate for controlling the meat corresponding to the second part.

When the first information includes information indicating that the photographed meat corresponds to a first position of the first part, the server 2000 may generate and/or determine parameters appropriate for controlling the meat taken at the first position. When the first information includes information indicating that the photographed meat was taken at a second position of the first part, the server 2000 may generate and/or determine parameters appropriate for controlling the meat taken at the second position.

When it is determined that the photographed meat is related to the first part, the server 2000 may determine a first parameter and a second parameter to be appropriate for cooking the meat corresponding to the first part. Here, the first parameter may be related to the intensity of a heat source, and the second parameter may be related to a heating time.

As a more specific example, when it is determined that the photographed meat is pork belly, the server 2000 may determine a first parameter (e.g., the intensity of the heat source) and a second parameter (e.g., the heating time) to be appropriate for cooking the pork belly according to predetermined conditions. As another example, when the photographed meat is a part of pork belly positioned at a thirteenth thoracic vertebrae, the server 2000 may determine a first parameter (e.g., the intensity of the heat source) and a second parameter (e.g., the heating time) to be appropriate for cooking the pork belly positioned at the thirteenth thoracic vertebrae according to predetermined conditions

The server 2000 may obtain information on a type of the meat through the user input. In this case, the information on the type of the meat is related to a result of cooking the meat preferred by the user, and may be related to a taste of meat desired by the user, such as meat flavor, meat juiciness, meat tenderness, etc.

The server 2000 may determine a cooking recipe on the basis of the generated parameters and the information on the type of the meat. For example, an optimal cooking recipe may be determined in consideration of the parameters, which are determined based on the parts of the photographed meat and/or the position information for each part of the meat, and the information on the type of the meat, which is obtained through the user input.

Referring to FIG. 24, the server 2000 may determine a cooking recipe through at least one piece of input data. For example, the server 2000 may receive first information related to a part of the meat, determine the part of the meat (or position for each part of the meat), and determine parameters on the basis of a result of the determination. The server 2000 may obtain information on the type of the meat related to user preference through the user input. The server 2000 may obtain surrounding environment information to generate an auxiliary indicator that has an effect on determining a recipe.

The server 2000 may determine a cooking recipe using at least one of the determined at least one parameter, the information on the type of the meat related to the user preference, and the auxiliary indicator determined from the surrounding environment information.

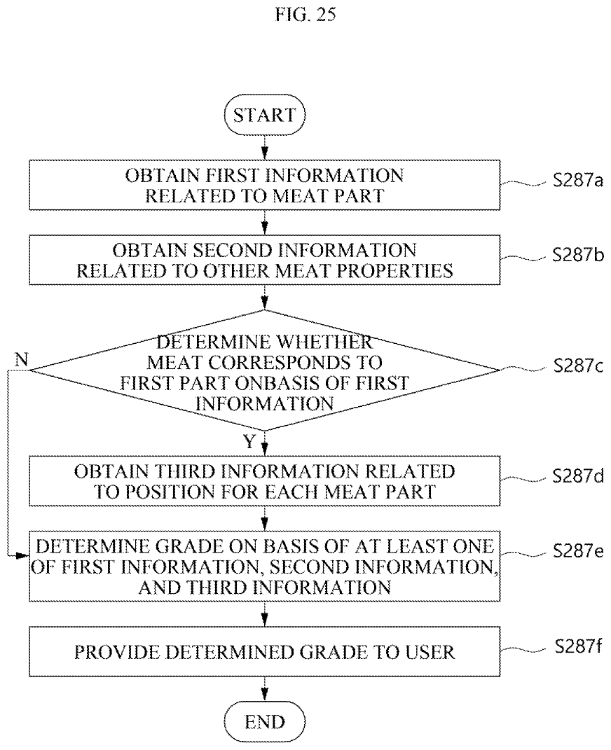

Referring to FIG. 25, the server 2000 may determine a grade of a target meat on the basis of the information on the part of the meat and/or the position information for each part which are obtained through the method of FIG. 22 and provide the determined grade to the user.

The server 2000 may perform a step S287a of obtaining first information related to a part of meat, a step S287b of obtaining second information related to other properties of the meat, a step S287c of determining whether the meat corresponds to a first part on the basis of the first information, a step S287d of obtaining third information related to a position for each part of the meat, a step S287e of determining a grade of the meat on the basis of at least one of the first information, the second information, and the third information, and a step S287f of providing the determined grade to the user.

The server 2000 may obtain the first information related to the part of the meat. Since this is the same as or corresponds to the content described above through the step S286a of obtaining the first information related to the part of the meat of FIG. 23, overlapping descriptions thereof will be omitted.

The server 2000 may obtain the second information related to other properties of the meat. For example, the second information may be information on at least one of a weight, a shape, and a thickness of the meat. As another example, the second information may be information on components constituting the meat, which is obtained through image analysis.

The server 2000 may determine whether the photographed meat corresponds to a first part on the basis of the first information. The server 2000 may determine whether the photographed meat corresponds to a first part from among a plurality of predetermined parts on the basis of the first information. The first part may be one part predetermined by the user from among a plurality of parts.

When it is determined that the photographed meat corresponds to the first part, the server 2000 may additionally obtain third information related to a position for each part of the meat. In this case, since the obtaining, by the server 2000, the third information related to the position for each part of the meat is the same as or corresponds to the content described above through the step S285 of obtaining the position information for each part of the meat of FIG. 22, overlapping descriptions thereof will be omitted.

The server 2000 may determine a grade of the photographed meat on the basis of at least one of the first information, the second information, and the third information.

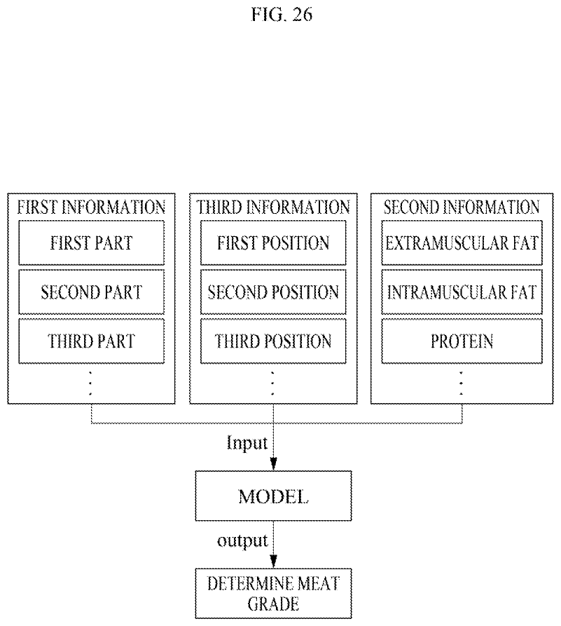

Referring to FIG. 26, the server 2000 may determine a grade of the meat on the basis of at least one of the first information, the second information, and the third information through a pre-trained neural network model. For example, when it is determined that the photographed meat corresponds to a predetermined first part, the server 2000 may determine a grade of the meat on the basis of the first information, the second information, and the third information. As another example, when it is determined that the photographed meat does not correspond to a predetermined first part, the server 2000 may determine a grade of the meat on the basis of the first information and the second information. Although not illustrated in the drawing, the server 2000 may determine a grade of the meat on the basis of at least one of the first information, the second information, and the third information through a predetermined algorithm other than the pre-trained neural network model.

The first information may include information on whether the photographed meat corresponds to one of a plurality of types of meat, the second information may include information on components constituting the photographed meat, and the third information may include information on position, among specific parts, to which the photographed meat corresponds.

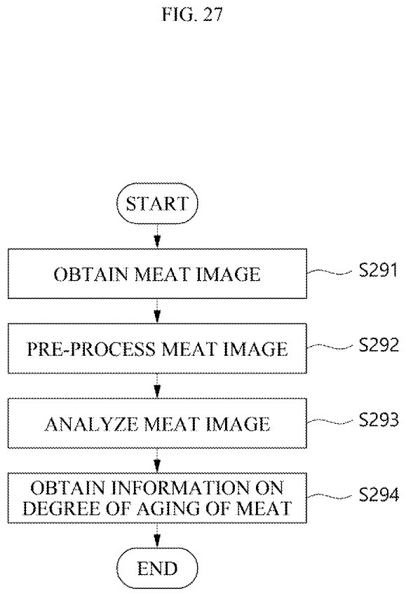

FIG. 27 is a diagram for describing a method of obtaining meat properties information on the basis of meat image analysis according to another embodiment.

Referring to FIG. 27, the server 2000 may perform a step S219 of obtaining an image of meat, a step S292 of pre-processing the image of the meat, a step S293 of analyzing the image of the meat, and a step S294 of obtaining information on a degree of aging of the meat.

The server 2000 may obtain information on a degree of aging of meat through analysis of an image of the meat. For example, the server 2000 may obtain the information on the degree of aging of the meat on the basis of color information extracted from the image of the meat and information related to a shape of the meat. As another example, the server 2000 may obtain the information on the degree of aging of the meat by comparing an image captured at a first time point and an image captured at a second time point. In this case, the first time point and the second time point may be different, and the first time point may be a time point earlier than the second time point.

The server 2000 may provide information on an aging completion time point of the meat to the user on the basis of the information on the degree of aging of the meat. For example, the server 2000 may obtain the information on the degree of aging of the meat, and when the degree of aging of the meat satisfies a predetermined criterion, provide a notification indicating that the meat has been aged to the user.

Various factors may be considered when determining a method of cooking the meat. For example, as described above, in addition to the information on the components constituting meat, parts of meat, position for each part of meat, etc. which are obtained through image analysis, non-image data that can affect the cooking method may also influence determination of the method of cooking the meat. In order to determine a more appropriate cooking method, the server 2000 according to the embodiment may additionally consider non-image data in addition to data obtained through image analysis.

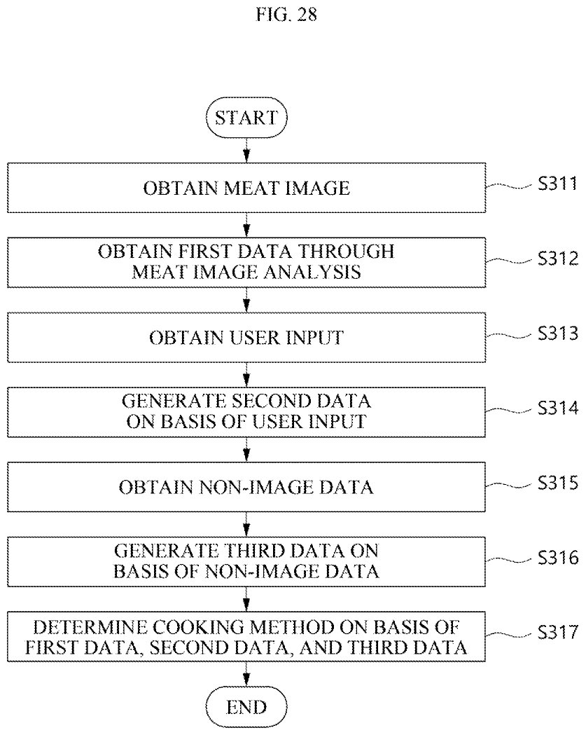

FIGS. 28 to 31 are exemplary diagrams for describing a method of determining a cooking method on the basis of additional analysis of non-image data according to an embodiment.

Referring to FIG. 28, the server 2000 may perform a step S311 of obtaining an image of meat, a step S312 of generating first data through analysis of the image of the meat, a step S313 of obtaining a user input, a step S314 of generating second data on the basis of the user input, a step S315 of obtaining non-image data, a step S316 of generating third data on the basis of the non-image data, and a step S317 of determining a cooking method on the basis of the first to third data.

Since the step S311 of obtaining the image of the meat, the step S312 of generating the first data through analysis of the image of the meat, the step S313 of obtaining the user input, and the step S314 of generating the second data on the basis of the user input, which are performed by the server 2000, have been described above, overlapping descriptions thereof will be omitted.

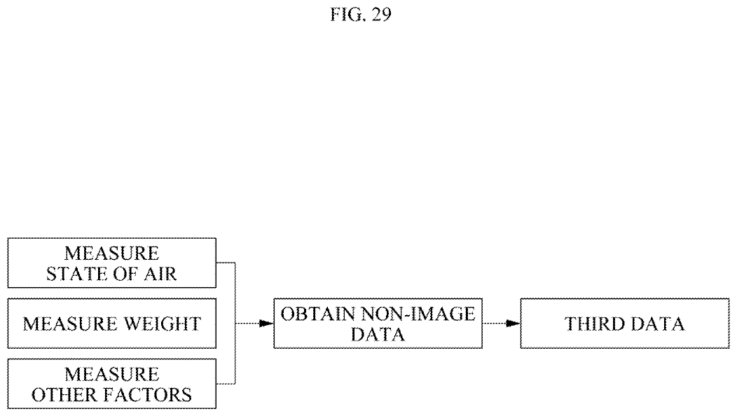

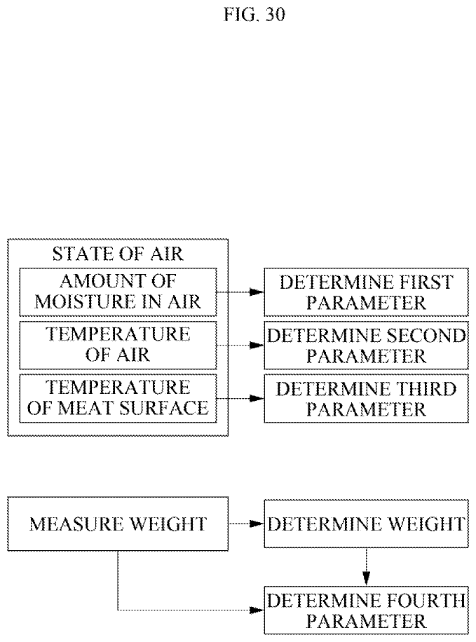

Referring to FIGS. 29 and 30, the server 2000 may obtain non-image data. The non-image data may be data that can directly or indirectly affect the method of cooking the meat. For example, the non-image data may be information related to a state of air and information obtained by measuring a weight and thickness of the meat, and the information related to the state of the air may be information on an amount of moisture in the air, a temperature of the air, a temperature of a surface of the meat, and a temperature of a grilling plate.

The server 2000 may generate third data on the basis of the obtained non-image data. The third data may be related to at least one parameter determined based on the non-image data. For example, the third data may be related to a first parameter related to the intensity of a heat source and/or a second parameter related to a heating time, which are determined based on the non-image data.

As a more specific example, since a rate of the heat transfer varies according to an amount of moisture in the air, when non-image data for the amount of moisture in the air is obtained, a first parameter may be determined based on the obtained non-image data, and when the temperature of the air is higher or lower than a predetermined temperature range, the temperature of the air affects the cooking method, and thus a second parameter may be determined based on the temperature of the air. Since the method of cooking the meat varies according to the temperature of the surface of the meat, a third parameter may be determined based on the temperature of the surface of the meat. Since the method of cooking the meat varies according to the weight or thickness of the meat, a fourth parameter may be determined based on the weight or thickness of the meat.

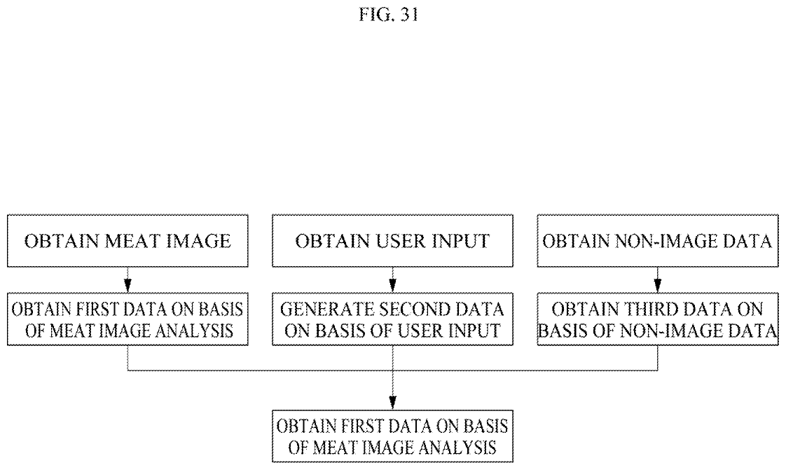

Referring to FIG. 31, the server 2000 may determine a cooking method on the basis of at least one of first data, second data, and third data. That is, the server 2000 may finally generate a cooking method using at least one of first data obtained by analyzing the image of the meat, second data obtained based on the user input, and third data obtained based on the analysis of the non-image data.

3 Selection of Cooking Method

As described above, the server 2000 according to the embodiment may generate the method of cooking the meat through the analysis of the image or the non-image. Since a method of grilling meat may vary according to user preference, a customized meat cooking method needs to be determined in order to cook the meat to reflect the user preference. In order to determine the customized meat cooking method, not only “user preference” should be considered, but also “meat properties information” should all be reflected.

Since the methods of extracting the “user preference” and the “meat properties information” have been described above in detail, a more specific method of determining a meat cooking method through such pieces of information will be described below in detail with reference to the accompanying drawings.

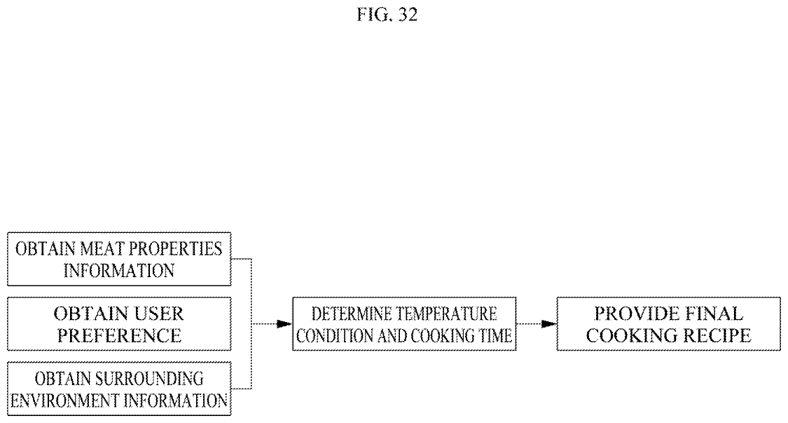

FIG. 32 is an exemplary diagram for describing a method of determining, by a server, a meat cooking method according to an embodiment.

Referring to FIG. 32, a server 2000 may obtain meat properties information through image analysis, obtain user preference through a user input, obtain surrounding environment information through non-image data, and then determine a temperature condition and a cooking time on the basis of at least one of the meat properties information, the user preference, and the surrounding environment information.

The server 2000 may finally determine a meat cooking method on the basis of the determined temperature condition and cooking time and then provide the determined meat cooking method to the user. The meat cooking method may be determined based on a condition related to a temperature for grilling the meat, a condition related to a time for grilling the meat, and a condition related to a time for flipping the meat.

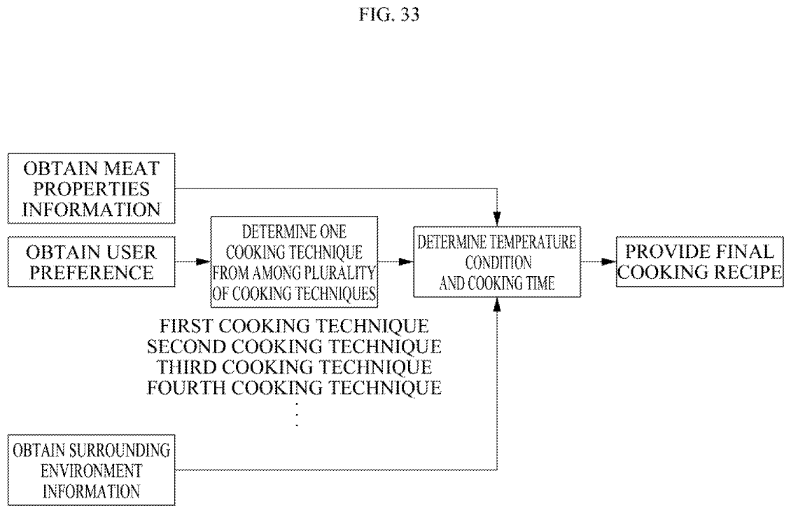

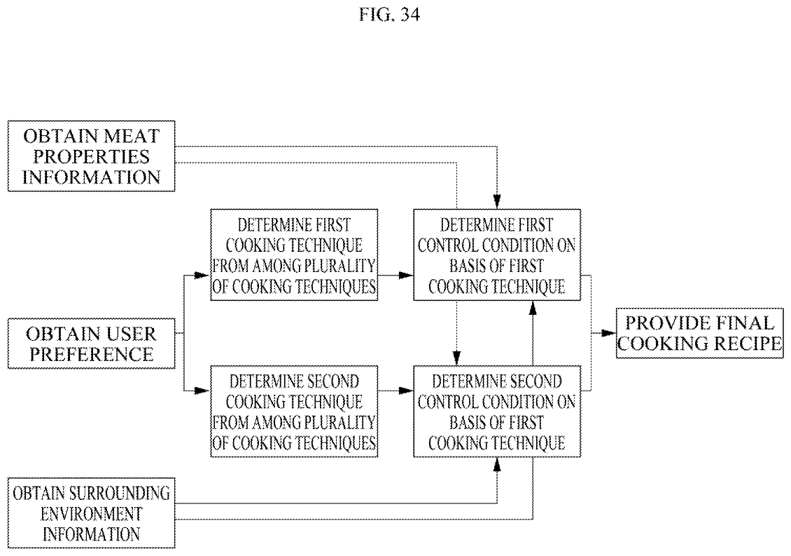

FIGS. 33 and 34 are exemplary diagrams for describing a method of determining, by a server, a meat cooking method according to another embodiment.

Referring to FIG. 33, a server 2000 may obtain user preference and then determine one cooking technique from among a plurality of cooking techniques on the basis of the obtained user preference. For example, the server 2000 may obtain the user preference and then determine one cooking technique from among a plurality of cooking techniques in consideration of at least one of meat juiciness, meat tenderness, and meat flavor included in the obtained user preference.

The technique for cooking meat may vary. For example, a resting technique is a technique for stabilizing the juiciness by waiting after grilling the meat, and a searing technique is a technique for cooking the meat over a strong fire so that an outside of the meat becomes crispy and an inside becomes moist. In addition, there may be various techniques for cooking meat, and juiciness, tenderness, and flavor of cooked meat may be determined differently depending on which cooking technique is used.

Accordingly, the server 2000 may obtain user preference and determine one of cooking techniques most suitable for producing a desired result in consideration of the juiciness, the tenderness, and the flavor included in the user preference from among a plurality of pre-stored cooking techniques. Although not illustrated in the drawing, the server 2000 may determine one cooking technique from among the plurality of cooking techniques on the basis of meat properties information or surrounding environment information.

The server 2000 may determine a temperature condition and a cooking time in consideration of the determined cooking technique and finally determine a cooking method on the basis of the determined temperature condition and cooking time. That is, the server 2000 may preferentially determine one cooking technique from among the plurality of cooking techniques, determine a temperature condition and cooking time suitable for the determined cooking technique, and then determine a final cooking method on the basis of the determined temperature condition and cooking time.

Referring to FIG. 34, the server 2000 may obtain user preference and then determine two or more cooking recipes from among a plurality of cooking techniques on the basis of the obtained user preference.

In order to obtain a result in which the user preference (e.g., juiciness, tenderness, or flavor) is reflected, upper and lower surfaces of the meat may need to be cooked differently. In this case, since it is necessary to separately determine the cooking techniques for cooking the upper and lower surfaces of the meat, the server 2000 may obtain user preference, and then determine a first cooking technique for cooking a first surface of the meat and determine a second cooking technique for cooking a second surface of the meat on the basis of the user preference, from among the plurality of cooking techniques.

The server 2000 may determine a first control condition on the basis of the determined first cooking technique and determine a second control condition on the basis of the determined second cooking technique. Here, the first control condition and the second control condition may be conditions related to the temperature condition and the cooking time. Thereafter, the server 2000 may determine a final cooking method in consideration of the determined first and second control conditions.

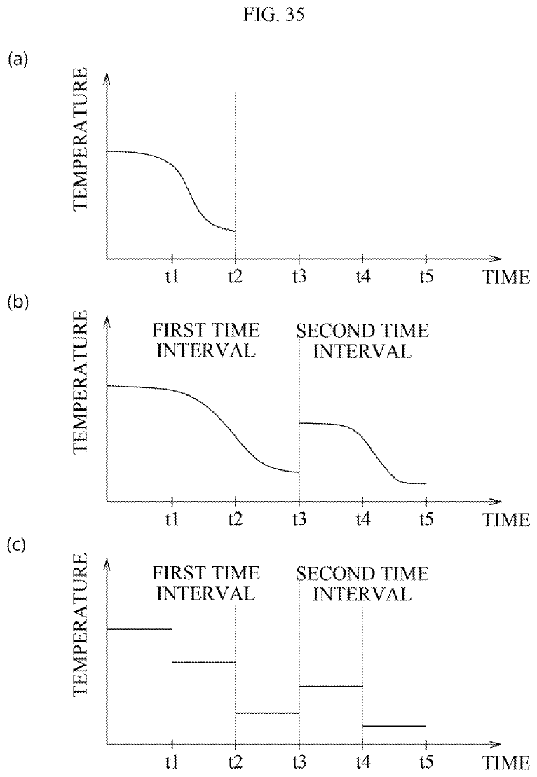

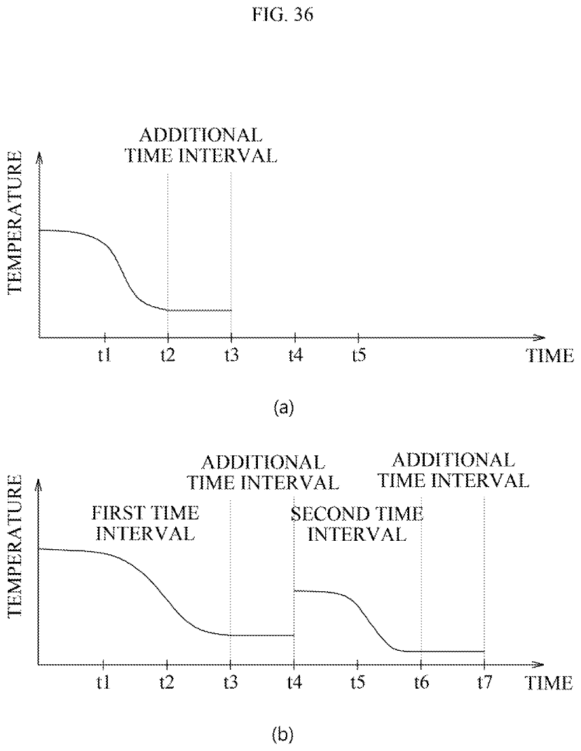

FIGS. 35 and 36 are exemplary diagrams for describing a determined cooking method according to an embodiment.

Referring to FIG. 35A, a meat cooking method may be provided so that a temperature may be controlled according to time. For example, the meat cooking method may be a method in which meat is initially heated at a first temperature until a first time point t1 and then is heated until a second time point t2 so that the temperature is gradually reduced at a second temperature. However, this is exemplary, and the meat cooking method may be in various forms such that the temperature is controlled according to a predetermined criterion within a predetermined time period.

Referring to FIG. 35B, a meat cooking method may be provided so that a temperature may be controlled according to a plurality of time periods. The meat cooking method may be provided such that a temperature is controlled according to a predetermined criterion in a first time period and a temperature is controlled according to a predetermined criterion in a second time period. For example, the meat cooking method may be a method in which, in a first time period (0 to t3), the meat is heated at a first temperature and then is heated while gradually reducing the temperature, and in a second time period (t3 to t5), the meat is heated at a second temperature and then is heated while gradually reducing the temperature, and the first temperature may be a higher temperature than the second temperature. However, this is exemplary, and the meat cooking method may be in various forms such that the temperature is controlled differently according to the predetermined criteria independently in the first time period and the second time period.

More specifically, when the meat is cooked, it is necessary to cook each of front and rear surfaces of the meat. Accordingly, since a meat grilling device also needs to be separately controlled to cook each of the front and rear surfaces of the meat, the meat grilling device may control the temperature according to a predetermined criterion in order to cook the front surface of the meat in the first time period, and control the temperature according to the predetermined criterion in order to cook the rear surface of the meat in the second time period. In this case, the first time period and the second time period may be determined to be identical to or different from each other according to the predetermined cooking method, and the temperature of the heat source controlled in each time period may also be determined to be identical to or different from each other according to the predetermined cooking method.

Referring to FIG. 35C, a meat cooking method may be provided so that a temperature may be controlled in each of a first time period and a second time period, and each of the first time period and the second time period is divided into a plurality of sub-time periods, and a predetermined temperature value is provided discretely to each sub-time period.

When the user directly controls the temperature, it may be difficult to control the temperature linearly according to the time period as illustrated in FIG. 35B, and thus the server 2000 according to the embodiment may provide the meat cooking method in the form in which each of a plurality of time periods may be divided into a plurality of sub-time periods and the meat may be heated at a specific temperature in each sub-time period.

For example, the meat cooking method may be provided in a form in which the temperature may be controlled according to the predetermined criterion in the first time period (0 to t3) and the second time period (t3 to t5), the first time period (0 to t3) may include a first sub-time period (0 to t1), a second sub-time period (t1 to t2), and a third sub-time period (t2 to t3), and the second time period (t3 to t5) may include a fourth sub-time period (t3 to t4) and a fifth sub-time period (t4 to t5). In this case, the meat cooking method may be a method in which, in the first sub-time period (0 to t1), the meat is heated at the first temperature, in the second sub-time period (t1 to t2), the meat is heated at the second temperature, in the third sub-time period (t2 to t3), the meat is heated at the third temperature, in the fourth sub-time period (t3 to t4), the meat is heated at the fourth temperature, and in the fifth sub-time period (t4 to t5), the meat is heated at the fifth temperature.

Referring to FIGS. 36A and 36B, a meat cooking method may be provided in such a way that the meat may be heated at a predetermined constant temperature in an additional time period after the temperature control in the predetermined time period is completed. Alternatively, a meat cooking method may be provided in such a way that the supply of the heat source is stopped in the additional time period after the temperature control in the predetermined time period is completed.

For example, when the temperature control in the predetermined time period (0 to t2) is completed as illustrated in FIG. 36A, thereafter, in the additional time period (t2 to t3), the meat cooking method may be provided in such a way that the meat is heated at the predetermined constant temperature or the supply of the heat source is stopped. As another example, when the temperature control in the first time period (0 to t3) is completed as illustrated in FIG. 36B, thereafter, in the first additional time period (t3 to t4), the meat cooking method may be provided in such a way that the meat is heated at the predetermined constant temperature, and when the temperature control in the second time period (t4 to t6) is completed, thereafter, in the second additional time period (t6 to t7), the meat cooking method may be provided in such a way that the meat is heated at the predetermined constant temperature.

4 Automatic Cooking Device

In order to provide meat cooked according to user preference, it is important to determine an appropriate cooking method according to properties of the meat and the user preference, but it is also important to accurately implement an appropriate cooking method after the cooking method is determined.

The automatic cooking device according to the embodiment of the present invention may transmit heat to meat by accurately controlling a temperature and time according to the cooking method determined using the above-described method.

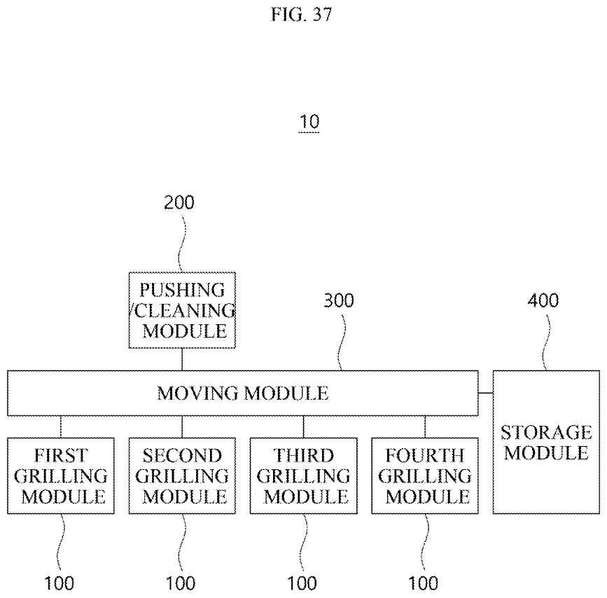

FIG. 37 is an exemplary diagram for describing an overall configuration of an automatic cooking device according to an embodiment.

Referring to FIG. 37, an automatic cooking device 10 may include at least one of a storage module 400, a moving module 300, a grilling module 100, and a pushing module 200. However, this is exemplary, and some modules of the automatic cooking device 10 may be added or omitted as necessary.

An automatic cooking device 10 according to an embodiment may include a storage module 400, a moving module 300, a grilling module 100, and a pushing module 200. In this case, the storage module 400 may perform a function of storing meat before being cooked, the moving module 300 may perform a function of moving at least one piece of meat stored in the storage module 400 to the grilling module 100, and the grilling module 100 may cook the meat by applying heat to the meat according to a preset cooking condition. The pushing module 200 may perform a function of inserting and placing the meat into the grilling module 100, perform a function of discharging the meat cooked by the grilling module 100 to the outside, or perform a function of cleaning the grilling module 100.

An automatic cooking device 10 according to another embodiment may include a moving module 300, a grilling module 100, and a pushing module 200. In this case, the moving module 300 may move meat obtained from an external device or user to the grilling module 100, the grilling module 100 that receives the meat may cook the meat by applying heat to the meat according to a preset cooking condition, and the pushing module 200 may perform a function of inserting and placing the meat into the grilling module 100, perform a function of discharging the meat cooked by the grilling module 100 to the outside, or perform a function of cleaning the grilling module 100.

An automatic cooking device 10 according to still another embodiment may include a grilling module 100 and a pushing module 200. In this case, the grilling module 100 may obtain meat from an external device or user and then cook the meat by applying heat to the meat according to a preset cooking condition, and the pushing module 200 may perform a function of inserting and placing the meat into the grilling module 100, perform a function of discharging the meat cooked by the grilling module 100 to the outside, or perform a function of cleaning the grilling module 100.

An automatic cooking device 10 according to yet another embodiment may include only a grilling module 100. In this case, the grilling module 100 may obtain meat from an external device or user and then cook the meat by applying heat to the meat according to a preset cooking condition, and the meat that has been cooked may be discharged to the outside by a separate device provided in the grilling module 100, an external device, or a user.

Hereinafter, the storage module 400, the moving module 300, the grilling module 100, and the pushing module 200 constituting the automatic cooking device 10 will be described with reference to the accompanying drawings.

4.1 Grilling Module

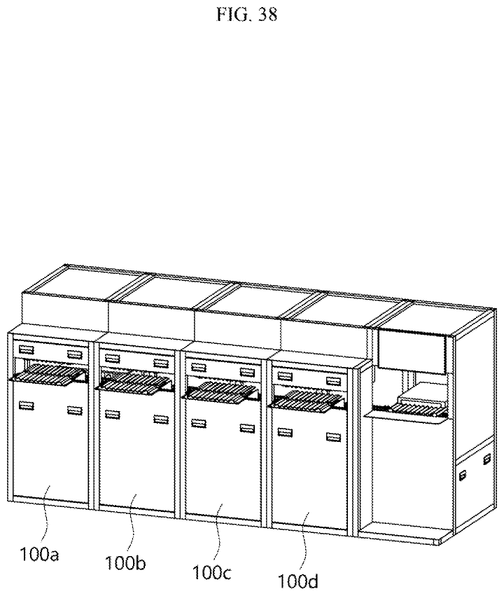

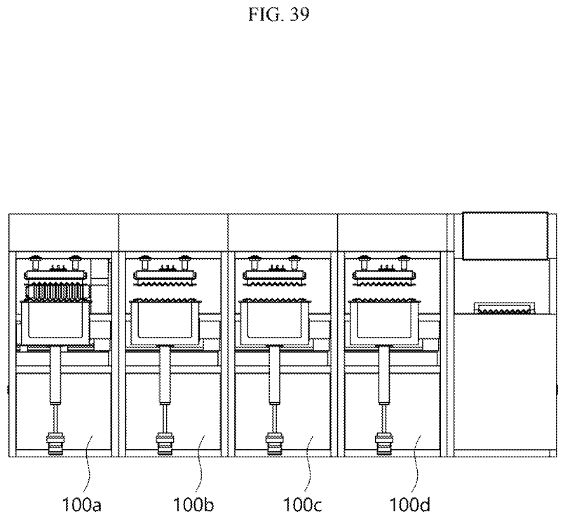

FIG. 38 is a perspective view of an automatic cooking device for describing a grilling module 100 according to an embodiment, and FIG. 39 is a side view of an automatic cooking device for describing the grilling module 100 according to the embodiment.

Referring to FIGS. 38 and 39, the grilling module 100 according to the embodiment may include a plurality of grilling module. When the grilling module 100 includes a plurality of grilling modules, the automatic cooking device 10 may simultaneously cook several pieces of meat.

For example, the grilling module 100 according to the embodiment may include a first grilling module 100a, a second grilling module 100b, a third grilling module 100c, and a fourth grilling module 100d. However, this is exemplary, and the automatic cooking device 10 may include only one grilling module 100 or may include two grilling modules 100.

When the grilling module 100 includes a plurality of grilling modules, the respective grilling modules may be directly or indirectly connected to each other by the moving module 300. The automatic cooking device 10 may move meat to be cooked to one of the plurality of grilling modules according to a predetermined criterion using the moving module 300 and then cook the meat.

When the grilling module 100 includes the first grilling module 100a, the second grilling module 100b, the third grilling module 100c, and the fourth grilling module 100d, the first grilling module 100a to the fourth grilling module 100d may be controlled parallelly. For example, the first grilling module 100a to the fourth grilling module 100d may operate simultaneously.

When the grilling module 100 includes a plurality of grilling modules, configurations of the respective the grilling modules may be provided to be identical or similar to each other. Hereinafter, one grilling module 100 will be described, and the description of one grilling module 100 may be applied to the remaining grilling modules 100 in the same way.

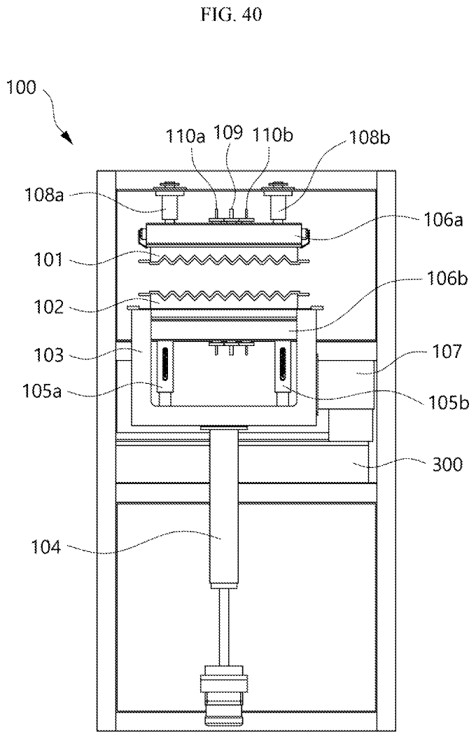

FIG. 40 is a diagram for describing a grilling module according to an embodiment.

Referring to FIG. 40, a grilling module 100 may include a plurality of grilling plates. The grilling module 100 may apply heat to meat using the plurality of grilling plates. For example, when meat is placed on one grilling plate, the grilling module 100 may apply heat to the placed meat by adjusting intervals between the plurality of grilling plates.

The grilling module 100 may include a first grilling plate 101 and a second grilling plate 102. The first grilling plate 101 may be disposed to face the second grilling plate 102. The first grilling plate 101 may be disposed to be opposite to the second grilling plate 102. The first grilling plate 101 and the second grilling plate 102 may be disposed to be symmetrical to each other.

The first grilling plate 101 and the second grilling plate 102 may be disposed to be spaced a preset distance from each other. Since the grilling module 100 can apply heat to meat by placing the meat between the first grilling plate 101 and the second grilling plate 102, the first grilling plate 101 and the second grilling plate 102 may be disposed to be spaced a minimum interval, in which the meat can be placed, from each other. Further, as will be described below, since an operation, such as placing meat between the first grilling plate 101 and the second grilling plate 102, discharging meat that has been cooked to the outside, or the like, can be performed using the pushing module 200, the first grilling plate 101 and the second grilling plate 102 may be disposed to be spaced a minimum interval, in which the operation can be performed, from each other.

Shapes of the first grilling plate 101 and the second grilling plate 102 may correspond to each other. For example, the shape of the first grilling plate 101 may correspond to the shape of the second grilling plate 102. As a more specific example, when grooves are formed in the first grilling plate 101 at regular intervals, grooves may also be formed in the second grilling plate 102 at regular intervals so that the shape of the second grilling plate 102 corresponds to the shape of the first grilling plate 101.

Each of the first grilling plate 101 and the second grilling plate 102 may include a heat source. The heat source provided in the first grilling plate 101 and the heat source provided in the second grilling plate 102 may be independently controlled.

A temperature sensor may be provided on each of the first grilling plate 101 and the second grilling plate 102. The automatic cooking device 10 may monitor or control a temperature applied to the first grilling plate 101 by a first temperature sensor provided in the first grilling plate 101, and monitor or control a temperature applied to the second grilling plate 102 by a second temperature sensor provided in the second grilling plate 102.

A heat insulation member may be provided on each of the first grilling plate 101 and the second grilling plate 102. For example, a first heat insulation plate 106a may be provided on the first grilling plate 101, and a second heat insulation plate 106b may be provided on the second grilling plate 102.

When one surface of the first grilling plate 101 and one surface of the second grilling plate 102 are disposed to face each other, the first heat insulation plate 106a may be disposed on another surface of the first grilling plate 101, and the second heat insulation plate 106b may be disposed on another surface of the second grilling plate 102. In this case, when the meat is cooked between the first grilling plate 101 and the second grilling plate 102, the first heat insulation plate 106a and the second heat insulation plate 106b may minimize the heat transmitted to the meat between one surface of the first grilling plate 101 and one surface of the second grilling plate 102 to be discharged to the outside.

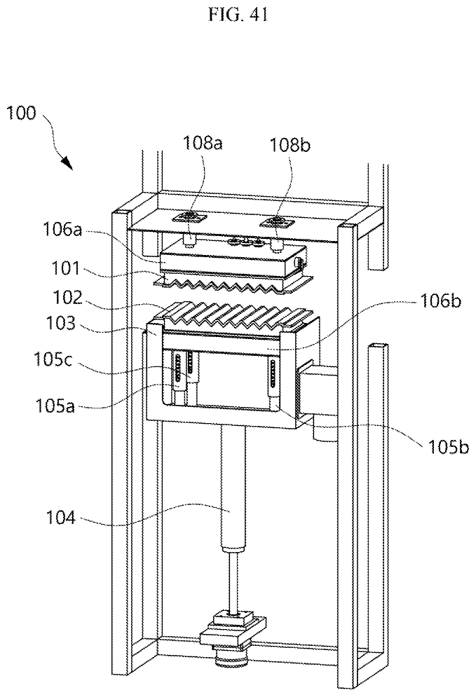

FIG. 41 is an exemplary diagram for describing a method of adjusting a height of one of a plurality of grilling plates included in a grilling module.

Referring to FIG. 41, a first grilling plate 101 or a second grilling plate 102 included in the grilling module 100 may be provided so that relative positions thereof can be changed. For example, the first grilling plate 101 and the second grilling plate 202 may be provided so that heights thereof can be adjusted. The first grilling plate 101 and the second grilling plate 202 may be provided so that the heights thereof can be adjusted relative to the ground. As another example, the first grilling plate 101 may be fixed, and only the second grilling plate 102 may be provided so that the height thereof can be adjusted. In this case, the first grilling plate 101 may be fixed by fixing members 108a and 108b.

According to an embodiment, the height of the second grilling plate 102 may be adjusted by a shaft 104. The second grilling plate 102 may be directly or indirectly connected to the shaft 104, and a relative position of the second grilling plate 102 relative to the ground may be adjusted by the shaft 104. Although not illustrated in the drawing, the height of the first grilling plate 101 may be adjusted by a shaft. The first grilling plate 101 may be directly or indirectly connected to the shaft, and a relative position of the first grilling plate 101 relative to the ground may be adjusted by the shaft. Hereinafter, a method of adjusting, by the shaft 104, the height of the second grilling plate 102 will be described, and the height of the first grilling plate 101 may also be adjusted in the same way.

The second grilling plate 102 may be directly or indirectly connected to the shaft 104. The second grilling plate 102 may be indirectly connected to the shaft 104 through at least one elastic member. The second grilling plate 102 may be indirectly connected to the shaft 104 through at least one elastic member, and the height of the second grilling plate 102 may be adjusted by the shaft 104 and the at least one elastic member.

For example, the grilling module 100 may include at least one elastic member. The grilling module 100 may include a first elastic member 105a, a second elastic member 105b, a third elastic member 105c, and a fourth elastic member 105d, and the first elastic member 105a to the fourth elastic member 105d may transmit power generated by the shaft 104 to the second grilling plate 102. The second grilling plate 102 may be indirectly connected to the shaft 104 by the first elastic member 105a, the second elastic member 105b, the third elastic member 105c, and the fourth elastic member 105d, and the height of the second grilling plate 102 may be adjusted.

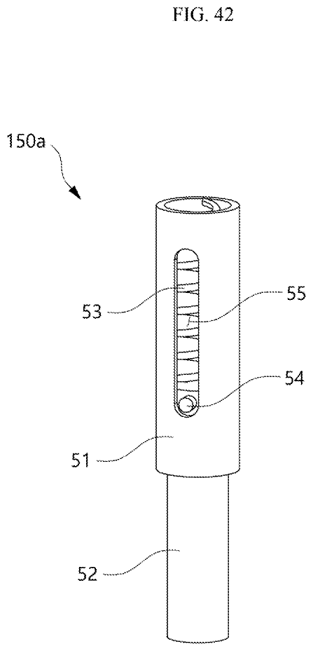

FIG. 42 is an exemplary diagram for describing at least one elastic member constituting a grilling module. Referring to FIG. 42, a first elastic member 105a may include a first support 51, a second support 52, a buffer member 53, and a protruding member 54.

Shapes of the first support 51 and the second support 52 may correspond to each other. The first support 51 and the second support 52 may be formed to be coupled to each other. At least a part of the second support 52 may be formed to be inserted into at least a part of the first support 51.

The first support 51 may include an inner space. In this case, at least a part of the second support 52 may be inserted into at least a part of the inner space. For example, the first support 51 may have a cylindrical shape having an inner space, and in this case, the second support 52 may also have a cylindrical shape corresponding to the shape of the first support 51, and at least a part of the second support 52 may be inserted into at least a part of the inner space of the first support 51.

A stopper 55 may be provided in the first support 51. Due to the stopper 55 provided in the first support 51, the second support 52 may be inserted into the inner space of the first support 51 within a predetermined range. When at least a part of the second support 52 is inserted into the inner space of the first support 51, at least a part of the second support 52 may be inserted into the inner space of the first support 51 only by a predetermined length due to the stopper 55 provided in the first support 51.

The stopper 55 provided in the first support 51 may be an opening. The first support 51 may include an opening in at least a part of a surface of the first support 51 to guide the insertion of the second support 52 by a predetermined length. The opening provided in the first support 51 may be formed in a longitudinal direction. The opening provided in the first support 51 may be formed in a direction in which the second support 52 is inserted into the inner space of the first support 51.

The length of the opening provided in the first support 51 may be determined based on a distance between the first grilling plate 101 and the second grilling plate 102. The length of the opening provided in the first support 51 may be determined based on a height of the first grilling plate 101 from the ground. The length of the opening provided in the first support 51 may be determined based on a shape of a housing 103. The length of the opening provided in the first support 51 may be determined based on a height of the housing 103. A detailed description of the housing 103 will be given below.

The second support 52 may include a protruding member 54. The protruding member 54 may be provided in at least a part of a surface of the second support 52. The protruding member 54 provided in the second support 52 may be provided to have a shape corresponding to that of the stopper 55 provided in the first support 51. When at least a part of the second support 52 is inserted into the inner space of the first support 51, the protruding member of the second support 52 may guide at least a part of the second support 52 to be inserted into the inner space of the first support 51 by a predetermined range.

When the stopper 55 provided in the first support 51 is an opening, the protruding member 54 provided in the second support 52 may have a shape corresponding to that of the opening. The protruding member 54 of the second support 52 may be provided to be coupled to the opening formed in the first support 51.

For example, the protruding member 54 of the second support 52 may be positioned at one end of the opening of the first support 51 and then may be positioned at the other end of the opening of the first support 51 when the second support 52 is maximally inserted into the inner space of the first support 51. That is, the second support 52 may be inserted into the inner space of the first support 51 only until the protruding member 54 is positioned at the other end of the opening of the first support 51. The second support 52 may be inserted into the inner space of the first support 51 until the protruding member 54 is positioned at the other end of the opening of the first support 51.

The first elastic member 105a may include a buffer member 53. The buffer member 53 may be a member having elasticity. The buffer member 53 may be provided on one surface of the second support 52. The buffer member 53 may be attached to one surface of the second support 52 and disposed to be inserted into the inner space of the first support 51. The buffer member 53 is disposed to be inserted into the inner space of the first support 51, and thus, when at least a part of the second support 52 is inserted into the inner space of the first support 51, an impact may be reduced.

The first support 51 may be directly or indirectly fixed to the second grilling plate 102 or the second heat insulation plate 106b. The first support 51 may be directly or indirectly fixed to the second grilling plate 102 or the second heat insulation plate 106b to transmit power generated by the shaft to the second grilling plate 102 or the second heat insulation plate 106b.

The second support 52 may be directly or indirectly fixed to the housing 103. The second support 52 may be directly or indirectly fixed to the housing 103, and thus transmit the power generated by the shaft 104 to at least one of the first support 51, the second grilling plate 102, and the second heat insulation plate 106b.

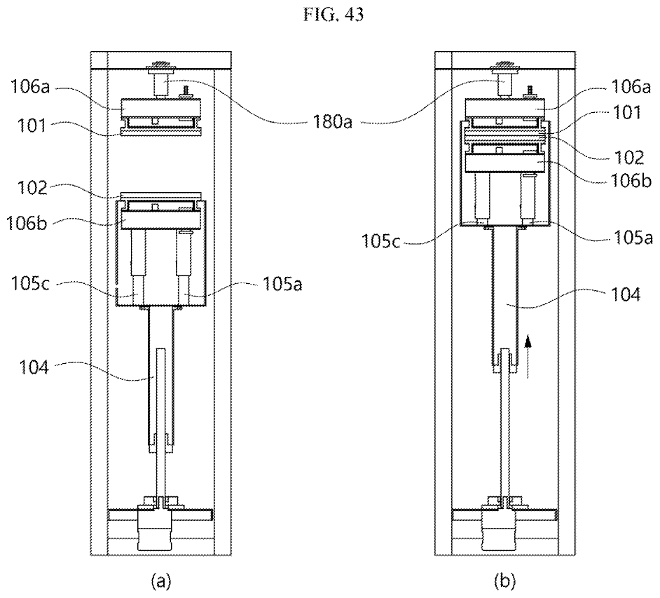

FIG. 43 is a set of exemplary diagrams for describing a method of allowing a grilling module to apply heat to meat using a plurality of grilling plates according to an embodiment.

Referring to FIG. 43, when meat is placed on a first grilling plate 101, a grilling module 100 may adjust a distance between the first grilling plate 101 and a second grilling plate 102 to be a preset distance, and apply heat to the placed meat.

The grilling module 100 may adjust a height of the first grilling plate 101 or the second grilling plate 102 to apply the heat to the meat placed between the first grilling plate 101 and the second grilling plate 102.

For example, when meat is placed on the first grilling plate 101, the grilling module 100 may move the second grilling plate 102 toward the first grilling plate 101 by a predetermined distance to apply heat to the placed meat. As another example, when the meat is placed on the first grilling plate 101, the grilling module 100 may move the first grilling plate 101 toward the second grilling plate 102 by a predetermined distance to apply the heat to the placed meat. As another example, when the meat is placed on the first grilling plate 101, the grilling module 100 may move the first grilling plate 101 and the second grilling plate 102 so that the distance between the first grilling plate 101 and the second grilling plate 102 becomes a predetermined value, to apply the heat to the placed meat.

FIG. 43A is a diagram illustrating an operation of the grilling module 100 before the meat is cooked, and FIG. 43B is a diagram illustrating an operation of the grilling module 100 while the meat is being cooked.

Referring to FIG. 43A, when the grilling module 100 performs an input operation, the first grilling plate 101 and the second grilling plate 102 may be disposed to be spaced apart from each other. In this case, the input operation may be an operation performed before the meat is cooked. The input operation may be an operation for placing the meat on the first grilling plate 101 or the second grilling plate 102 before the meat is cooked.

When the grilling module 100 performs the input operation, the first grilling plate 101 and the second grilling plate 102 may be spaced a preset distance from each other. When the grilling module 100 performs the input operation, the first grilling plate 101 and the second grilling plate 102 may be spaced a first distance from each other. The first distance may be a distance sufficient to place or take out the meat between the first grilling plate 101 and the second grilling plate 102.

Referring to FIG. 43B, when the grilling module 100 performs a cooking operation, the first grilling plate 101 and the second grilling plate 102 may be spaced a preset distance from each other. When the grilling module 100 performs the cooking operation, the first grilling plate 101 and the second grilling plate 102 may be spaced a second distance from each other. The second distance may be a distance sufficient to cook the meat between the first grilling plate 101 and the second grilling plate 102. The second distance may be a distance sufficient to transmit heat to the meat placed between the first grilling plate 101 and the second grilling plate 102. The second distance may be a distance shorter than the distance (e.g., first distance) between the first grilling plate 101 and the second grilling plate 102 when the grilling module 100 performs the input operation.

When the grilling module 100 performs the cooking operation, the second grilling plate 102 may move in a direction of the first grilling plate 101 by the shaft 104 while the first grilling plate 101 is fixed, and thus the distance between the first grilling plate 101 and the second grilling plate 102 may be adjusted.

The grilling module 100 may simultaneously apply heat to a plurality of surfaces of the meat by applying the heat to the meat using the plurality of grilling plates (e.g., the first grilling plate 101 and the second grilling plate 102). Since the grilling module 100 simultaneously applies the heat to the plurality of surfaces of the meat, it is possible to provide an effect that more rapid cooking can be achieved.

For example, the grilling module 100 may apply heat to a first surface of the meat through the first grilling plate 101, and at the same time, apply the heat to a second surface of the meat through the second grilling plate 102. As another example, the grilling module 100 may apply the heat to first and second surfaces of the meat through the first grilling plate 101, and at the same time, apply the heat to third and fourth surfaces of the meat through the second grilling plate 102.

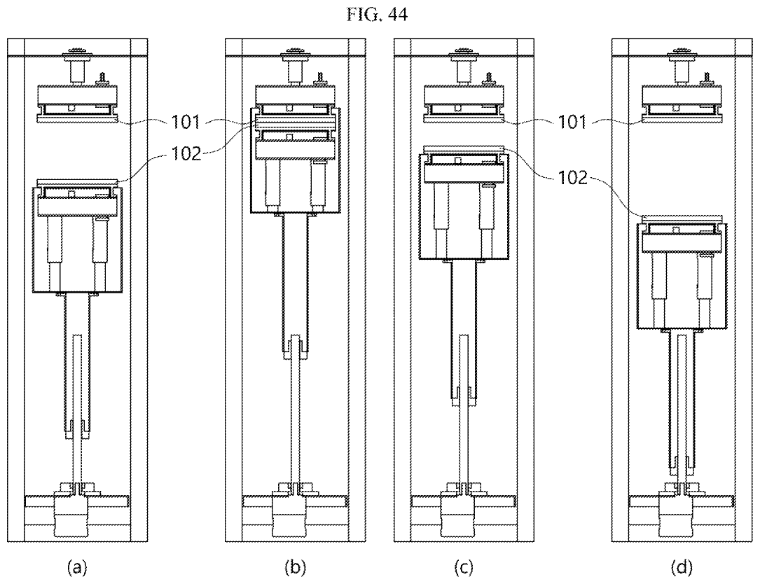

FIG. 44 is a set of exemplary diagrams for describing various operations performed by a grilling module according to an embodiment. The grilling module 100 may perform various operations in addition to the above-described input operation and cooking operation.

FIG. 44A is a diagram illustrating the grilling module 100 performing an input operation, FIG. 44B is a diagram illustrating the grilling module 100 performing a cooking operation, FIG. 44C is a diagram illustrating the grilling module 100 performing an output operation, and FIG. 44D is a diagram illustrating the grilling module 100 performing a cleaning operation.

The grilling module 100 may obtain meat to be cooked through an input operation. The grilling module 100 may apply heat to the first grilling plate 101 and the second grilling plate 102 through a cooking operation to provide the heat to meat placed between the first grilling plate 101 and the second grilling plate 102.

The grilling module 100 may perform an output operation when the cooking operation is completed, that is, when it is confirmed that cooking is completed in a preset manner. The output operation may be an operation for discharging the meat that has been cooked to the outside. When the grilling module 100 performs the output operation, the meat placed on the first grilling plate 101 or the second grilling plate 102 may be discharged to the outside after cooking is completed. Further, when the grilling module 100 performs the output operation, the first grilling plate 101 or the second grilling plate 102 may be cleaned by the pushing module 200.

The grilling module 100 may perform a cleaning operation. When grilling module 100 performs the cleaning operation, a distance between the first grilling plate 101 and the second grilling plate 102 becomes the farthest compared to other operations, and thus the user may directly clean the first grilling plate 101 or the second grilling plate 102.

The plurality of operations performed by the grilling module 100 and described above with reference to FIGS. 44A to 44D may be defined by the distance between the first grilling plate 101 and the second grilling plate 102. Alternatively, the plurality of operations performed by the grilling module 100 may be defined by a position of the second grilling plate 102 adjusted by the shaft 104.

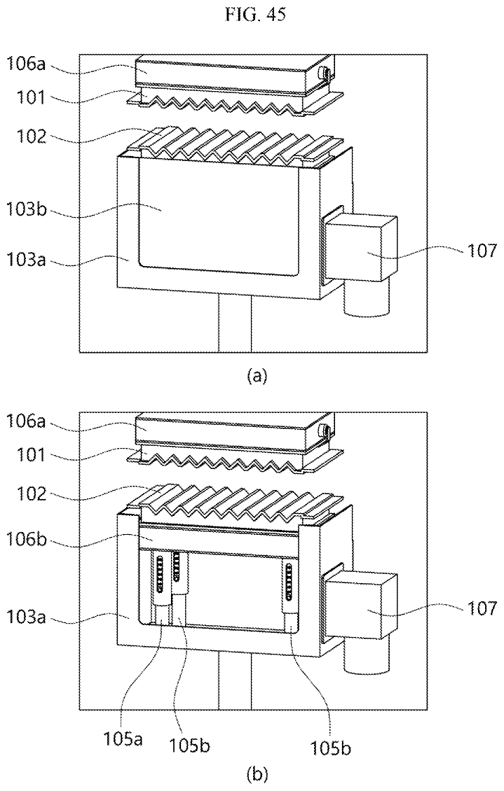

FIG. 45 is a set of exemplary diagrams for describing a housing included in a grilling module according to an embodiment. Referring to FIG. 45, a grilling module 100 may include a housing 103.

The housing 103 according to the embodiment may include an inner space. At least a part of the first grilling plate 101 or at least a part of the second grilling plate 102 may be accommodated in the inner space of the housing 103. When the grilling module 100 performs a cooking operation as illustrated in FIG. 44B, at least a part of the first grilling plate 101 or at least a part of the second grilling plate 102 may be accommodated in the inner space of the housing 103.

The meat may be cooked in a state in which at least a part of the first grilling plate 101 or at least a part of the second grilling plate 102 are accommodated in the inner space of the housing 103, and thus oil generated when heat is applied to the meat may remain inside the housing 103 without splashing out. As a result, oil generated when the meat is cooked is accommodated inside the housing 103 and minimally leaks to the outside of the housing 103, thereby providing an effect that a clean state can be maintained continuously. Further, even when the user manually cleans the grilling module 100, the oil accumulated inside the housing 103 can be cleaned, and thus cleaning and management can be much easier.

The at least one elastic member 105 described above may be disposed in the inner space of the housing 103. A first elastic member 105a to a fourth elastic member 105d may be disposed in the inner space of the housing 103.

The housing 103 may include a housing body 103a and a housing cover 103b. The housing body 103a may form an inner space in a form in which at least one surface thereof is open. The housing cover 103b may be provided to open or close at least a part of the open part of the housing body 103a. The housing cover 103b is coupled to the housing body 103a and may be coupled in a detachable state.

When the grilling module 100 operates in a cooking mode, the housing cover 103b may be coupled to the housing body 103a, and when the grilling module 100 operates in a cleaning mode, the housing cover 103b may be separated from the housing body 103a. Since the housing cover 103b is provided, the user may more easily clean the inner space of the housing 103. However, the housing cover 103b is not essential and may be provided selectively.

In a housing 103 according to an embodiment, a sub-housing 107 may be additionally formed. The grilling module 100 may circulate air through the sub-housing 107. Smoke and odor generated while the grilling module 100 operates may be discharged to the outside through the sub-housing 107.

The housing 103 and the sub-housing 107 may be formed to be fluidly connected to each other. The housing 103 may be fluidly connected to the sub-housing 107 through at least a part of surfaces of the housing 103. The housing 103 may be fluidly connected to the sub-housing 107 through at least a part of an upper surface or a lower surface of the housing 103.

An opening/closing member or a strainer may be present between the housing 103 and the sub-housing 107, and a blowing fan may be provided in the sub-housing 107. Since the blowing fan is provided in the sub-housing 107, smoke or the like generated in the housing 103 may be more effectively discharge to the outside.

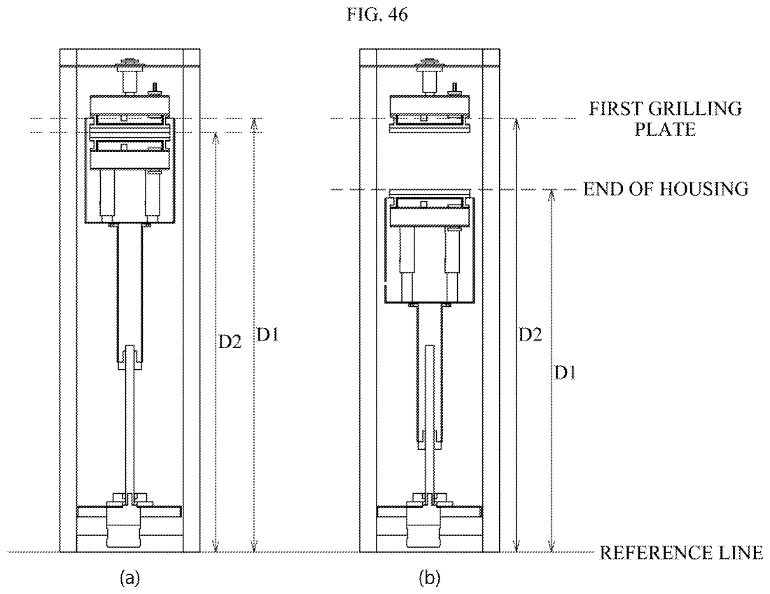

FIG. 46 is a set of exemplary diagrams for describing a relationship between a housing and a plurality of grilling plates included in a grilling module according to an embodiment.

Referring to FIG. 46, when a grilling module 100 performs a cooking operation on the basis of at least one elastic member 105 and a shaft 104. The housing 103 may accommodate at least a part of the first grilling plate 101 or at least a part of the second grilling plate 102 in an inner space thereof.

According to an embodiment, when a grilling module 100 performs a cooking operation, an interval between a first grilling plate 101 and a second grilling plate 102 is adjusted to become a preset distance.

According to an embodiment, when a grilling module 100 performs a cooking operation, a second grilling plate 102 may move in a direction of a first grilling plate 101 by a shaft 104 so that an interval between the first grilling plate 101 and the second grilling plate 102 becomes a preset distance.

The second grilling plate 102 may move in the direction of the first grilling plate 101 by the shaft 104 that is indirectly connected through at least one elastic member 105. While the second grilling plate 102 moves in the direction of the first grilling plate 101, the housing 103 connected to the at least one elastic member 105 may also move in the direction of the first grilling plate 101.

The housing 103 may move in the direction of the first grilling plate 101 at a first time point. At the first time point when the housing 103 starts to move in the direction of the first grilling plate 101, a protruding member 54 formed in a second support 52 of the elastic member 105 may be positioned at one end of the opening formed in the first support 51.

The second grilling plate 102 may move in the direction of the first grilling plate 101 at a second time point. At the second time point when the second grilling plate 102 starts to move in the direction of the first grilling plate 101, the protruding member 54 formed in the second support 52 of the elastic member 105 may be positioned at the other end of the opening formed in the first support 51. That is, the second grilling plate 102 may move from the second time point at which the protruding member 54 formed in the second support 52 of the elastic member 105 is positioned at the other end of the opening formed in the first support 51 in the direction toward the first grilling plate 101.

At the second time point, at least a part of the first grilling plate 101 or at least a part of the second grilling plate 102 may be accommodated in the inner space of the housing 103.

The second grilling plate 102 may move in the direction toward the first grilling plate 101 at the second time point, and may move to a third time point at which the interval between the first grilling plate 101 and the second grilling plate 102 becomes a predetermined interval. The second grilling plate 102 may move in the direction toward the first grilling plate 101 at the second time point, and may move to the third time point at which at least a part of the first grilling plate 101 and at least a part of the second grilling plate 102 are brought into contact with each other.

Cooking starts at the third time point at which the distance between the first grilling plate 101 and the second grilling plate 102 becomes the predetermined distance, and at the second time point, which is prior to the third time point, at least a part of the first grilling plate 101 or at least a part of the second grilling plate 102 may be accommodated in the inner space of the housing 103. Accordingly, oil generated when the meat is cooked may be accommodated in the housing 103 without splashing out.

Referring to FIG. 46A, when the grilling module 100 operates in a cooking mode, a first distance D1, which is a distance between a bottom surface of the automatic cooking device 10 or the ground and an end of the housing 103, may be greater than or equal to a second distance D2, which is a distance between the bottom surface of the automatic cooking device 10 or the ground and the first grilling plate 101. That is, since the first distance D1 is greater than or equal to the second distance D2, the oil generated when the meat is cooked may remain the inside of the housing and minimally leak out to the outside of the housing.

Referring to FIG. 46B, when the grilling module 100 operates in a mode (e.g., an input mode, an output mode, or a cleaning mode) other than the cooking mode, a first distance D1, which is a distance between a bottom surface of the automatic cooking device 10 or the ground and an end of the housing 103, may be smaller than or equal to a second distance D2, which is a distance between the bottom surface of the automatic cooking device 10 or the ground and the first grilling plate 101. That is, when the grilling module 100 does not operate in the cooking mode, the first distance D1 is smaller than or equal to the second distance D2, and thus, when the meat is placed on the second grilling plate 102, the meat that has been cooked is discharged, or the first grilling plate 101 and the second grilling plate 102 are cleaned, interference with the housing 103 may not occur.

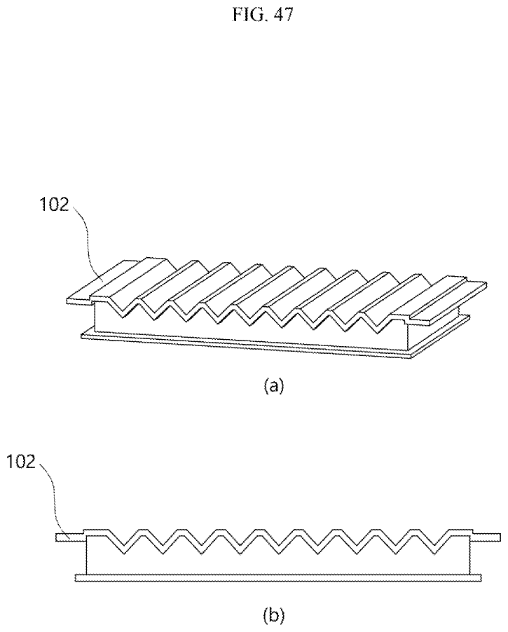

FIG. 47 is a set of exemplary diagrams for describing a grilling plate according to an embodiment.

Referring to FIG. 47, grooves may be formed in a first grilling plate 101 or a second grilling plate 102 according to the embodiment. A plurality of grooves may be formed at regular intervals in the first grilling plate 101 or the second grilling plate 102. The plurality of grooves may be formed to have a certain gradient. Since meat may be placed in the plurality of grooves, depths of the plurality of grooves may correspond to a thickness of the meat. For example, the plurality of grooves may be formed to have depths smaller than the thickness of the meat.

At least one groove formed in the first grilling plate 101 or second grilling plate 102 may have various shapes. The at least one groove formed in the first grilling plate 101 or second grilling plate 102 may be formed with various inclinations, widths, depths or intervals. For example, the at least one groove formed in the first grilling plate 101 or second grilling plate 102 may have a shape having a bottom surface. A flat bottom surface may be formed on at least a part of the at least one groove formed in the first grilling plate 101 or second grilling plate 102.

The first grilling plate 101 and the second grilling plate 102 may be disposed to face each other as described above, and when the grilling module 100 cooks the meat, that is, when the grilling module 100 performs the cooking operation, at least a part of the first grilling plate 101 and at least a part of the second grilling plate 102 may be brought into contact with each other.

When the grilling module 100 performs the cooking operation, the first grilling plate 101 and the second grilling plate 102 may be disposed to face each other at predetermined intervals, and in this case, a cooking space may be formed due to the plurality of grooves formed in the first grilling plate 101 and the plurality of grooves formed in the second grilling plate 102. The meat may be placed and cooked in the cooking space. In this case, the grilling module 100 may simultaneously apply heat to difference surfaces of the meat through the first grilling plate 101 and the second grilling plate 102. For example, the grilling module 100 may apply heat to a first surface and a second surface of the meat through the first grilling plate 101, and at the same time, apply heat to a third surface and a fourth surface of the meat through the second grilling plate 102.

The shape of the first grilling plate 101 or the second grilling plate 102 described with reference to FIG. 47 is exemplary, and the shape of the first grilling plate 101 or the second grilling plate 102 may be provided in various other shapes.

The method of applying the heat to the meat placed on the first grilling plate 101 and the second grilling plate 102 of the grilling module 100 may vary according to a predetermined cooking method, and in this case, a temperature of the heat applied through the first grilling plate 101 and a temperature of the heat applied through the second grilling plate 102 may be the same as or different from each other, and a time during which the heat is provided through the first grilling plate 101 and a time during which the heat is provided through the second grilling plate 102 may be the same as or different from.

4.2 Pushing Module

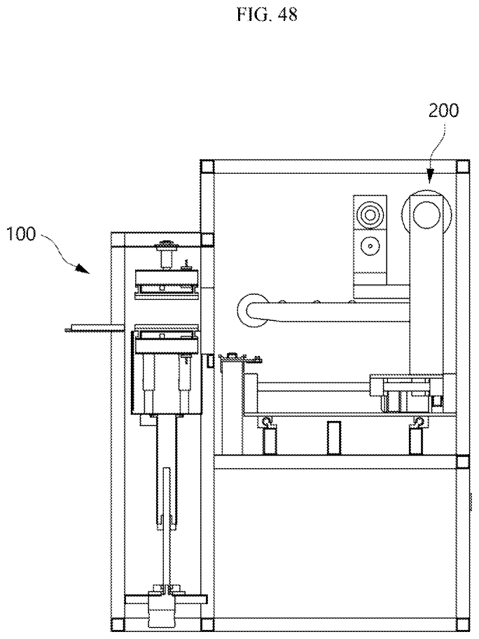

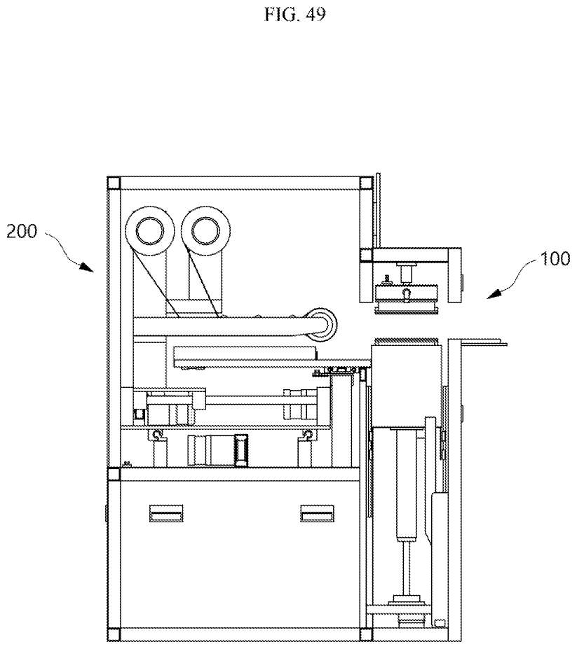

FIGS. 48 and 49 are exemplary diagrams for describing a pushing module according to an embodiment, and hereinafter, a pushing module 200 will be described with reference to FIGS. 48 and 49.

Referring to FIGS. 48 and 49, a pushing module 200 according to the embodiment may be disposed in a region adjacent to the grilling module 100. The pushing module 200 may serve to assist meat to be cooked to be placed on the grilling module 100, serve to assist the cooked meat to be discharged to the outside through the grilling module 100, and serve to assist at least a part of the grilling module 100 to be cleaned.

According to an embodiment, an automatic cooking device 10 may include a plurality of grilling modules 100 and a pushing module 200. For example, the automatic cooking device 10 may include two or more grilling modules 100 and one pushing module 200. As a more specific example, the automatic cooking device 10 may include four grilling modules 100 and one pushing module 200. In this case, the pushing module 200 may assist operations of the four grilling modules 100.

According to another embodiment, the automatic cooking device 10 may include a plurality of grilling modules 100 and a plurality of pushing modules 200. For example, the automatic cooking device 10 may include a plurality of grilling modules 100 and a corresponding number of pushing modules 200. As a more specific example, the automatic cooking device 10 may include four grilling modules 100 and four pushing modules 200. In this case, a first pushing module may assist an operation of the first grilling module, the second pushing module may assist an operation of the second grilling module, the third pushing module may assist an operation of the third grilling module, and the fourth pushing module may assist an operation of the fourth grilling module.

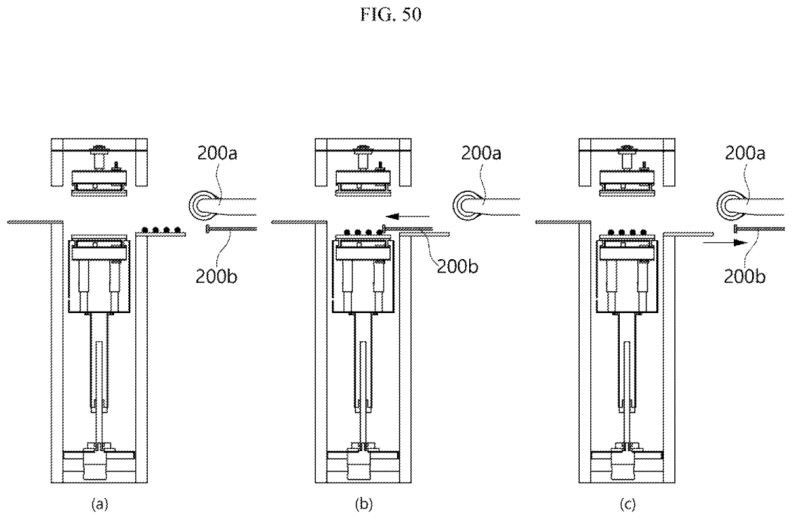

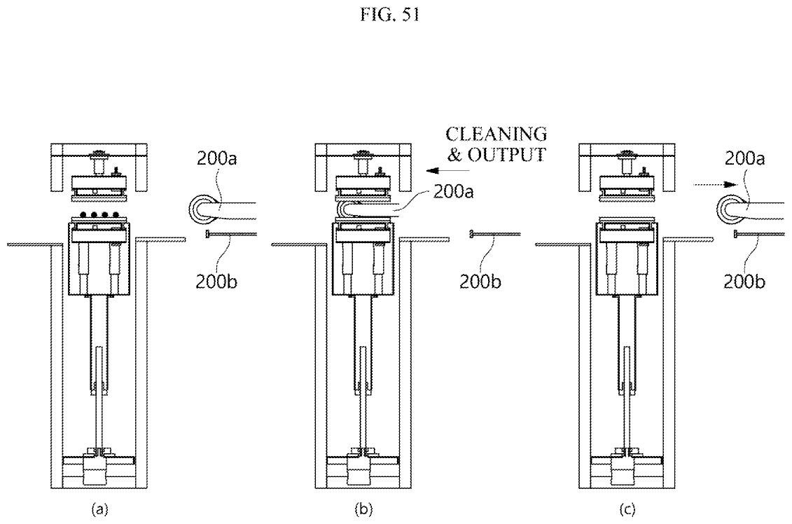

FIGS. 50 and 51 are exemplary diagrams for describing an operation of a pushing module according to an embodiment.

The pushing module 200 according to the embodiment may include a first pushing module 200a and a second pushing module 200b. The pushing module 200 may operate in conjunction with the operation of the grilling module 100. Each of the first pushing module 200a and the second pushing module 200b may operate in conjunction with the operation of the grilling module 100.

The grilling module 100 may perform a plurality of operations as described above. For example, the grilling module 100 may perform a first operation to a fourth operation. In this case, the first pushing module 200a may perform a fifth operation when the grilling module 100 performs the first operation, and the second pushing module 200b may perform a sixth operation when the grilling module 100 performs the third operation.

For example, the first operation performed by the grilling module 100 may be an input operation, and the third operation performed by the grilling module 100 may be an output operation. However, the present is not limited thereto, and when the grilling module 100 operates in various modes or is in various states, the pushing module 200 may operate in conjunction with the grilling module 100.

Referring to FIG. 50, the second pushing module 200b may perform an operation of placing meat to be cooked on the grilling module 100.

When the grilling module 100 performs a predetermined operation, the second pushing module 200b may perform the first operation in conjunction with the grilling module 100. When the grilling module 100 performs an input operation, the second pushing module 200b may perform the first operation in conjunction with the grilling module 100.

When the grilling module 100 is in the first state, the second pushing module 200b may perform the first operation in conjunction with the grilling module 100. The first state may be a state in which the grilling module 100 performs the input operation. The first state may be a state in which a distance between the first grilling plate 101 and the second grilling plate 102 is a predetermined first distance. The first state may be a state in which the grilling module 100 performs a specific operation.

When a first distance from a bottom surface of the automatic cooking device 10 or the ground to the second pushing module 200b corresponds to a second distance from the bottom surface of the automatic cooking device 10 or the ground to the second grilling plate 102, the second pushing module 200b may perform the first operation.

When the first distance from the bottom surface of the automatic cooking device 10 or the ground to the second pushing module 200b is identical to the second distance from the bottom surface of the automatic cooking device 10 or the ground to the second grilling plate 102 within an error range, the second pushing module 200b may perform the first operation.

As illustrated in FIGS. 50A to 50C, when it is determined that the grilling module 100 is in the first state, the second pushing module 200b may perform the first operation. In this case, the first operation may be an operation in which the second pushing module 200b reciprocates by a predetermined distance in a direction toward the first grilling plate 101 or the second grilling plate 102.

When it is determined that the grilling module 100 is in the first state, the second pushing module 200b may perform an operation of reciprocating by a predetermined distance in a direction perpendicular to the first grilling plate 101 or the second grilling plate 102.

When it is determined that the grilling module 100 is in the first state, the second pushing module 200b may perform an operation of performing a reciprocating motion by a predetermined distance with respect to a first axis. The first axis may be an axis perpendicular to a longitudinal direction of the first grilling plate 101 or the second grilling plate 102. The first axis may be an axis parallel to a direction of the groove formed in the first grilling plate 101 or the second grilling plate 102.

Whether the grilling module 100 is in the above-described first state or whether the input operation is completed may be determined based on a value of at least one sensor. The sensor may be a contact sensor or a non-contact sensor, and various known types of sensors may be used.

The above-described reciprocating motion performed by the second pushing module 200b may be an operation in which the second pushing module 200b moves a predetermined distance in a first direction and then moves a predetermined distance in a second direction opposite to the first direction.

Referring to FIG. 51, the first pushing module 200a may perform an operation of discharging meat that has been cooked from the grilling module 100 and an operation of cleaning the grilling plate of the grilling module 100.

When the grilling module 100 performs a predetermined operation, the first pushing module 200a may perform a second operation in conjunction with the grilling module 100. When the grilling module 100 performs an output operation, the first pushing module 200a may perform the second operation in conjunction with the grilling module 100.

When the grilling module 100 is in a second state, the first pushing module 200a may perform the second operation in conjunction with the grilling module 100. The second state may be a state in which the grilling module 100 performs the output operation. The second state may be a state in which the distance between the first grilling plate 101 and the second grilling plate 102 is a predetermined second distance. The second state may be a state in which the grilling module 100 performs the specific operation.

When a first distance from a bottom surface of the automatic cooking device 10 or the ground to the first pushing module 200a corresponds to a second distance from the bottom surface of the automatic cooking device 10 or the ground to the second grilling plate 102, the first pushing module 200a may perform the second operation.

When the first distance from the bottom surface of the automatic cooking device 10 or the ground to the first pushing module 200a is identical to the second distance from the bottom surface of the automatic cooking device 10 or the ground to the second grilling plate 102 within an error range, the first pushing module 200a may perform the second operation.

As illustrated in FIGS. 51A to 51C, when it is determined that the grilling module 100 is in the second state, the first pushing module 200a may perform the second operation. In this case, the second operation may be an operation in which the first pushing module 200a reciprocates by a predetermined distance in a direction toward the first grilling plate 101 or the second grilling plate 102.

When it is determined that the grilling module 100 is in the second state, the first pushing module 200a may perform an operation in which the first pushing module 200a reciprocates by a predetermined distance in a direction perpendicular to the first grilling plate 101 or the second grilling plate 102.

When it is determined that the grilling module 100 is in the second state, the first pushing module 200a may perform a reciprocating motion by a predetermined distance with respect to a first axis. The first axis may be an axis perpendicular to a longitudinal direction of the first grilling plate 101 or the second grilling plate 102. The first axis may be an axis parallel to a direction of the groove formed in the first grilling plate 101 or the second grilling plate 102.

Whether the grilling module 100 is in the above-described second state or whether the output operation is completed may be determined based on a value of at least one sensor. The sensor may be a contact sensor or a non-contact sensor, and various known types of sensors may be used.

The above-described reciprocating motion performed by the first pushing module 200a may be an operation in which the first pushing module 200a moves a predetermined distance in a first direction and then moves a predetermined distance in a second direction opposite to the first direction.

The first pushing module 200a and the second pushing module 200b may operate in conjunction with each other. For example, the first pushing module 200a may operate when the second pushing module 200b does not operate. Alternatively, the second pushing module 200b may operate when the first pushing module 200a does not operate. Alternatively, the first pushing module 200a and the second pushing module 200b may operate simultaneously.

As an example, the first pushing module 200a and the second pushing module 200b may be disposed with a step difference therebetween. The first pushing module 200a and the second pushing module 200b may be disposed with a step difference therebetween, wherein the first pushing module 200a may be disposed close to the first grilling plate 101, and the second pushing module 200b may be disposed close to the second grilling plate 102. In this case, the second grilling plate 102 may be provided in a state in which a height thereof is adjustable by the shaft 104, and the first grilling plate 101 may be provided in a fixed state. As another example, the first pushing module 200a may be disposed above the second pushing module 200b.

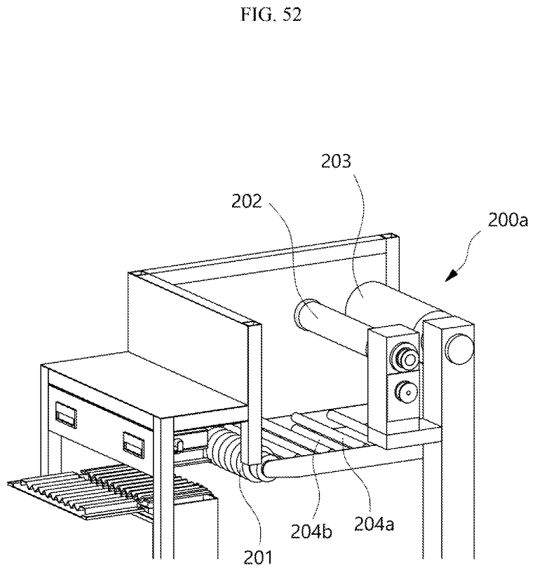

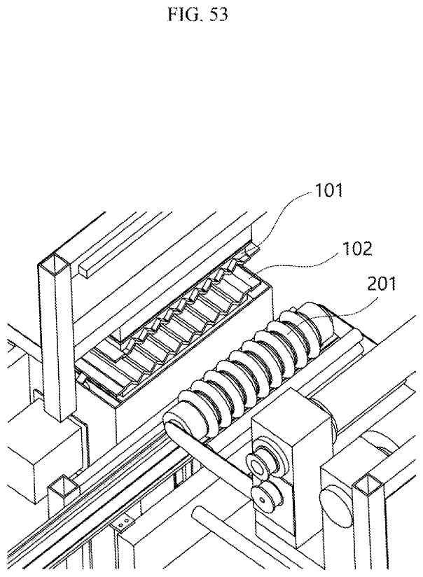

FIGS. 52 and 53 are exemplary diagrams for describing a first pushing module according to an embodiment. The first pushing module 200a may perform a function of discharging the meat cooked as described above from the grilling module 100 to the outside, and perform a function of cleaning at least one of a plurality of grilling plates constituting the grilling module 100. Hereinafter, accessories assisting in performing the functions of the first pushing module 200a will be described with reference to FIG. 52.

Referring to FIG. 52, the first pushing module 200a may include a rotation roller 201, a collection roller 202, a supply roller 203, and at least one pressing members 204a and 204b.

A roll of paper may be provided on the supply roller 203. Pieces of unused paper may be provided on the supply roller 203 in a rolled form. In this case, the paper may be a material of paper or synthetic resin, but the present invention is not limited thereto. The paper may be various known materials that can be used for wiping a surface of the first grilling plate 101 or the second grilling plate 102.

When the paper provided on the supply roller 203 is exhausted, the first pushing module 200a may automatically or manually replenish the paper in the supply roller 203.

When an abnormal situation such as cutting or jamming the paper provided on the supply roller 203 occurs, the first pushing module 200a may provide a notification of the abnormal situation to the user.

Whether the paper is exhausted or whether an abnormal situation has occurred may be determined based on the number of revolutions of at least one of the rotation roller 201, the collection roller 202, and the supply roller 203. Whether the paper is exhausted or whether the abnormal situation has occurred may be determined by a sensor. Whether the paper is exhausted or whether the abnormal situation has occurred may be determined based on the number of repetitions of a specific operation (e.g., cooking operation) by the grilling module 100.

The collection roller 202 may perform a function of collecting at least some rolls of paper provided on the supply roller 203. The collection roller 202 may perform a function of returning at least some rolls of paper provided on the supply roller 203. The collection roller 202 may be disposed at a predetermined interval from the supply roller 203. The paper provided on the supply roller 203 may be wound around the collection roller 202 after the performance of the cleaning function is completed.

The collection roller 202 may provide power to the supply roller 203 or the rotation roller 201. The collection roller 202 may be directly or indirectly connected to a driving unit, and may provide power to the supply roller 203 or the rotation roller 201 through the driving unit. By providing the power to the supply roller 203 or the rotation roller 201 through the collection roller 202, the paper provided on the supply roller 203 may be smoothly returned to the collection roller 202 via the rotation roller 201 without being pushed or cut off.

The collection roller 202 may include a separate tension maintenance module. The tension generated between at least one of the rotation roller 201, the collection roller 202, and the supply roller 203 and the paper may be maintained through the tension maintenance module.

The rotation roller 201 may rotationally move in conjunction with at least one of the supply roller 203 and the collection roller 202. The rotation roller 201 may be indirectly connected to the supply roller 203 and the collection roller 202 so as to rotationally move in conjunction with at least one of the supply roller 203 and the collection roller 202.

Referring to FIG. 53, a shape of the rotation roller 201 may correspond to a shape of the first grilling plate 101 or second grilling plate 102 provided in the grilling module 100. The rotation roller 201 may include a plurality of protruding members, and the plurality of protruding members may be formed to correspond to a plurality of grooves formed in the first grilling plate 101 or second grilling plate 102 provided in the grilling module 100.

For example, when the plurality of grooves formed in the first grilling plate 101 or second grilling plate 102 provided in the grilling module 100 are formed at a first interval, the plurality of protruding members provided in the rotation roller 201 may also be formed at the first interval. As another example, when a cross section of each of the plurality of grooves formed in the first grilling plate 101 or second grilling plate 102 provided in the grilling module 100 has a first shape, the plurality of protruding members provided in the rotation roller 201 may also be formed to have a shape similar to the first shape.

As still another example, a first groove and a second groove may be formed in the first grilling plate 101 or second grilling plate 102 provided in the grilling module 100, and a first protruding member and a second protruding member may be formed on the rotation roller 201. In this case, the first protruding member may be provided to be coupled to the first groove, and the second protruding member may be provided to be coupled to the second groove.

The first pushing module 200a may include a plate that is connected to the rotation roller 201 and guides movement of the paper. The paper provided on the supply roller 203 may be transmitted to the rotation roller 201 via the plate.

The first pushing module 200a may include at least one pair of pressing members. The at least one pair of pressing members may serve to assist the paper to move in close contact with the plate in a region adjacent to the rotation roller 201.

The first pushing module 200a may include a first pressing member 204a and a second pressing member 204b. The first pressing member 204a and the second pressing member 204b may be rotatably provided.

The first pressing member 204a and the second pressing member 204b may be present as a pair. The first pressing member 204a and the second pressing member 204b may be disposed to be symmetrical to each other. The first pressing member 204a and the second pressing member 204b may be disposed to face each other.

When the first pressing member 204a is disposed on one surface of the plate, the second pressing member 204b may be disposed on another surface of the plate. When the first pressing member 204a is disposed on one surface of the plate, the second pressing member 204b may be disposed on another surface of the plate and may be disposed at a position symmetrical to the first pressing member 204a with respect to the plate.

The first pressing member 204a and the second pressing member 204b may be disposed in a region adjacent to the rotation roller 201 on the plate. The first pressing member 204a and the second pressing member 204b may be disposed at points spaced a preset distance from the rotation roller 201 on the plate.

As described above, the first pushing module 200a may include a pair of pressing members 204a and 204b, but the present invention is not limited thereto, and the first pushing module 200a may include multiple pairs of pressing members. For example, the first pushing module 200a may include a plurality of pairs of pressing members. As a more specific example, the first pushing module 200a may include a first pressing member, a second pressing member, a third pressing member, and a fourth pressing member, the first pressing member and the second pressing member may be provided as a pair, and the third pressing member and the fourth pressing member may be provided as a pair. In other words, the first pressing member and the second pressing member may be disposed to face each other with respect to the plate, and the third pressing member and the fourth pressing member may be disposed to face each other with respect to the plate.

4.3 Moving Module

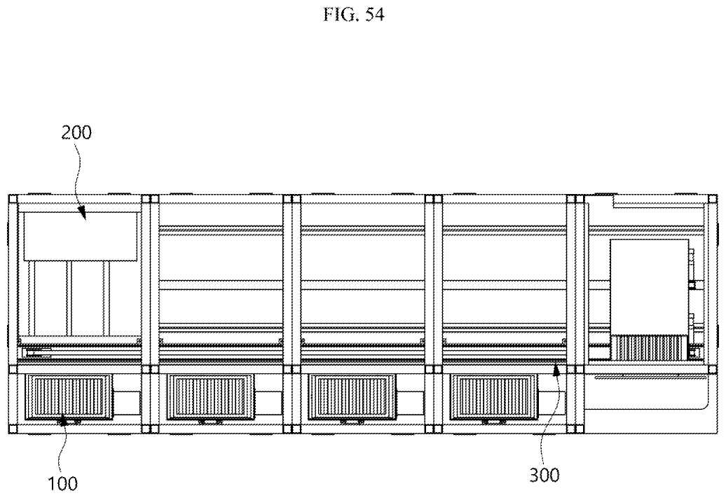

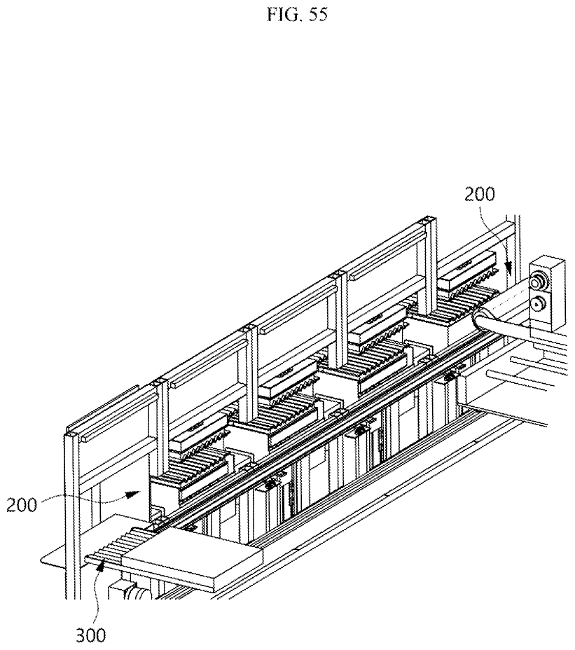

FIGS. 54 and 55 are exemplary diagrams for describing a moving module according to an embodiment. Referring to FIGS. 54 and 55, an automatic cooking device 10 according to an embodiment may include a grilling module 100, a pushing module 200, and a moving module 300.

The moving module 300 may be provided in the form of a rail. The moving module 300 may be provided in the form of a rail, and may move meat placed on a plate to the grilling module 100. When a plurality of grilling modules 100 are provided, the moving module 300 may move meat to one of the plurality of grilling modules determined according to a predetermined criterion.

A sensor may be provided in the moving module 300, and based on a value measured through the sensor, the moving module 300 may move the meat to one of the plurality of grilling modules determined according to the predetermined criterion.

4.4 Storage Module

Although not illustrated in the drawing, an automatic cooking device 10 according to an embodiment may include a storage module 400.

The storage module 400 may include a space for storing meat before being cooked. The meat before being cooked according to a predetermined criterion may be disposed or stored in the storage module 400. The storage module 400 may include a space in which a plurality of plates capable of accommodating the meat before being cooked can be inserted and disposed. A shape of the storage module 400 is not limited, and the storage module 400 may be provided in various known shapes having a space capable of accommodating meat.

4.5 Method of Operating Device

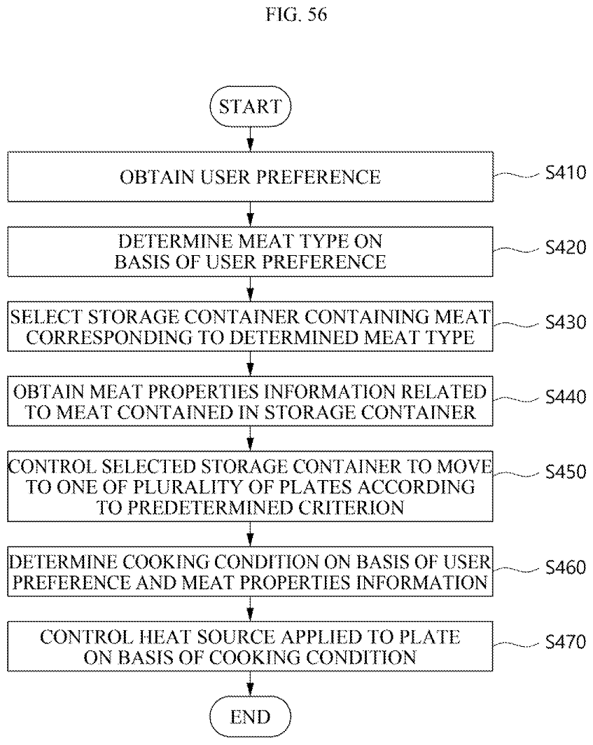

FIG. 56 is an exemplary flowchart for describing a method of operating an automatic cooking device according to an embodiment.

Referring to FIG. 56, an automatic cooking device 10 according to the embodiment may perform a step S410 of obtaining user preference, a step S420 of determining a type of meat on the basis of the user preference, a step S430 of selecting a storage container containing meat corresponding to the determined type of the meat, a step S440 of obtaining meat properties information related to the meat contained in the storage container, a step S450 of controlling the selected storage container to move to one of a plurality of plates according to a predetermined criterion, a step S460 of determining a cooking condition on the basis of the user preference and the meat properties information, and a step S470 of controlling a heat source applied to the plate on the basis of the cooking condition.

The automatic cooking device 10 may obtain user preference and determine a type of meat on the basis of the user preference. The user preference is related to a result of cooking the meat, and may be related to a taste of meat desired by the user, such as meat flavor, meat juiciness, meat tenderness, etc. The automatic cooking device 10 may determine the type of the meat on the basis of at least one of flavor, juiciness, and tenderness of the meat obtained from a user input.

The automatic cooking device 10 may select at least one storage container containing meat corresponding to the determined type of the meat from among a plurality of containers included in the storage module 400.

For example, information on the contained meat may be mapped to the storage container, and the automatic cooking device 10 may select at least one storage container containing the meat corresponding to the determined type of the meat from among a plurality of containers on the basis of the mapped value. As another example, a plurality of containers may be disposed in the storage module 400 according to a predetermined criterion. For example, a plurality of containers may be disposed in a predetermined order on the basis of the type and/or the properties of the meat in the storage module 400. In this case, the automatic cooking device 10 may select at least one storage container containing the meat corresponding to the determined type of the meat from among a plurality of containers on the basis of the predetermined criterion or the order in which the plurality of containers are disposed.

The automatic cooking device 10 may obtain properties information on the meat contained in the selected storage container. The automatic cooking device 10 may extract the meat properties information by itself through an additionally provided analysis device or may obtain the extracted meat properties information through an external analysis device.

The meat properties information may be extracted through image data or non-image data, and since the detailed extraction method has been described above, overlapping descriptions thereof will be omitted.

The automatic cooking device 10 may control the selected storage container to move to one of the plurality of plates according to a predetermined criterion. The automatic cooking device 10 may control the selected storage container to move to one of a plurality of grilling modules according to a predetermined criterion.

For example, the automatic cooking device 10 may control the selected storage container to move to one grilling module in a standby state among the plurality of grilling modules. As another example, the automatic cooking device 10 may control the selected storage container to move to a grilling module heated at a temperature closest to a predetermined value among the plurality of grilling modules. As another example, the automatic cooking device 10 may control the selected storage container to move to a grilling module positioned closest to the storage module 400 among the plurality of grilling modules.

In this case, when the automatic cooking device 10 determines the grilling module heated at a temperature closest to a predetermined value from among the plurality of grilling modules, the predetermined value may be determined based on the user preference, the meat properties information, or the predetermined cooking condition.

As still another example, after the automatic cooking device 10 determines the grilling module in a standby state from among the plurality of grilling modules, when there are a plurality of grilling modules in a standby state, the automatic cooking device 10 may control the selected storage container to move to the grilling module heated at the most appropriate temperature. As another example, after the automatic cooking device 10 determines the grilling module in a standby state from among the plurality of grilling modules, when there are a plurality of grilling modules in a standby state, the automatic cooking device 10 may determine the grilling module heated at the most appropriate temperature, wherein, when there are a plurality of grilling modules heated at the most appropriate temperature, the automatic cooking device 10 may control the selected storage container to move to the grilling module positioned closest to the storage module 400.

The automatic cooking device 10 may determine a cooking condition on the basis of the user preference and the meat properties information. The automatic cooking device 10 may determine the cooking condition by itself through an additionally provided device or may obtain the determined cooking condition through an external device.

The cooking condition may be the intensity of heat applied to the meat through the grilling module 100 or a time for applying heat to the meat, and since detailed descriptions thereof have been described above, overlapping descriptions thereof will be omitted.

The automatic cooking device 10 may control the grilling module 100 according to the determined cooking condition in the above-described method. The automatic cooking device 10 may control the intensity of the heat source and the operation time of the heat source of the grilling module 100 according to the determined cooking condition in the above-described method, and since detailed descriptions thereof have been described above, overlapping descriptions thereof will be omitted.

5 Cooking Guide System

When the cooking device is not a system that automatically cooks meat, but the user wants to grill the meat by himself/herself, it is necessary to precisely control the temperature, grilling time, timing of flipping the meat, and the like in order to satisfy the meat state desired by the user. However, there is a limit in that it is difficult to precisely control the temperature, grilling time, timing of flipping the meat, and the like unless performed by an expert, and accordingly, in most cases, the meat is cooked without satisfying the user's desired state.

Accordingly, a cooking guide system according to an embodiment may provide an appropriate cooking guide after recognizing a state of meat in real time when the user wants to grill the meat by himself/herself.

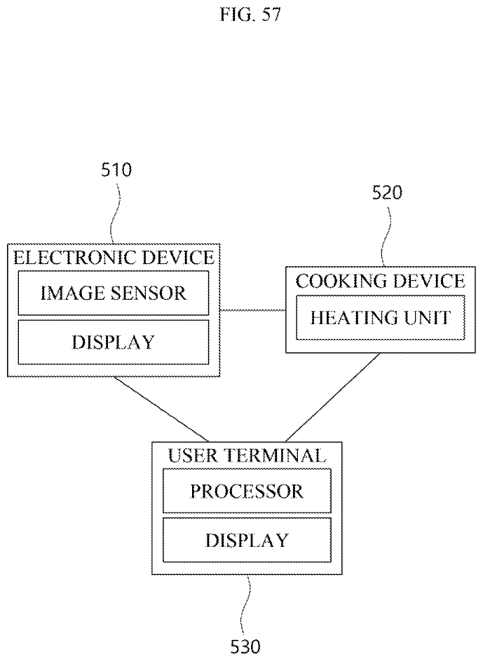

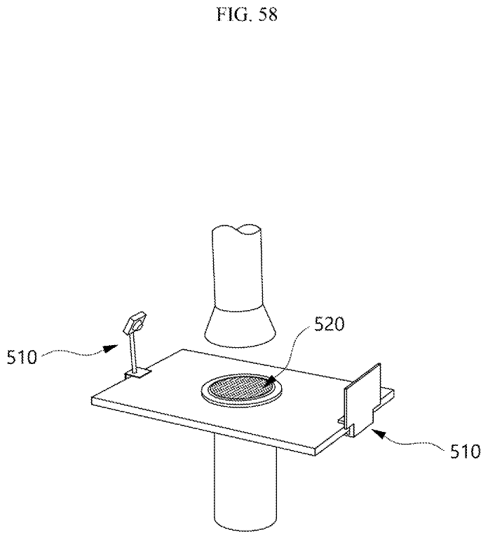

FIGS. 57 and 58 are diagrams for describing a cooking guide system according to an embodiment. Referring to FIG. 57, the cooking guide system according to the embodiment may include an electronic device 510, a cooking device 520, and a user terminal 530.

The electronic device 510 may include an image sensor for photographing meat being cooked. The electronic device 510 may include a display for displaying a result of analyzing an image of the meat obtained through an image sensor or displaying information obtained based on the analysis result.

The cooking device 520 may include a heating unit (e.g., heat source) for transmitting heat to meat. Although not illustrated in the drawing, the cooking device 520 may include various auxiliary devices necessary for cooking meat in addition to a heat source.

The user terminal 530 may include a processor for computational processing. The user terminal 530 may include a display for obtaining a user input or displaying a result of analyzing an image of meat to the user.

According to another embodiment, as illustrated in FIG. 58, the cooking guide system may include a cooking device 520 and an electronic device 510. In this case, a user input may be obtained through the electronic device 510 or a result of analyzing an image of meat may be displayed to the user through the electronic device 510.

According to another embodiment, the cooking guide system may include a cooking device 520 and a user terminal 530. In this case, the cooking device 520 may an image sensor for photographing meat being cooked, and a display for displaying a result of analyzing the obtained image of the meat or displaying information obtained based on the analysis result. Hereinafter, the cooking guide system will be described as including the cooking device 520 and the user terminal 530.

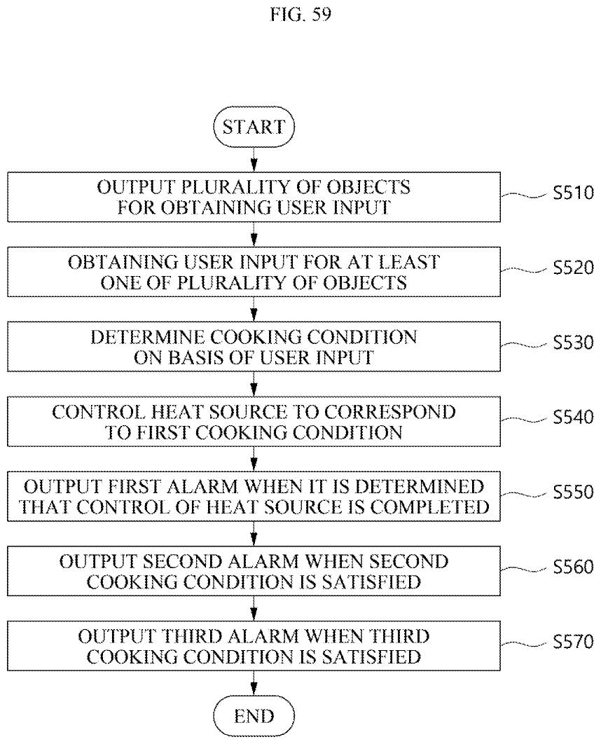

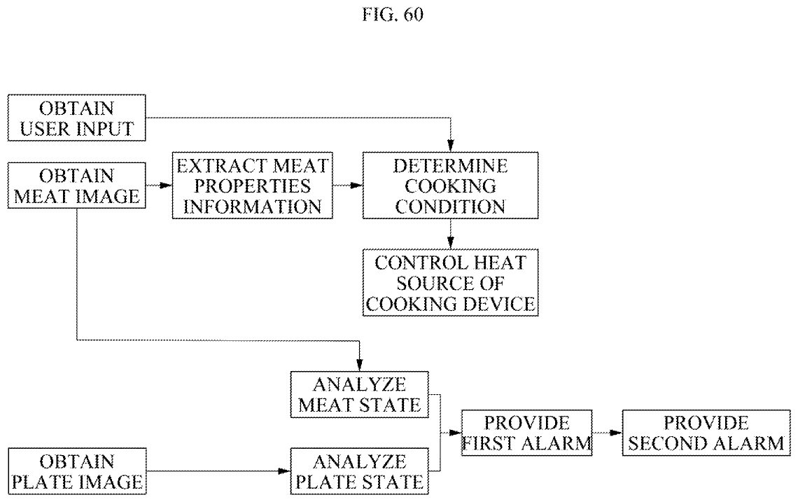

FIGS. 59 and 60 are exemplary diagrams for describing a method of providing a guide to a user through a cooking guide system according to an embodiment.

Referring to FIG. 58, a cooking device 520 may perform a step S510 of outputting a plurality of objects for obtaining a user input, a step S520 of obtaining a user input for at least one of the plurality of objects, a step S530 of determining a cooking condition on the basis of the user input, a step S540 of controlling a heat source to correspond to a first cooking condition, a step S550 of outputting a first alarm when it is determined that the control of the heat source is completed, a step S560 of outputting a second alarm when a second cooking condition is satisfied, and a step S570 of outputting a third alarm when a third cooking condition is satisfied.

The cooking device 520 may output a plurality of objects for obtaining a user input through a display. The user may input information related to user preference through the plurality of objects. The information related to the user preference is related to a result of cooking the meat, and thus may be related to a taste of meat desired by the user, such as meat flavor, meat juiciness, meat tenderness, etc.

The cooking device 520 may determine a cooking condition on the basis of the user input and control a heat source to correspond to the determined cooking condition. Since the method of determining the cooking condition on the basis of the user input and the method of controlling the heat source to correspond to the determined cooking condition have been described above, overlapping descriptions thereof will be omitted.

The cooking device 520 may output a first alarm when it is determined that the control of the heat source is completed. The first alarm may be an alarm guiding the user to place meat on a grilling plate.

The cooking device 520 may output a second alarm when a second cooking condition is satisfied, and output a third alarm when a third cooking condition is satisfied. The second cooking condition may be a cooking condition for one surface of the meat, and the third cooking condition may be a cooking condition for another surface of the meat.

More specifically, in the case in which the second cooking condition for one surface of the meat is pre-stored and the heat source is applied to the one surface of the meat, when it is determined that the second cooking condition is satisfied (e.g., when it is determined that the meat has been heated at a preset temperature for a preset period of time), the cooking device 520 may output the second alarm. As with above, in the case in which the third cooking condition for another surface of the meat is pre-stored and the heat source is applied to another surface of the meat, when it is determined that the third cooking condition is satisfied (e.g., when it is determined that the meat has been heated at a preset temperature for a preset period of time), the cooking device 520 may output the third alarm.

In this case, the second alarm may be an alarm guiding the user to flip the meat placed on the grilling plate, and the third alarm may be an alarm informing that the cooking of the meat has been completed.

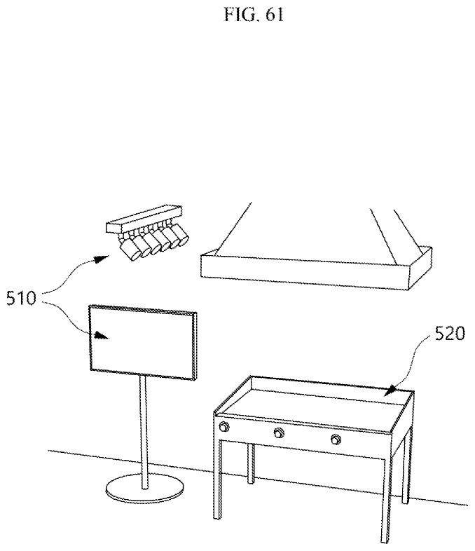

FIGS. 61 to 63 are diagrams for describing a cooking guide system according to another embodiment. Referring to FIG. 61, the cooking guide system according to another embodiment may include an electronic device 510 and a cooking device 520. In this case, the cooking device 520 may include a plate for cooking meat, and at least one region of the plate may be provided with a different temperature from the remaining regions.

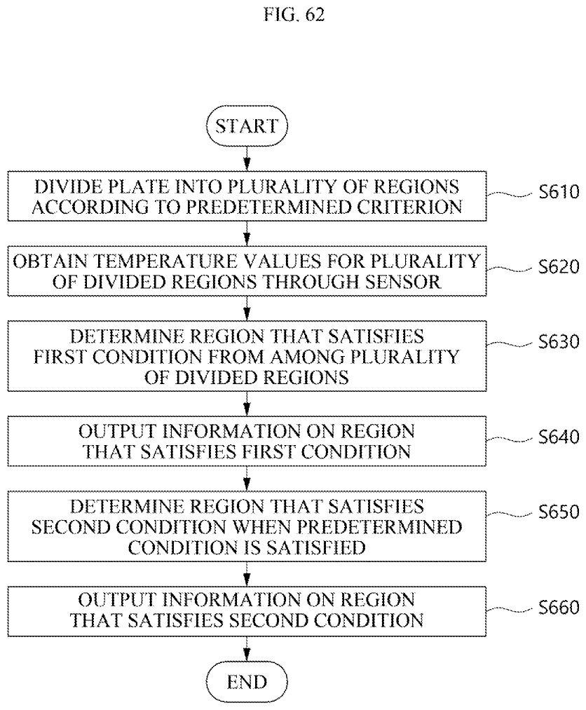

Referring to FIG. 62, the cooking device 520 may perform a step S610 of dividing a plate into a plurality of regions according to a predetermined criterion, a step S620 of obtaining temperature values for the plurality of divided regions through a sensor, a step S630 of determining a region that satisfies a first condition from among the plurality of divided regions, a step S640 of outputting information on the region that satisfies the first condition, a step S650 of determining a region that satisfies a second condition among the plurality of divided regions when a predetermined condition is satisfied, and a step S660 of outputting information on the region that satisfies the second condition.

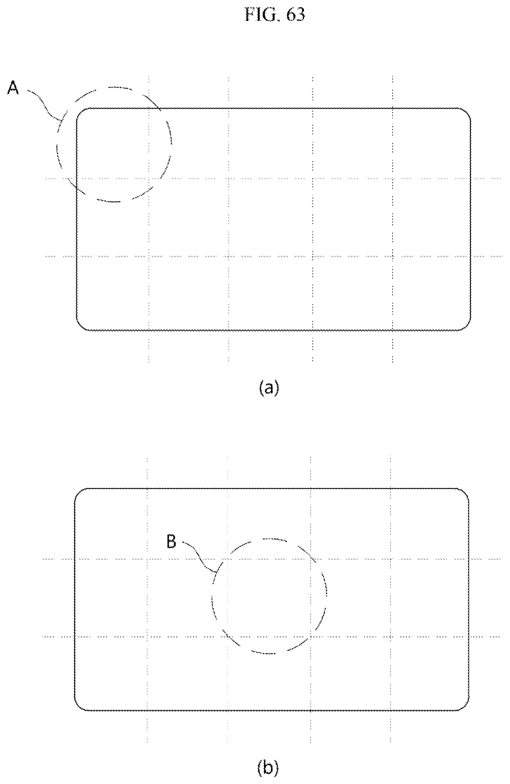

Referring to FIG. 63, the cooking device 520 may be divided a plate into a plurality of regions according to a predetermined criterion. In this case, the plurality of regions may be virtual regions rather than physically divided regions.

The cooking device 520 may obtain temperature values of the plurality of divided regions through a sensor, and determine a first region that satisfies a first condition from among the plurality of divided regions. The first condition may be a condition related to temperature. For example, the cooking device 520 may determine a first region closest to a preset temperature value from among the plurality of divided regions. Thereafter, the cooking device 520 may output an alarm or the like guiding the user's operation to place the meat in the first region that satisfies the first condition.

In the case in which the meat is cooked in the first region, when the predetermined condition is satisfied, the cooking device 520 may determine a second region that satisfies a second condition from among the plurality of divided regions, and output information on the second region to the user.

As a more specific example, the cooking device 520 may operate based on information that meat should cooked at a preset first temperature for a first period of time (e.g., cooked according to the first condition) and then cooked at a preset second temperature for a second period of time (e.g., cooked according to the second condition). In this case, when it is determined that the meat is cooked at a preset first temperature for a first period of time in a first region A as illustrated in FIG. 63A, the cooking device 520 may output information on a second region B, in which the meat may be cooked according to the second condition (e.g., cooked at the second temperature for the second period of time) as illustrated in FIG. 63B, to the user.

6 Cooking Recipe Improvement System

In order to automatically cook meat, it is important to determine an appropriate cooking method, but a method of objectively evaluating meat that has been cooked and a feedback system for modifying the cooking method on the basis of the evaluation result are also important.

According to an embodiment, a cooking recipe improvement system may be provided in which, after the cooking of meat is completed, the cooking method is modified by the server 2000 in consideration of a difference from an initially intended value through analysis of the meat that has been cooked.

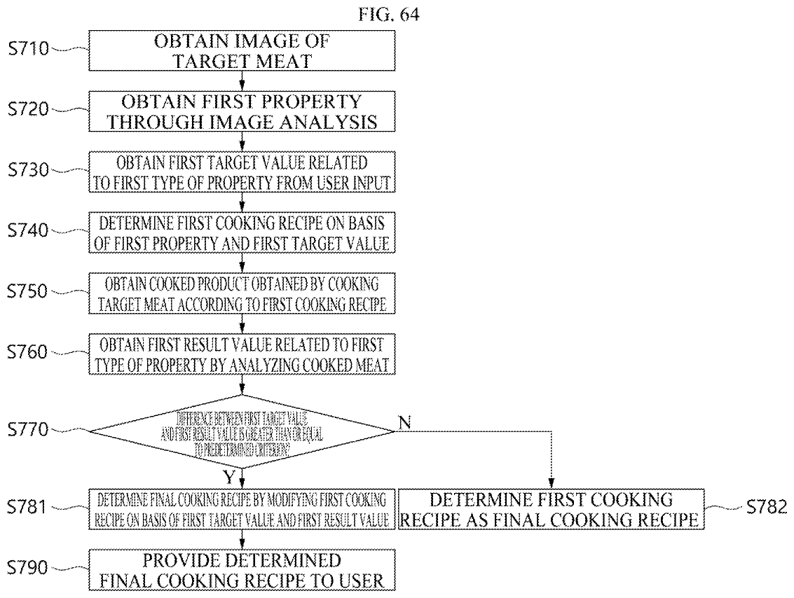

FIGS. 64 to 67 are diagrams for describing a cooking recipe improvement system according to an embodiment.

Referring to FIG. 64, the server 2000 may perform a step S710 of obtaining an image of a target meat, a step S720 of obtaining a first property through analysis of the image, a step S730 of obtaining a first target value related to a first type of property from a user input, a step S740 of determining a first cooking recipe on the basis of the first property and the first target value, a step S750 of obtaining a cooked product obtained by cooking the target meat according to the first cooking recipe, a step S760 of obtaining a first result value related to the first type of property by analyzing the cooked meat, a step S770 of determining whether a difference between the first target value and the first result value is greater than or equal to a predetermined criterion, a step S781 of determining a final cooking recipe by modifying the first cooking recipe on the basis of the first target value and the first result value, a step S782 of determining the first cooking recipe as the final cooking recipe, and a step S790 of providing the determined final cooking recipe to the user.

The server 2000 may obtain an image of meat and obtain a first property through analysis of the image. Since the method of obtaining, by the server 2000, information on the properties of the meat from the image of the meat has been described above, overlapping descriptions thereof will be omitted.

The server 2000 may obtain a first target value related to a first type of property from a user input. In this case, the first type of property may be related to at least one of meat flavor, meat juiciness, and meat tenderness. The first target value may be a value obtained from the user input. The first target value may be a grade or value related to the first type of property.

The server 2000 may determine a first cooking recipe on the basis of the first property and the first target value, and obtain a first result value related to the first type of property through analysis of a product cooked according to the first cooking recipe.

The first result value may be obtained through the analysis of the cooked product, and may be at least one of a test for juiciness, a test for tenderness, and a test for flavor of the cooked product.

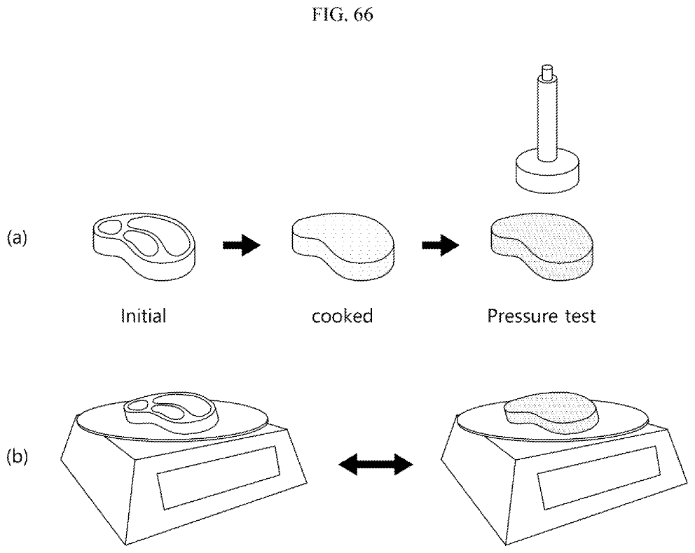

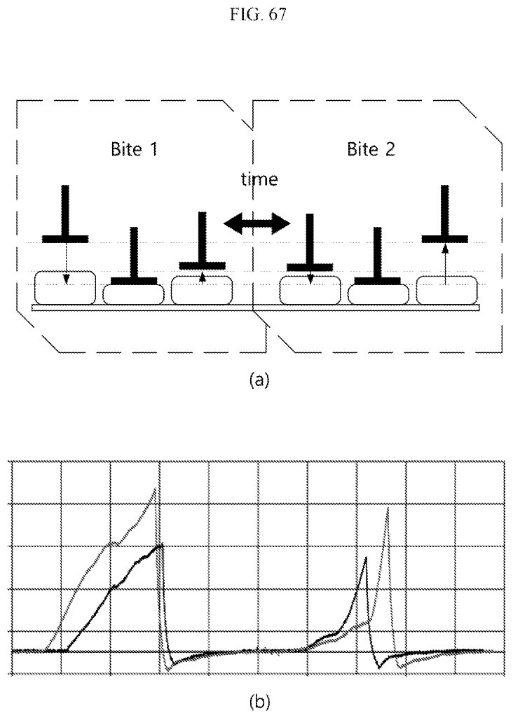

FIG. 66 is a set of diagrams for describing the test for the juiciness of the cooked product, and FIG. 67 is a set of diagrams for describing the test for the tenderness of the cooked product.

As illustrated in FIGS. 66A and 66B, the tenderness of the cooked product may be tested by analyzing the meat before being cooked, the meat after being cooked, and the meat in a state where pressure is applied after being cooked, and since this may be performed in a known manner, a detailed description thereof will be omitted. The test for the tenderness of the product may be conducted in various other methods.

As illustrated in FIGS. 67A and 67B, the test for the tenderness of the cooked product may be performed through a method of measuring a property that imitates human chewing motion. For example, the test for the tenderness of the product may be performed through a texture profile analysis (TPA) test, and since the test for the tenderness of the product may be performed in a known manner, a detailed description thereof will be omitted.

The server 2000 may determine whether a difference between the first target value and the first result value is greater than or equal to a predetermined criterion. When it is determined that the difference between the first target value and the first result value is greater than or equal to the predetermined criterion, the server 2000 may determine a final cooking recipe by modifying the first cooking recipe on the basis of the first target value and the first result value. When it is determined that the difference between the first target value and the first result value does not meet the predetermined criterion, the server 2000 may determine the first cooking recipe as the final cooking recipe.

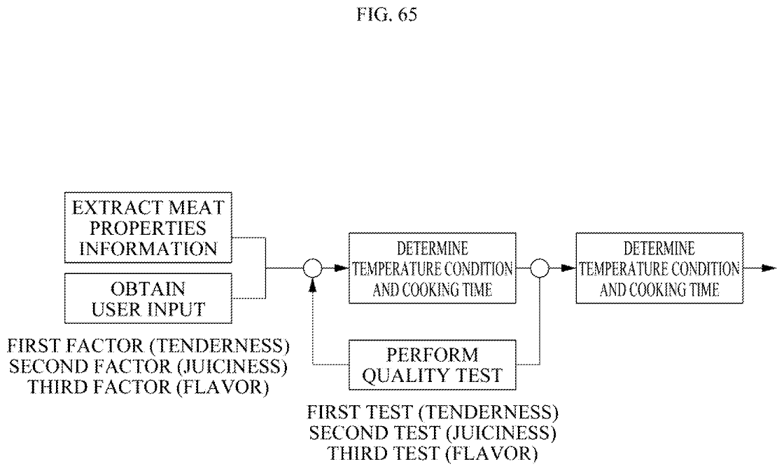

The server 2000 may improve the initially set first cooking recipe according to the above-described method, and provide the improved final cooking recipe to the user. In other words, as illustrated in FIG. 65, the basic cooking method determined based on the meat properties information and/or the user preference can be improved into the final cooking method using a result of analysis (e.g., quality test) of the cooked product.

The server 2000 may obtain target values related to a plurality of types of properties from the user input, and provide the final cooking recipe improved based on the target values to the user. For example, the server 2000 may obtain a first target value related to a first type of property and a second target value related to a second type of property from the user input. In this case, the first type of property may be different from the second type of property.

The server 2000 may determine the first cooking recipe on the basis of the first target value and the second target value. The server 2000 may obtain a cooked product by cooking the meat according to the first cooking recipe, and then obtain a first result value related to the first type of property and obtain a second result value related to the second type of property.

The server 2000 may determine whether a difference between the first target value and the first result value or a difference between the second target value and the second result value is greater than or equal to a predetermined criterion. When it is determined that the difference between the first target value and the first result value is greater than or equal to the predetermined criterion, the server 2000 may determine the final cooking recipe by modifying the first cooking recipe on the basis of the first target value and the first result value. When it is determined that the difference between the second target value and the second result value is greater than or equal to the predetermined criterion, the server 2000 may determine the final cooking recipe by modifying the first cooking recipe on the basis of the second target value and the second result value. When it is determined that the difference between the first target value and the first result value and the difference between the second target value and the second result value are greater than or equal to the predetermined criterion, the server 2000 may determine the final cooking recipe by modifying the first cooking recipe on the basis of the first target value, the second target value, the first result value, and the second result value.

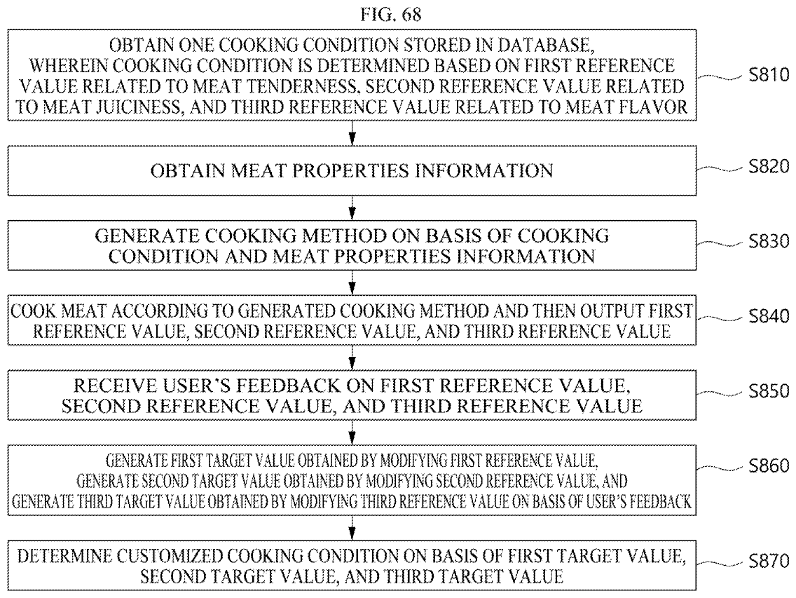

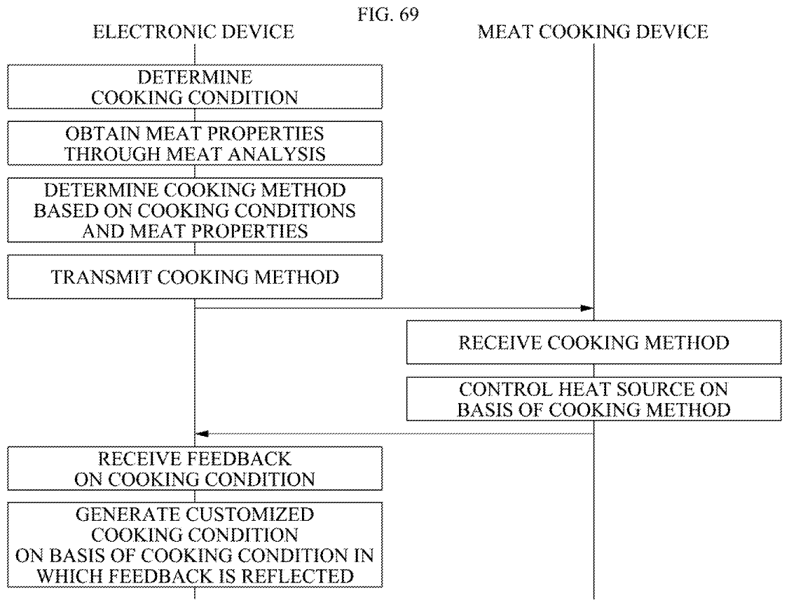

FIGS. 68 and 69 are exemplary diagrams for describing a method of determining a customized cooking condition according to an embodiment.

Referring to FIGS. 68 and 69, the method of determining the customized cooking condition according to the embodiment may perform a step S810 of obtaining one cooking condition stored in a database, a step S820 of obtaining meat properties information, a step S830 of generating a cooking method on the basis of the cooking condition and the meat properties information, a step S840 of cooking the meat according to the generated cooking method and then outputting a first reference value, a second reference value, and a third reference value, a step S850 of receiving user's feedback on the first reference value, the second reference value, and the third reference value, a step S860 of generating a first target value obtained by modifying the first reference value, generating a second target value obtained by modifying the second reference value, and generating a third target value obtained by modifying the third reference value on the basis of the user's feedback, and a step S870 of determining a customized cooking condition on the basis of the first target value, the second target value, and the third target value.

The method of determining the customized cooking condition according to an embodiment may receive the user's feedback on the meat cooked according to the cooking method determined according to a first criterion, and then generate a second criterion by reflecting the user's feedback to the first criterion to provide the cooking method determined according to the second criterion, and thus the customized the cooking condition may be determined.

The method of determining the customized cooking condition according to an embodiment includes the operation of obtaining one cooking condition stored in the database, wherein the cooking condition may be determined based on the first reference value related to meat tenderness, the second reference value related to meat juiciness, and the third reference value related to meat flavor.

The method of determining the customized cooking condition according to an embodiment may include the operation of generating the cooking method on the basis of the cooking condition and the meat properties information. The meat properties information may be information related to properties of the meat extracted based on image data or non-image data, and since descriptions thereof have been described above, the overlapping descriptions thereof will be omitted.

The method of determining the customized cooking condition according to an embodiment may include the operation of cooking the meat according to the generated cooking method and then outputting the first reference value, the second reference value, and the third reference value. The first reference value, the second reference value, and the third reference value may be numerical values that are a basis for generating the cooking method.

The method of determining the customized cooking condition according to an embodiment may include a step of receiving the user's feedback on the first reference value, the second reference value, and the third reference value. In the above step, the user's response to at least one of the first reference value, the second reference value, and the third reference value may be received. The user may reflect feedback on at least one of the first reference value, the second reference value, and the third reference value as an evaluation of the cooked meat.

The method of determining the customized cooking condition according to an embodiment may include a step of obtaining the first target value, the second target value, and the third target value on the basis of the user's feedback. In the above step, the first target value may be a value in which the user's feedback is reflected to the first reference value, the second target value may be a value in which the user's feedback is reflected to the second reference value, and the third target value may be a value in which the user's feedback is reflected to the third reference value.

The method of determining the customized cooking condition according to an embodiment may include a step of determining the customized cooking condition on the basis of the first target value, the second target value, and the third target value. That is, by newly determining a cooking method on the basis of the first to third target values in which the user's feedback is reflected, the customized cooking method in which the user preference is reflected may be determined.

According to the embodiments of the present invention, by obtaining information on properties of meat on the basis of analysis of an image or a non-image, it is possible to determine a method cooking the meat on the basis of the obtained information and evaluate the quality of the cooked meat.

According to the embodiments of the present invention, by determining a cooking method by reflecting meat properties information and user preference, it is possible to provide an optimal cooking method capable of deriving a product desired by a user.

According to the embodiments of the present invention, by providing an automatic meat cooking device capable of accurately performing a predetermined cooking method, it is possible to cook meat more rapidly, accurately, and precisely.

According to the embodiments of the present invention, it is possible to provide a meat cooking recipe improvement system capable of improving a previously set cooking method on the basis of analysis of a cooked product, and accordingly, it is possible to determine a cooking method capable of providing an optimal product desired by the user.

Effects of the present invention are not limited to the above-described effects and other effects that are not described may be clearly understood by those skilled in the art from this specification and the accompanying drawings.

Features, structures, and effects described in the above-described exemplary embodiments are included in at least one exemplary embodiment of the present invention but are not necessarily limited to only one exemplary embodiment. Further, features, structures, and effects exemplified in each exemplary embodiment may be embodied by being combined with another exemplary embodiment or modified by those skilled in the art. It should be interpreted that contents related to such combinations and modifications are included in the scope of the present invention.

While the present invention has been particularly described with reference to embodiments, the embodiments are only exemplary embodiments of the present invention and the present invention is not intended to be limited thereto. It will be understood by those skilled in the art that modifications and applications in other forms may be made without departing from the spirit and scope of the present invention. That is, each component specifically shown in the embodiments may be modified and embodied. In addition, it should be understood that differences related to these modifications and applications are within the scope of the present invention as defined in the appended claims.

What is claimed is:

1. A cooking device, comprising:
a first grilling plate;
a second grilling plate disposed to face the first grilling plate;
a shaft configured to adjust a distance between the first grilling plate and the second grilling plate; and
at least one processor configured to control an operation of the shaft,
wherein the at least one processor configured to:
control the operation of the shaft so that the distance between the first grilling plate and the second grilling plate becomes a first distance in case that the first grilling plate and the second grilling plate operate in a first mode,
control the operation of the shaft so that the distance between the first grilling plate and the second grilling plate becomes a second distance in case that the first grilling plate and the second grilling plate operate in a second mode, wherein the second distance is shorter than the first distance, and
apply heat to the first grilling plate and the second grilling plate.

2. The device of claim 1,
wherein the first mode is a mode in which the first grilling plate or the second grilling plate operates so that meat is placed on the first grilling plate or the second grilling plate or the meat is discharged from the first grilling plate or the second grilling plate, and
wherein the second mode is a mode in which the first grilling plate or the second grilling plate operates so that the meat is cooked by the first grilling plate and the second grilling plate.

3. The device of claim 1,
wherein the at least one processor configured to:
control the first grilling plate to apply heat to the first side of the meat and control the second grilling plate to apply heat to the second side of the meat in case that the first grilling plate and the second grilling plate operate in the second mode.

4. The device of claim 1,
wherein the device further comprises at least one elastic member, and
wherein the at least one elastic member is directly or indirectly connected to the second grilling plate to transmit power generated by the shaft to the second grilling plate.

5. The device of claim 4,
wherein the at least one elastic member comprises a first support, a second support, a buffer member, and a protruding member.

6. The device of claim 5,
wherein the first support is configured to have an inner space and is formed to be coupled to the second support, and
wherein at least a part of the second support is inserted into at least a part of the inner space of the first support.

7. The device of claim 5,
wherein an opening is formed on at least a part of a side surface of the first support, and the protruding member is provided on at least a part of a side surface of the second support, and
wherein the opening and the protruding member is configured to guide the at least a part of the second support to be inserted within a predetermined range in case that the at least a part of the second support is inserted into the inner space of the first support.

8. The device of claim 1,
wherein the device further comprises a housing having an inner space, and
wherein at least a part of the first grilling plate and at least a part of the second grilling plate are accommodated in the inner space of the housing in case that the first grilling plate and the second grilling plate operate in the second mode.

9. The device of claim 8,
wherein the housing comprises a housing body and a housing cover,
wherein the housing body is configured to form an inner space with at least one surface open, and
wherein the housing cover is provided to open or close at least a part of the open part of the housing body.

10. The device of claim 8,
wherein the device further comprises a sub-housing,
wherein the sub-housing is fluidly connected to the housing, and
wherein the sub-housing comprises a blowing fan for discharging smoke generated in the housing to the outside.

11. The device of claim 1,
wherein the at least one processor is configured to control the operation of the shaft so that the second grilling plate moves toward the first grilling plate in case that the first grilling plate and the second grilling plate operate in the second mode.

12. The device of claim 1,
wherein the at least one processor is configured to control the operation of the shaft so that the housing moves toward the first grilling plate at a first time point and control the operation of the shaft so that the second grilling plate moves toward the first grilling plate at a second time point in case that the first grilling plate and the second grilling plate operate in the second mode, and
wherein the second time point is later than the first time point.

13. The device of claim 12,
wherein, at the second time point, the second grilling plate is configured to be accommodated in the inner space of the housing.

14. The device of claim 12,
wherein, at the second time point, at least a part of the first grilling plate and the second grilling plate are configured to be accommodated in the inner space of the housing.

15. The device of claim 7,
wherein the device further comprises a housing having an inner space,
wherein the at least one processor is configured to control the operation of the shaft so that the housing moves toward the first grilling plate at a first time point and control the operation of the shaft so that the second grilling plate moves toward the first grilling plate at a second time point in case that the first grilling plate and the second grilling plate operate in the second mode,
wherein the second time point is later than the first time point,
wherein, at the first time point, the protruding member formed on the second support is positioned at one end of the opening formed on the first support, and
wherein, at the second time point, the protruding member formed on the second support is positioned at the other end of the opening formed on the first support.

16. The device of claim 1,
wherein the device further comprises a housing having an inner space,
wherein a distance from the ground to an end of the housing is smaller than or equal to a distance from the ground to the first grilling plate in case that the first grilling plate and the second grilling plate operate in the first mode, and
wherein the distance from the ground to the end of the housing is greater than or equal to the distance from the ground to the first grilling plate in case that the first grilling plate and the second grilling plate operate in the second mode.

17. The device of claim 1,
wherein the shape of the first grilling plate is a shape in which a plurality of grooves is formed at regular intervals, and
wherein the shape of the second grilling plate is correspond to the shape of the first grilling plate.

18. The device of claim 1,
wherein a first temperature sensor is provided on the first grilling plate, and a second temperature sensor is provided on the second grilling plate, and
wherein the at least one processor is configured to control a temperature of the first grilling plate and a temperature of the second grilling plate based on the first temperature sensor and the second temperature sensor.

19. The device of claim 1,
wherein the first heat insulation plate is provided on the first grilling plate, and a second heat insulation plate is provided on the second grilling plate,
wherein one surface of the first grilling plate is disposed to face one surface of the second grilling plate, and
wherein the first heat insulation plate is disposed on another surface of the first grilling plate, and the second heat insulation plate is disposed on another surface of the second grilling plate.

20. A method of cooking meat, comprising:
controlling a operation of a shaft so that the distance between a first grilling plate and a second grilling plate becomes a first distance in case that the first grilling plate and the second grilling plate operate in a first mode;
controlling a operation of the shaft so that the distance between the first grilling plate and the second grilling plate becomes a second distance in case that the first grilling plate and the second grilling plate operate in a second mode; and
applying heat to the first grilling plate and the second grilling plate,
wherein the second distance is shorter than the first distance,
wherein the second grilling plate is disposed to face the first grilling plate, and
wherein the shaft is configured to adjust a distance between the first grilling plate and the second grilling plate.
